(19) United States
(12) Patent Application Publication
(10) Pub. No.: US 2023/0284619 A1
(43) Pub. Date: Sep. 14, 2023

(54) Agrochemical mixtures of diamides, plant health additives and insecticide

(71) Applicant: RAJDHANI PETROCHEMICALS PRIVATE LIMITED, Ahmedabad, Gujarat (IN)

(72) Inventors: Dipakkumar PATEL, Ahmedabad, Gujarat (IN); Kenal V. SHAH, Ahmedabad, Gujarat (IN); Bhavesh V. SHAH, Ahmedabad, Gujarat (IN); Kawarlal DABHODIA, Ahmedabad, Gujarat (IN)

(21) Appl. No.: 18/016,696

(22) PCT Filed: Jul. 16, 2021
(86) PCT No.: PCT/IN2021/050687

§ 371 Date: Jan. 18, 2023

(30) Foreign Application Priority Data
Jul. 18, 2020 (IN) 202021030669

(51) Int. Cl. A01N 43/56; A01N 25/04; A01N 25/30; A01N 25/14; A01N 43/88; A01N 33/26; A01N 43/16; A01N 37/06; A01N 37/10

(52) U.S. Cl. CPC A01N 43/56; A01N 25/04; A01N 25/30; A01N 25/14; A01N 43/88; A01N 33/26; A01N 43/16; A01N 37/06; A01N 37/10

(57) ABSTRACT

A synergistic agrochemical mixture for foliar spray and soil application comprising of bioactive amount of Diamide insecticide, one or more plant health additives and an insecticide. The present invention further relates to process for preparing the said compositions in specific ratio. The present invention further relates to the process of preparing the said composition along with an unclassified compound that has an uncertain mode of action. The present invention further relates to the synergistic agrochemical composition, where in active ingredient present in fixed ratio shows synergy in pesticidal activity.

### FIELD OF INVENTION

The present invention relates to synergistic agrochemical mixtures for foliar spray and soil application composition comprising of bioactive amounts of diamide insecticide; one or more plant health additives; and at least one more insecticide. The present invention further relates to process of preparing the said mixtures for foliar spray treatment of plants and soil application treatment.

### BACKGROUND OF THE INVENTION

These days cultivation of crops and agriculture in general is cost intensive. Receiving a high yield from the cultivated crops is a key. Hence, to achieve higher yield, protecting crops from pest and parasitic infestation is vital.

Combination of insecticides and plant health additives compounds is used to broaden the spectrum of control of insect pests and parasitic nematodes, reduce dosage, thereby reducing environmental impact, and decrease the chances of development of resistance. the combination of an insecticide and plant health additives compound at times demonstrate an active or synergistic effect that results in an improved control on the pest and overall crop health as well as improved plant vigour in field condition.

Damage to plants from insects and parasitic nematodes is a major concern for agriculturist. There are various diseases such as root knot, cyst, Pine wilt disease etc. which reduce the water and nutrient uptake in plants and decrease the overall yield of the crops. Treating plants with such an insecticide and plant health additives combination helps reduce the damage from insect pests and parasitic nematodes. Another advantage of treating the plants with the said combination is the improvement in plant growth, increased yield and overall plant health.

AU2018101439A4 relates to the field of pesticide technology, and in particular to a special film-coated controlled release pesticide for peanut, comprising a three-layer structure, wherein raw materials in an inner layer comprise phoxim, imidacloprid, chlorpyrifos, Diamide insecticide like chlorantraniliprole, wheat bran, Plant health additives such as humic acid, and adhesive; raw materials in an intermediate layer comprise phoxim, imidacloprid, chlorpyrifos, chlorantraniliprole, urea formaldehyde powder; and raw materials in an outer layer comprise urea formaldehyde powder and fermented livestock and poultry manure. The pesticide is applied into the fruiting layer along with seeding, and does not release pesticidal effects in the early growth stage, but releases pesticidal effects until the coating film is decomposed in the pegging and pod-bearing stage of peanut in about 50 days after application into soil, which can not only reduce the pesticide use level to prevent non-point source pollution, but also strongly targetedly and effectively control soil pests, avoid the pesticide toxicity and pesticidal effect losses, reduce the pesticide use level, reduce environmental pollution, achieve safe storage and transport and low production cost, and have good market prospects.

AU2018203760B2 relates to agricultural methods and the use of an insecticidal active carboxamide derivative in seed treatment and soil application methods. The insecticidal carboxamide derivative is highly suitable alone or in combination with other active agricultural ingredients for controlling animal pests such as insects and/or spider mites and/or nematodes by treating the soil/growth substrate by drenching or drip application or dipping or soil injection. In the said invention use of diamide insecticide such as chlorantraniliprole and plant health additives such as humic acid are being employed.

EP2958431B1 discloses nematicidal aqueous suspension concentrate compositions comprising of diamide insecticides such as chlorantraniliprole, cyantraniliprole and the like as well as plant health additives such as humic acid, fulvic acid and the like.

There is however a need for improvement of these combinations. Single active combination used over a long period of time has resulted in resistance. With the onset of resistance to certain pests, there is a need in the art for a combination of actives that decrease the chances of resistance and improves the spectrum of disease and pest control.

In general use, the pesticide actives are used in the form of a dilute aqueous composition because it can attain a good interaction with the target organism, such as plants, insects and parasitic nematodes. However, most active pesticide compounds that are used as pesticides are only sparingly or insoluble in water. The low solubility of such compounds present the challenges and difficulties to formulator in formulating pesticide compounds in stable formulations that can be easily stored for a long time and which can still have a high stability and effective activity until end use. This problem especially occurs and may get worsen if more than one active compound is present in the mixture.

Therefore, one object of the present invention is to provide improved combinations of Diamide insecticide, Plant health additives and another insecticide for the control of insect-pest and nematodes. Another object of the present invention is to provide a method and a composition for controlling insect pests on a full grown plant.

Yet another object of the present invention is to provide improved combinations of diamide insecticide, plant health additives and another insecticide that promote plant health and increase plant yield in the field.

Embodiment of the present invention can ameliorate one or more of the above mentioned problems.

Inventors of the present invention have surprisingly found that the novel synergistic mixture for plant treatment comprising of an insecticide from the diamide group of insecticide; one or more plant health additives; and one more insecticide can provide solution to the above mentioned problems.

### SUMMARY OF INVENTION

Therefore an aspect of the present invention provides an agrochemical mixture for foliar plant treatment comprising (A) an insecticide selected from Diamide group; (B) one or more Plant health additives; (C) one more insecticide.

More particularly an aspect of the present invention provides an agrochemical mixture for foliar and soil application comprising (A) Diamide group of insecticides like broflanilide, chlorantraniliprole, cyantraniliprole, cyclaniliprole, cyhalodiamide, cyproflanilide, flubendiamide, tetrachlorantraniliprole, tetraniliprole fluxametamide or isocyclaseram and mixtures thereof; (B) one compound or more Plant health additives compounds like chitosan, chitin, humic acid, potassium fulvic acid, potassium humate, fulvic acid, amino acid, protein hydrolisates, seaweed extract (Ascophyllum nodosum), brassinolide, microalgae polysaccharides, jasmonic acid (methyl jasmonate), silicon compound-silicic acid (H2Si03), monosilicic acid, orthosilicic acid (H4Si04), disilicic acid (H2Si205), and pyrosilicic acid (H6Si207), silica nanoparticles, Calcium silicate, Potassium silicate, Sodium silicate or mixtures thereof, silicyclic acid Micronutrients Zinc (zinc sulphate heptahydrate ZnSO₄7H₂O, zinc sulphate mono hydrate ZnSO₄·H₂O, chelated zinc as Zn-EDTA, zinc oxide, Zinc Lactate Gluconate, Zinc Polyflavonoid), Boron (borax-sodium tetraborate, boric acid (H₃BO₃), di-sodium octa borate tetra hydrate (Na2B₈O13.4H₂O), di-sodium tetra borate penta hydrate, anhydrous borax,), Manganese (manganese sulphate), Copper (copper sulphate), Iron (ferrous sulphate, chelated iron as Fe-EDTA), Molybdanum (ammonium molybdate), Magnesium (Magnesium sulphate) or Sulphur (elemental sulphur, boronated sulphur) and mixture thereof; (C) one more Insecticide like acetylcholine esterase inhibitors from the class of carbamates, acetylcholine esterase inhibitors from the class of organophosphates, GABA-gated chloride channel antagonists, sodium channel modulators from the class of pyrethroids, nicotinic acteylcholine receptor (nAChR) competitive modulators, nicotinic acteylcholine receptor (nAChR) allosteric modulators-Site I-from the class of spinosyns, glutamate-gated chloride channel (GluCl) allosteric modulators-class of mectins, juvenile hormone mimics, non-specific multi-site inhibitors, chordotonal organ TRPV channel modulators, mite growth inhibitors affecting CHS1, microbial disruptors of insect midgut membrane, inhibitors of mitochondrial ATP synthase, uncouplers of oxidative phosphorylation, inhibitors of the chitin biosynthesis affecting CHS1, inhibitors of the chitin biosynthesis type 1, Ecdyson receptor agonists, moulting disruptors, Octopamin receptor agonists, Mitochondrial complex III electron transport inhibitors, Mitochondrial complex I electron transport inhibitors, Voltage-dependent sodium channel blockers, Inhibitors of the lipid synthesis, inhibitors of acetyl CoA carboxylase, Mitochondrial complex II electron transport inhibitors, chordotonal organ modulators, Baculoviruses; and an Unclassified Compound with uncertain mode of action like azadirechtin, benzoximate, benzpyrimoxan, pyridalyl and oxazosulfyl; dimpropyridaz, tyclopyrazoflor, dichloromezotiaz, fluhexafon, acaricidal compound-cyetpyrafen, flupentiofenox, acynonapyr, compound with nematicidal action-cyclobutrifluram, fluazaindolizine, tioxazafen.

Accordingly, in yet another aspect the agrochemical mixture for plant treatment comprising (A) Diamide group of insecticide; (B) one or more Plant health additives; (C) one more insecticide; wherein the formulations selected from

Capsule suspension (CS), Dispersible concentrate (DC), Powder for dry seed treatment (DS), Emulsifiable concentrate (EC), Emulsion, water in oil (EO), Emulsion for foliar spray (ES), Emulsion, oil in water (EW), Flowable suspension/concentrate for foliar spray (FS), Granule/soil applied (GR), Controlled (Slow or Fast) release granules (CR), Jambo balls or bags (bags in water soluble pouch), Solution for foliar spray (LS), Micro-emulsion (ME), Oil dispersion (OD), Oil miscible flowable concentrate (oil miscible suspension (OF), Oil miscible liquid (OL), Suspension concentrate (=flowable concentrate) (SC), Suspo-emulsion (SE), Water soluble granule (SG), Soluble concentrate (SL), Water soluble powder (SP), Water dispersible granule (WG or WDG), Wettable powder (WP), Water dispersible powder for slurry treatment (WS), A mixed formulation of CS and SC (ZC), A mixed formulation of CS and SE (ZE), A mixed formulation of CS and EW (ZW).

The remainder of the aqueous formulation is preferably wholly water but may comprise other materials, such as inorganic salts. The formulation is preferably, completely free from organic solvents.

Accordingly, in a first aspect, the present invention provides an agrochemical mixture comprising (A) Diamide group of insecticide; (B) one or more Plant health additives; (C) one more Insecticide; exhibits synergistic activity.

### DETAIL DESCRIPTION OF THE INVENTION

The term “health of a plant” or “plant health” is defined as a condition of the plant and/or its products. As a result of the improved health, yield, plant vigor, quality and tolerance to abiotic or biotic stress are increased. Noteworthy, the health of a plant when applying the method according to the invention, is increased independently of the pesticidal properties of the active ingredients used because the increase in health is not based upon the reduced pest pressure but instead on complex physiological and metabolic reactions which result for example in an activation of the plant's own natural defense system. As a result, the health of a plant is increased even in the absence of pest pressure. Accordingly, in an especially preferred embodiment of the method according to the invention, the health of a plant is increased both in the presence and absence of biotic or abiotic stress factors. The above identified indicators for the health condition of a plant may be interdependent or they may result from each other. An increase in plant vigor may for example result in an increased yield and/or tolerance to abiotic or biotic stress. One indicator for the condition of the plant is the yield. “Yield” is to be understood as any plant product of economic value that is produced by the plant such as grains, fruits in the proper sense, vegetables, nuts, grains, seeds, wood (e.g. in the case of silviculture plants) or even flowers (e.g. in the case of gardening plants, ornamentals). The plant products may in addition be further utilized and/or processed after harvesting.

In an especially preferred embodiment of the invention, the yield of the treated plant is increased.

In another preferred embodiment of the invention, the yield of the plants treated according to the method of the invention, is increased synergistically.

According to the present invention, “increased yield” of a plant, in particular of an agricultural, silvicultural and/or horticultural plant means that the yield of a product of the respective plant is increased by a measurable amount over the yield of the same product of the plant produced under the same conditions, but without the application of the mixture according to the invention.

Increased yield can be characterized, among others, by the following improved proper-ties of the plant: increased plant, weight, increased plant height, increased biomass such as higher overall fresh weight (FW), increased number of flowers per plant, higher grain yield, more tillers or side shoots (branches), larger leaves, increased shoot growth, increased protein content, increased oil content, increased starch content, increased pigment content, increased leaf are index.

A further indicator for the condition of the plant is the plant vigor. The plant vigor becomes manifest in several aspects such as the general visual appearance. In another especially preferred embodiment of the invention, the plant vigor of the treated plant is increased. In another preferred embodiment of the invention, the plant vigor of the plants treated according to the method of the invention, is increased synergistically. Improved plant vigor can be characterized, among others, by the following improved properties of the plant: improved vitality of the plant, improved plant growth, improved plant development, improved visual appearance, improved plant stand (less plant verse/lodging), improved emergence, enhanced root growth and/or more developed root system, enhanced nodulation, in particular rhizobial nodulation, bigger leaf blade, bigger size, increased plant weight, increased plant height, increased tiller number, increased number of side shoots, increased number of flowers per plant, increased shoot growth, increased root growth (extensive root system), increased yield when grown on poor soils or unfavorable climate, enhanced photosynthetic activity (e.g. based on increased stomatal conductance and/or increased C02 assimilation rate), increased stomatal conductance, increased C02 assimilation rate, enhanced pigment content (e.g. chlorophyll content), earlier flowering, earlier fruiting, earlier and improved germination, earlier grain maturity, improved self-defense mechanisms, improved stress tolerance and resistance of the plants against biotic and abiotic stress factors such as fungi, bacteria, viruses, insects, heat stress, cold stress, drought stress, UV stress and/or salt stress, less non-productive tillers, less dead basal leaves, less input needed (such as fertilizers or water), greener leaves, complete maturation under shortened vegetation periods, less fertilizers needed, less seeds needed, easier harvesting, faster and more uniform ripening, longer shelf-life, longer panicles, delay of senescence, stronger and/or more productive tillers, better extractability of ingredients, improved quality of seeds (for being seeded in the following seasons for seed production), better nitrogen uptake, improved reproduction, reduced production of ethylene and/or the inhibition of its reception by the plant.

The improvement of the plant vigor according to the present invention particularly means that the improvement of any one or several or all of the above mentioned plant characteristics are improved independently of the pesticidal action of the mixture or active ingredients (components).

Another indicator for the condition of the plant is the “quality” of a plant and/or its products.

In an especially preferred embodiment of the invention, the quality of the treated plant is increased.

In another preferred embodiment of the invention, the quality of the plants treated according to the method of the invention, is increased synergistically.

According to the present invention, enhanced quality means that certain plant characteristics such as the content or composition of certain ingredients are increased or improved by a measurable or noticeable amount over the same factor of the plant produced under the same conditions, but without the application of the mixtures of the present invention Enhanced quality can be characterized, among others, by following improved properties of the plant or its product: increased nutrient content, increased protein content, increased content of fatty acids, increased metabolite content, increased carotenoid content, increased sugar content, increased amount of essential amino acids, improved nutrient composition, improved protein composition, improved composition of fatty acids, improved metabolite composition, improved carotenoid composition, improved sugar composition, improved amino acids composition, improved or optimal fruit color, improved leaf color, higher storage capacity, higher processability of the harvested products.

Another indicator for the condition of the plant is the plant's tolerance or resistance to biotic and/or abiotic stress factors. Biotic and abiotic stress, especially over longer terms, can have harmful effects on plants. Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to plants exposed to the same conditions, but without being treated with a mixture according to the invention and (2.) that the negative effects are not diminished by a direct action of the mixture according to the invention on the stress factors, e.g. by its fungicidal or insecticidal action which directly destroys the microorganisms or pests, but rather by a stimulation of the plants' own defensive reactions against said stress factors.

The present invention provides a novel synergistic agrochemical mixture for plant treatment comprising (A) an insecticide selected from the group of Diamide insecticides; (B) one or more Plant health additives; (C) one more Insecticide;

More preferably the present invention provides an agrochemical comprising (A) Diamide group of insecticides like broflanilide, chlorantraniliprole, cyantraniliprole, cyclaniliprole, cyhalodiamide, cyproflanilide, flubendiamide, tetrachlorantraniliprole, tyclopyrazoflor, tetraniliprole fluxametamide or isocyclaseramand mixtures thereof; (B) one compound or more Plant health additives compounds like chitosan, chitin, humic acid, potassium fulvic acid, potassium humate, fulvic acid, amino acid, protein hydrolisates, seaweed extract (Ascophyllum nodosum), brassinolide, microalgae polysaccharides, jasmonic acid (methyl jasmonate), silicon compound-silicic acid (H2Si03), monosilicic acid, orthosilicic acid (H4Si04), disilicic acid (H2Si205), and pyrosilicic acid (H6Si207), silica nanoparticles, Calcium silicate, Potassium silicate, Sodium silicate or mixtures thereof, silicyclic acid Micronutrients (Zinc (zinc sulphate heptahydrate ZnSO₄7H₂O, zinc sulphate mono hydrate ZnSO₄·H₂O, chelated zinc as Zn-EDTA, zinc oxide, Zinc Lactate Gluconate, Zinc Polyflavonoid), Boron (borax-sodium tetraborate, boric acid (H₃BO₃), di-sodium octa borate tetra hydrate (Na2B8O13.4H2O), di-sodium tetra borate penta hydrate, anhydrous borax,), Manganese (manganese sulphate), Copper (copper sulphate), Iron (ferrous sulphate, chelated iron as Fe-EDTA), Molybdanum (ammonium molybdate), Magnesium (Magnesium sulphate) or Sulphur (elemental sulphur, boronated sulphur) and mixture thereof; (C) one more Insecticide like acetylcholine esterase inhibitors from the class of carbamates, acetylcholine esterase inhibitors from the class of organophosphates, GABA-gated chloride channel antagonists, sodium channel modulators from the class of pyrethroids, nicotinic acteylcholine receptor (nAChR) competitive modulators, nicotinic acteylcholine receptor (nAChR) allosteric modulators-Site I-from the class of spinosyns, glutamate-gated chloride channel (GluCl) allosteric modulators-class of mectins, juvenile hormone mimics, non-specific multi-site inhibitors, chordotonal organ TRPV channel modulators, mite growth inhibitors affecting CHS1, microbial disruptors of insect midgut membrane, inhibitors of mitochondrial ATP synthase, uncouplers of oxidative phosphorylation, nicotinic acetylcholine receptor channel blockers, inhibitors of the chitin biosynthesis affecting CHS1, inhibitors of the chitin biosynthesis type 1, Ecdyson receptor agonists, moulting disruptors, Octopamin receptor agonists, Mitochondrial complex III electron transport inhibitors, Mitochondrial complex I electron transport inhibitors, Voltage-dependent sodium channel blockers, Inhibitors of the lipid synthesis, inhibitors of acetyl CoA carboxylase, Mitochondrial complex II electron transport inhibitors, chordotonal organ modulators, Baculoviruses; and an Unclassified Compound with uncertain mode of action like azadirechtin, benzoximate, benzpyrimoxan, pyridalyl and oxazosulfyl; dimpropyridaz, tyclopyrazoflor, dichloromezotiaz, fluhexafon, acaricidal compound-cyetpyrafen, flupentiofenox, acynonapyr, compound with nematicidal action-cyclobutrifluram, fluazaindolizine, tioxazafen.

In an embodiment of the present invention, at least one insecticide may be selected from the class of Acetylcholine esterase inhibitors from the class of carbamates such as aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, and triazamate.

In a further embodiment of the present invention, at least one insecticide may be selected from the class of Acetylcholine esterase inhibitors from the class of organophosphates such as acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion.

In a further embodiment of the present invention, at least one insecticide may be selected from the class of GABA-gated chloride channel antagonists such as cyclodiene organochlorine compounds like endosulfan; or Phenylpyrazole (fiproles) like ethiprole, fipronil, flufiprole, nicofluprole, pyrafluprole, or pyriprole.

In a further embodiment of the present invention, at least one insecticide may be selected from the class of Sodium channel modulators from the class of pyrethroids such as acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (py rethrum), resmethrin, silafluofen, tefluthrin, tetramethylfluthrin, tetramethrin, tralomethrin, transfluthrin.

In a further embodiment of the present invention, at least one insecticide may be selected from the class of Nicotinic acteylcholine receptor (nAChR) competitive modulators such as Neonicotinoids like acetamiprid, clothianidin, dinotefuran, imidacloprid, nitenpyram, thiacloprid, thiamethoxam; or Sulfoximines like sulfoxaflor; or Butenolides like flupyradifurone; or Mesoionics like triflumezopyrim and flupyrimin. In a further embodiment of the present invention, at least one insecticide may be selected from the class of Nicotinic acteylcholine receptor (nAChR) allosteric modulators-Site I-from the class of spinosyns such as spinosad, spinetoram.

In a further embodiment of the present invention, at least one insecticide may be selected from the class of Glutamate-gated Chloride channel (GluCl) allosteric modulators-class of mectins such as Avermectins like abamectin, emamectin benzoate, ivermectin, lepimectin; Milbemycins like milbemectin.

In a further embodiment of the present invention, at least one insecticide may be selected from the class of Juvenile hormone mimics such as hydroprene, kinoprene, methoprene, fenoxycarb, pyriproxyfen.

In a further embodiment of the present invention, at least one insecticide may be selected from the class of Non-specific multi-site inhibitors such as methyl bromide and other alkyl halides, chloropicrin, sulfuryl fluoride, borax or tartar emetic, dazomet, metam.

In a further embodiment of the present invention, at least one insecticide may be selected from the class of Chordotonal organ TRPV channel modulators-selective homopteran feeding blockers such as pyridine azomethine like pymetrozine, pyrifluquinazon; pyropenes like afidopyropen.

In a further embodiment of the present invention, at least one insecticide may be selected from the class of mite growth inhibitors affecting CHS1 such as clofentezine, hexythiazox, diflovidazin or etoxazole.

In a further embodiment of the present invention, at least one insecticide may be selected from the class of Microbial disruptors of insect midgut membrane such as Bacillus thuringiensis and insecticidal proteins they product.

In a further embodiment of the present invention, at least one insecticide may be selected from the class of Inhibitors of mitochondrial ATP synthase such as diafenthiuron, azocyclotin, cyhexatin, fenbutatin oxide, propargite, or tetradifon.

In a further embodiment of the present invention, at least one insecticide may be selected from the class of Uncouplers of oxidative phosphorylation such as chlorfenapyr, DNOC, or sulfluramid.

In a further embodiment of the present invention, at least one insecticide may be selected from the class of Inhibitors of the chitin biosynthesis affecting CHS1 such as Benzoylureas-bistrifluron, chlorfluazuron, diflubenzuron, flucycloxuron, flufenoxuron, hexaflumuron, lufenuron, novaluron, noviflumuron, teflubenzuron, and triflumuron.

In a further embodiment of the present invention, at least one insecticide may be selected from the class of Inhibitors of the chitin biosynthesis type 1 such as buprofezin.

In a further embodiment of the present invention, at least one insecticide may be selected from the class of Moulting disruptors such as cyromazine.

In a further embodiment of the present invention, at least one insecticide may be selected from the class of Ecdyson receptor agonists such as diacylhydrazines-methoxyfenozide, tebufenozide, halofenozide, fufenozide or chromafenozide.

In a further embodiment of the present invention, at least one insecticide may be selected from the class of Octopamin receptor agonists such as amitraz.

In a further embodiment of the present invention, at least one insecticide may be selected from the class of Mitochondrial complex III electron transport inhibitors such as hydramethylnon, acequinocyl, flometoquin, fluacrypyrim, pyriminostrobin or bifenazate.

In a further embodiment of the present invention, at least one insecticide may be selected from the class of Mitochondrial complex I electron transport inhibitors such as fenazaquin, fenpyroximate, pyrimidifen, pyridaben, tebufenpyrad, tolfenpyrad, flufenerim, or rotenone.

In a further embodiment of the present invention, at least one insecticide may be selected from the class of Voltage-dependent sodium channel blockers such as oxadiazines like indoxacarb; semicarbazones like metaflumizone.

In a further embodiment of the present invention, at least one insecticide may be selected from the class of Inhibitors of the lipid synthesis, inhibitors of acetyl CoA carboxylase such as Tetronic and tetramic acid derivatives like spirodiclofen, spiromesifen, spirotetramat or spiropidion.

In a further embodiment of the present invention, at least one insecticide may be selected from the class of Mitochondrial complex II electron transport inhibitors such as cyenopyrafen, cyflumetofen or pyflubumide.

In a further embodiment of the present invention, at least one insecticide may be selected from the class of chordotonal organ modulators such as unidentified-flonicamid.

In a further embodiment of the present invention, at least one insecticide may be selected from the class of Baculoviruses such as Granuloviruses and Nucleopolyhedrosis viruses.

The present inventors found unexpected synergy when Diamide insecticide, Plant health additives and another insecticide was combined with an unclassified compound with uncertain mode of action.

Diamide group of Insecticides: The diamides are the most recent addition to the limited number of insecticide classes with specific target site activity that are highly efficacious, control a wide pest spectrum, and have a favorable toxicological profile. Currently available diamide insecticides include chlorantraniliprole and flubendiamide, with cyantraniliprole already being sold in some countries as launch progresses.

For example, Flubendiamide and chlorantraniliprole act by selective activation of the ryanodine receptor (RyR) in the endoplasmic reticulum of insects. The function of these specialized channels is the rapid release of Ca²⁺ from intracellular stores, which is necessary for muscle contraction. Diamide insecticides induce ryanodine-sensitive cytosolic Ca²⁺ transients independent of the extracellular Ca²⁺ concentration. This potent activation of RyRs results in a fast initial efficacy in the insect larvae, with a unique symptomology of irreversible muscle contraction paralysis and characteristic feeding cessation.

Plant health additives: Plant health additives are products that reduce the need for fertilizers and increase plant growth, resistance to water and abiotic stresses. In small concentrations, these substances are efficient, favoring the good performance of the plant's vital processes, and allowing high yields and good quality products. In addition, plant health additives applied to plants enhance nutrition efficiency, abiotic stress tolerance and/or plant quality traits, regardless of its nutrient contents. Several researches have been developed in order to evaluate the plant health additives in improving plant development subjected to stresses, saline environment, and development of seedlings, among others. Furthermore, various raw materials have been used in plant health additives compositions, such as humic acids, hormones, algae extracts, and plant growth-promoting bacteria. In this sense, this chapter aims to approach the use of plant health additives in plant growth according to the raw material used in their compositions as well as their effects on plants subjected to abiotic stresses.

Brassinolide: Brassinolide is a plant hormone. The first isolated brassinosteroid, it was discovered when it was shown that pollen from rapeseed (Brassica napus) could promote stem elongation and cell division. The biologically active component was isolated and named brassinolide.

Salicylic acid: Salicylic acid is a monohydroxy benzoic acid that is benzoic acid with a hydroxy group at the ortho position. It has IUPAC name as 2-hydroxybenzoic acid. Salicylic acid is a phenolic phytohormone and is found in plants with roles in plant growth and development, photosynthesis, transpiration, ion uptake and transport. Salicylic acid is involved in endogenous signalling, mediating in plant defence against pathogens. It plays a role in the resistance to pathogens by inducing the production of pathogenesis-related proteins. It is involved in the systemic acquired resistance in which a pathogenic attack on one part of the plant induces resistance in other parts. The signal can also move to nearby plants by salicylic acid being converted to the volatile ester methyl salicylate. Methyl salicylate is taken up by the stomata of the nearby plant, and once deep in the leaf, is converted back to salicylic acid to induce the immune response. Salicylic acid is a lipophilic monohydroxybenzoic acid, a type of phenolic acid, and a beta hydroxy acid (BHA). It has the formula C7H6O03. This colorless crystalline organic acid is widely used in organic synthesis and functions as a plant hormone. It is derived from the metabolism of salicin.

Zinc: Zinc is a chemical element. Zinc deficiency is crop plants most common micronutrient deficiency; it is particularly common in high-pH soils. Plants that grow in soils that are zinc-deficient are more susceptible to disease. Excess zinc is toxic to plants, although zinc toxicity is far less widespread. Zinc deficiency is very common in almost all type of soils in India especially paddy/rice and sugarcane field. Zinc (Zn) is one of the eight essential micronutrients. It is needed by plants in small amounts, but yet crucial to plant development. In plants, zinc is a key constituent of many enzymes and proteins. It plays an important role in a wide range of processes, such as growth hormone production and internode elongation. Zinc deficiency is probably the most common micronutrient deficiency in crops worldwide, resulting in substantial losses in crop yields. Zinc is an essential micronutrient which means it is essential for plant growth and development, but is required in very small quantities. Although zinc requirements vary among crops, zinc leaf concentrations (on a dry matter basis) in the range 20 to 100 mg/kg are adequate for most crops. It is needed by plants in small amounts, but yet crucial to plant development. In plants, zinc is a key constituent of many enzymes and proteins. It plays an important role in a wide range of processes, such as growth hormone production and inter-node elongation. Zinc deficiency is probably the most common micronutrient deficiency in crops worldwide, resulting in substantial losses in crop yields and human nutritional health problems. Deficiency in zinc might result in significant reduction in crop yields and quality. In fact, yield can even be reduced by over 20% before any visual symptoms of the deficiency occur. The cost to the farmer, associated with loss of production, is by far higher than the cost of testing the soil and plant tissue and applying zinc fertilizers. The mobility of zinc in plants varies, depending on its availability in the soil or growing media. When zinc availability is adequate, it is easily translocated from older to younger leaves, while when zinc is deficient, movement of zinc from older leaves to younger ones is delayed. Therefore, zinc deficiency will initially appear in middle leaves. Symptoms of zinc deficiency include one or some of the symptoms are: Stunting—reduced height, Interveinal chlorosis, Brown spots on upper leaves, distorted leaves, reduced tillering, reduction in leaf size. Zinc occurs in plants as a free ion, as a complex with a variety of low molecular weight compounds, or as a component of proteins and other macromolecules. In many enzymes, zinc acts as a functional, structural, or regulatory cofactor; a large number of zinc-deficiency disorders are associated with the disruption of normal enzyme activity (including that of key photosynthetic enzymes). Zinc deficiency also increases membrane leakiness as zinc-containing enzymes are involved in the detoxification of membrane-damaging oxygen radicals. Zinc may be involved in the control of gene expression; it appears important in stabilizing RNA and DNA structure, in maintaining the activity of DNA-synthesizing enzymes and in controlling the activity of RNA-degrading enzymes. Application of zinc may not correct zinc deficiency in alkaline soils because even with the addition of zinc, it may remain unavailable for plant absorption. Foliar applications of zinc as zinc sulphate or as zinc chelate (or other organic complexes) are also widely used, especially with fruit trees and grape vines. Zinc can also be supplied as a seed treatment, or by root-dipping of transplant

Humic acid: Humic acid is a group of molecules that bind to, and help plant roots receive, water and nutrients. It has an IUPAC name as 2-nitrobicyclo [2.2.1] hept-5-ene-2,3-dicarboxylic acid. High humic acid levels can dramatically increase yields. Humic acid deficiency can prevent farmers and gardeners from growing crops with optimum nutrition.

Humic acids are vital for increasing cell wall permeability in plants. When cell membranes become more permeable, nutrients can more easily enter through the plant. One obvious benefit of humus has been the aggregation of clay. This aggregation has made the clay more porous, soft, and aerobic, with better drainage, resulting in deeper root growth of all plants. Humic acids are remarkable brown to black products of soil chemistry that are essential for healthy and productive soils. They are functionalized molecules that can act as photosensitizers, retain water, bind to clays, act as plant growth stimulants, and scavenge toxic pollutants. No synthetic material can match humic acid's physical and chemical versatility.

Fulvic acid: Fulvic acid is a yellow-brown substances found in natural material such as shilajit, soil, peat, coal, and bodies of water such as streams or lakes. Fulvic acid is formed when plants and animals decompose. Aggregation of soil plays an important role in plant growth. The soil aggregation is promoted by fulvic acid mediating iron and aluminum, one of the constituents of the soil particles, to bind the soil particles together.

Jasmonic acid (JA)/(Methyl jasmonate): Jasmonic acid (JA) is an organic compound found in several plants. The molecule is a member of the jasmonate class of plant hormones. It is biosynthesized from linolenic acid by the octadecanoid pathway. The major function of JA and its various metabolites is regulating plant responses to abiotic and biotic stresses as well as plant growth and development. Regulated plant growth and development processes include growth inhibition, senescence, tendril coiling, flower development and leaf abscission.

Sulphur: Sulphur is one of the essential plant nutrients. It is essential for the growth and development of all crops, without exception. Sulphur also has some key functions in plants as Formation of chlorophyll that permits photosynthesis through which plants produce starch, sugars, oils, fats, vitamins and other compounds. Protein production: Sulphur is a constituent of three S-containing amino acids (cysteine, cystine and methionine), which are the building blocks of protein. About 90% of plant S is present in these amino acids. Synthesis of oils: This is why adequate sulphur is so crucial for oilseeds. Activation of enzymes: which aid in biochemical reactions in the plant. Increases crop yields and improves produce quality, both of which determine the market price a farmer would get for his produce. With reference to crop quality, S improves protein and oil percentage in seeds, cereal quality for milling and baking, marketability of dry coconut kernel (copra), quality of tobacco, nutritive value of forages, etc. It is associated with special metabolisms in plant and the structural characteristics of protoplasm.

The present inventors believe that the combination of the present invention surprisingly results in a synergistic action. The combination of the present invention allows for a broad spectrum of pest control and has surprisingly improved plant vigour and yield. The broad spectrum of the present combination also provides a solution for preventing the development of resistance.

The synergistic agrochemical mixture has very advantageous curative, preventive and systemic insecticidal properties for protecting cultivated plants. As has been mentioned, said active ingredient composition can be used to inhibit or destroy the pest and parasitic nematodes that occur on plants or parts of plants of useful crops. The synergistic agrochemical composition of specific active ingredient has the special advantage of being highly active against insect pests and parasitic nematodes that mostly occur on plant parts such as roots.

The synergistic agrochemical composition of the present invention is used to protect the crops and plants from insect pest and parasitic nematodes. Examples of the crops on which the present compositions may be used include but are not limited to GMO (Genetically Modified Organism) and Non GMO varieties of Cotton (Gossypium spp.), Paddy (Oryza sativa), Wheat (Triticum aestavum), Barley (Hordeum vulgare), Maize (Zea mays), Sorghum (Sorghum bicolor), Oat (Avena sativa), Pearl millet (Pennisetum glaucum), Sugarcane (Saccharum officinarum), Sugarbeet (Beta vulgaris), Soybean (Glycin max), Peanut (Arachis hypogaea), Sunflower (Helianthus annuus), Mustard (Brassica juncea), Rape seed (Brassica napus), Linseed (Linum usitatissimum), Sesame (Sesamum indicum), Green gram (Vigna radiata), Black gram (Vigna mungo), Chickpea (Cicer aritinum), Cowpea (Vigna unguiculata), Redgram (Cajanus cajan), Frenchbean (Phaseolus vulgaris), Indian bean (Lablab purpureus), Horse gram (Macrotyloma uniflorum), Field pea (Pisum sativum), Cluster bean (Cyamopsis tetragonoloba), Lentils (Lens culinaris), Brinjal (Solanum melongena), Cabbage (Brassica oleracea var. capitata), Cauliflower (Brassica oleracea var. botrytis), Okra (Abelmoschus esculentus), Onion (Allium cepa L.), Tomato (Solanum lycopersicun), Potato (Solanum tuberosum), Sweet potato (Ipomoea batatas), Chilly (Capsicum annum), Garlic (Allium sativum), Cucumber (Cucumis sativus), Muskmelons (Cucumis melo), Watermelon (Citrullus lanatus), Bottle gourd (Lagenaria siceraria), Bitter gourd (Momordica charantia), Radish (Raphanus sativus), Carrot (Dacus carota subsp. sativus), Turnip (Brassica rapa subsp rapa), Apple (Melus domestica), Banana (Musa spp.), Citrus groups (Citrus spp.), Grape (Vitis vinifera), Guava (Psidium guajava), Litchi (Litchi chinensis), Mango (Mangifera indica), Papaya (Carica papaya), Pineapple (Ananas comosus), Pomegranate (Punica granatum), Sapota (Manilkara zapota), Tea (Camellia sinensis), Coffea (Coffea Arabica), Turmeric (Curcuma longa), Ginger (Zingiber officinale), Cumin (Cuminum cyminum), Fenugreek (Trigonella foenum-graecum), Fennel (Foeniculum vulgare), Coriander (Coriandrum sativum), Ajwain (Trachyspermum ammi), Psyllium (Plantago ovate), Black Pepper (Piper nigrum), Stevia (Stevia rebaudiana), Safed mush (Chlorophytum tuberosum), Drum stick (Moringa oleifera), Coconut (Coco nucifera), Mentha (Mentha spp.), Rose (Rosa spp.), Jasmine (Jasminum spp.), Marigold (Tagetes spp.), Common daisy (Bellis perennis), Dahlia (Dahlia hortnesis), Gerbera (Gerbera jamesonii), Carnation (Dianthus caryophyllus).

Further the said composition can be applied on vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc.

Moreover the said composition can also be applied to flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc., berries such as blueberry, cranberry, blackberry, raspberry, etc., grape, kaki fruit, olive, plum, banana, coffee, date palm, coconuts, etc.

Furthermore, the present composition can be applied to trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

The mixtures according to the invention can be applied to any and all developmental stages of pests, such as egg, larva, pupa, and adult. The pests may be controlled by contacting the target pest, its food supply, habitat, breeding ground or its locus with a pesticidally effective amount of the inventive mixtures or of compositions comprising the mixtures.

The synergistic agrochemical mixture according to the present invention comprising (A) Diamide group of insecticide; (B) one or more Plant health additives; (C) one more insecticide; is most suitable against insect pests and parasitic nematodes. The major insects pests are belongs to the order Hemiptera, for example, rice leafhopper Nephotettix nigropictus, rice brown plant hopper Nilaparvata lugen, rice white backed plant hopper, Apple Mealy bug Phenococcus aceris, bean aphid Aphis fabae, black citrus aphid Toxoptera aurantii, citrus black scale Saissetia oleae, cabbage aphid Brevicoryne brassicae, Lipaphis erysimi, citrus red scale Aonidiella aurantii, yellow scale Aonidiella citrine, citrus mealybug Planococcus citri, corn leaf aphid Rhopalosiphum maidis, cotton aphid Aphis gossypii, cotton jassid Amrasca biguttula biguttla, cotton mealy bug Planococcus spp. And Pseudococcus spp., cotton stainer Dysdercus suturellus, cotton whitefly Bemisia tabaci, cowpea aphid Aphis crassivora, grain aphid Sitobion avenae, golden glow aphid Uroleucon spp., grape mealybug Pseudococcus maritimus, green peach aphid Myzus persicae, greenhouse whitefly Trialeurodes vaporariorum, papaya mealy bug Pracoccus marginatus, pea aphid Acyrthosiphon pisum, sugarcane mealybug Saccharicoccus sacchari, potato aphid Myzus persicae, potato leaf hopper Empoasca fabae, cotton whitefly Bemisia tabaci, tarnished plant bug Lygus lineolaris, wooly apple aphid Eriosoma lanigerum, mango hopper Amritodus atkinsoni, Idioscopus spp.; order Lepidoptera, army worm Mythimna unipuncta, asiatic rice borer Chilo suppressalis, bean pod borer Maruca vitrata, beet armyworm Spodoptera exigua, black cutworm Agrotis ipsilon, bollworm Helicoverpa armigera, cabbage looper Trichoplusia ni, codling moth Cydia pomonella, croton caterpillar Achea janata, diamond backmoth Plutella xylostella, cabbage worm Pieris rapae, pink bollworm Pectinophora gossypiella, sugarcane borer Diatraea saccharalis, tobacco budworm Heliothis virescens, tomato fruitworm Helicoverpa zea, velvet bean caterpillar Anticarsia gemmatalis, yellow stem borer Scirpophaga incertulas, spotted bollworm Earias vittella, rice leaffolder Cnaphalocrocis medinalis, pink stem borer Sesamia spp., tobacco leafeating caterpillar Spodoptera litura; brinjal fruit and shoot borer Leucinodes orbonalis, bean pod borer Maruca vitrata, Maruca testulalis, armyworm Mythimna separata, cotton pinkbollworm Pectinophora gossypiella, citrus leafminer Phyllocnistis citrella, cabbage butterfly Pieris bras-sicae, diamond backmoth Plutella xylostella, paddy stem borer Scirpophaga excerptallis, Scirpophaga incertulas, Scirpophaga innotata, wheat stem borer Sesamia inferens, Sitotroga cerealella, Spilosoma obliqua, Spodoptera frugiperda, Spodoptera littoralis, Spodoptera litura, Trichoplusia ni, Tryporyza novella, Tuta absoluta; from the order Coleoptera, for example, apple twig borer Amphicerus spp., corn root worm Diabrotica virgifera, cucumber beetle diabrotica balteata, boll weevil Anthonomus grandis, grape flea beetle Altica chalybea, grape root worm Fidia viticola, grape trunk borer Clytoleptus albofasciatus, radish flea beetle Phyllotreta armoraciae, maize weevil Sitophilus zeamais, northern corn rootworm Diabrotica barberi, rice water weevil Lissorhoptrus oryzophilus, Anthonomus grandis, Bruchus lentis, Diabrotica semipunctata, Diabrotica virgifera, Dicladispa armigera, Epila-chna varivestis, various species of white grubs are Holotrichia bicolor, Holotrichia consanguinea, Holotrichia serrata, Leptinotarsa decemlineata, Phyllotreta chrysocephala, Popillia japonica etc; from the order Orthoptera, for example, Gryllotalpa spp., Locusta spp., and Schistocerca is spp.; from the order Thysanoptera, for example, Frankliniella spp., Thrips palmi, Thrips tabaci and Scirtothrips dorsalis; termites (Isoptera), e.g. Calotermes flavicollis, Coptotermes formosanus, Heterotermes aureus, Leucotermes flavipes, Microtermes obesi, Odontotermes obesus, Reticulitermes flavipes, Termes natalensis; from the order Heteroptera, for example, Dysdercus spp., Leptocorisa spp., from the order Hymenoptera, for example, Solenopsis spp.; from the order Diptera, for example, Antherigona soccata, Dacus spp., Liriomyza spp., Melanagromyza spp., from the order Acarina, for example, Aceria mangiferae, Brevipalpus spp., Eriophyes spp., Oligonychus mangiferus, Oligonychus punicae, Panonychus citri, Panonychus ulmi, Polyphagotarsonemus latus, Tarsonemus spp., Tetranychus urticae, Tetranychus cinnabarinus.

Additionally the present composition is also active against plant parasitic nematodes such as root-knot nematodes, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species; seed gall nematodes, Anguina funesta, Anguina tritici and other Anguina species; stem and foliar nematodes, Aphelenchoides besseyi, Aphelen-choides fragariae, Aphelenchoides ritzemabosi and other Aphelenchoides species; sting nematodes, Belonolaimus longicaudatus and other Belonolaimus species; pine nematodes, Bursaphelenchus xylophilus and other Bursaphelenchus species; ring ne-matodes, Criconema species, Criconemella species, Criconemoides species, and Me-socriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Helicotylenchus species, Rotylenchus robustus and other Roty-lenchus species; sheath nematodes, Hemicycliophora species and Hemicriconemoides species; Hirshmanniella species; lance nematodes, Hoplolaimus columbus, Hoplolai-mus galeatus and other Hoplolaimus species; false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species; burrowing nematodes, Radopholus similis and other Radopholus species; reniform nematodes, Rotylenchulus reniformis and other Rotylenchulus species; Scutellonema species; stubby root nematodes, Tri-chodorus primitivus and other Trichodorus species; Paratrichodorus minor and other Paratrichodorus species; stunt nematodes, Tylenchorhynchus claytoni, Tylenchorhyn-chus dubius and other Tylenchorhynchus species and Merlinius species; citrus nematodes, Tylenchulus semipenetrans and other Tylenchulus species; dagger nematodes, Xiphinema americanum, Xiphinema index, Xiphinema diversicaudatum and other Xi-phinema species; and other plant parasitic nematode species.

Formulation of the present invention can be in any of the formulations selected from Capsule suspension (CS), Dispersible concentrate (DC), Powder for dry seed treatment (DS), Emulsifiable concentrate (EC), Emulsion, water in oil (EO), Emulsion for foliar spray (ES), Emulsion, oil in water (EW), Flowable suspension/concentrate for foliar spray (FS), Granule/soil applied (GR), Controlled (Slow or Fast) release granules (CR), Jambo balls or bags (bags in water soluble pouch), Solution for foliar spray (LS), Micro-emulsion (ME), Oil dispersion (OD), Oil miscible flowable concentrate (oil miscible suspension (OF), Oil miscible liquid (OL), Suspension concentrate (=flowable concentrate) (SC), Suspo-emulsion (SE), Water soluble granule (SG), Soluble concentrate (SL), Water soluble powder (SP), Water dispersible granule (WG or WDG), Wettable powder (WP), Water dispersible powder for slurry treatment (WS), A mixed formulation of CS and SC (ZC), A mixed formulation of CS and SE (ZE), A mixed formulation of CS and EW (ZW).

One or more of the active ingredients can be encapsulated for various purposes, such as to increase the residual biological activity, or to reduce the acute toxicity, or to obtain a physical or chemically stable water-based formulation. The purpose determines whether the “free” active ingredient and the “release rate” are relevant properties of a specific product.

Further (A) Diamide insecticide; (B) one or mixture of Plant health additives; (C) one more Insecticide; are the bioactive ingredient for the present mixture present in specific fixed ratio. 0.1% to 40% w/w Diamide insecticide; 0.001% to 20% w/w Plant health additives; and 0.1% to 40% another Insecticide; is present in the novel synergistic mixture.

| | Compounds | | |
|---|---|---|---|
| | Compound A | Compound B | Compound C |
| Composition | Diamide Insecticide | Plant Health | Insecticide |
| | | Additives | |
| Ratio | 0.1%-40% w/w | 0.001%-20% w/w | 0.1%-40% w/w |

The process for preparing the present synergistic mixture can be modified accordingly by any person skilled in the art based on the knowledge of manufacturing the formulation. However all such variations and modifications are covered by the scope of the present invention.

The composition of the present invention in addition to bioactive amounts of active ingredients further comprises inactive excipients including but not limited to dispersant or dispersing agent, anti-freezing agent, anti-foam agent, wetting agent, suspension aid, disintegrating agent, thickener, slow (controlled) releasing agents and buffering agent.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank or other vessel to reduce the wetting time of wettable powders and to improve the penetration of water into water-dispersible granules.

Examples of wetting agent used herein for CS (Capsule Suspension) formulation include but not limited to Ethylene oxide/propylene oxide block copolymer, Polyarylphenyl ether phosphate, Ethoxylated Fatty Alcohol, Sodium dioctyl sulfosuccinate, sodium lauryl sulphate and sodium dodecyl benzene sulfonate, alkyl diphenyl sulfonates, sodium isopropyl naphthalene sulfonate, Alkyl naphthalene sulfonate, Octyl phenol ethoxylate, alkyl phenol ethoxylate.

Examples of wetting agent used herein for Granule (GR) and Controlled Release Granule (CR-GR) formulation include but not limited to Mono C2-6 alkyl ether of a poly C2-4 alkylene oxide block copolymer, condensation product of castor oil and polyC2-4 alkylene oxide, alkoxylated castor oil is available under the trade name Agnique CSO-36, a mono- or di-ester of a C12-24 fatty acid and polyC2-4 alkylene oxide, carboxylates, sulphates, sulphonates, alcohol ethoxylates, alkyl phenol ethoxylates, fatty acid ethoxylates, sorbitan esters, ethoxylated fats or oils, amine ethoxylates, phosphate esters, ethylene oxide-propylene oxide copolymers, fluorocarbons, alkyd-polyethylene glycol resin, polyalkylene glycol ether, apolyalkoxylated nonyl phenyl, alkoxylated primary alcohol, ethoxylated distyrylphenol, ethoxylated distyrylphenol sulphate, ethoxylated tristyrylphenol phosphate, tristyrylphenol phosphate ester, hydroxylated stearic acid polyalkylene glycol polymer, and their corresponding salts, alkyd-polyethylene glycol resin, polyalkylene glycol ether, ethoxylated distyrylphenol, ethoxylated distyrylphenol sulphate, ethoxylated tristyrylphenol phosphate, tristyrylphenol phosphate ester, tristyrylphenol phosphate potassium salt, dodecysulfate sodium salt

Examples of wetting agent used herein for SC (Suspension concentrate) formulation include but not limited to ethylene oxide/propylene oxide block copolymer, polyarylphenyl ether phosphate, ethoxylated fatty alcohol, sodium dioctyl sulfosuccinate, sodium lauryl sulfate and sodium dodecyl benzene sulfonate, alkyl diphenyl sulfonates, sodium isopropyl naphthalene sulfonate, alkyl naphthalene sulfonate.

Examples of wetting agent used herein for Oil dispersion (OD) formulation includes but not limited to ethylene oxide/propylene oxide block copolymer, polyarylphenyl ether phosphate, ethoxylated fatty alcohol, sodium dioctyl sulfosuccinate, sodium lauryl sulfate and sodium dodecyl benzene sulfonate, alkyl diphenyl sulfonates, sodium isopropyl naphthalene sulfonate, alkyl naphthalene sulfonate.

Examples of wetting agent used herein for SE (Suspo Emulsion) formulation includes but not limited to Ethylene oxide/propylene oxide block copolymer, Polyarylphenyl ether phosphate, Ethoxylated Fatty Alcohol, Sodium dioctyl sulfosuccinate, sodium lauryl sulphate and sodium dodecyl benzene sulfonate, alkyl diphenyl sulfonates, sodium isopropyl naphthalene sulfonate, Alkyl naphthalene sulfonate, Octyl phenol ethoxylate, alkyl phenol ethoxylate and aliphatic alcohol ethoxylate or mixture thereof.

Examples of wetting agent used herein for WG (Wettable Granule), WDG (Water Dispersible Granule) formulation includes but not limited to sodium N-methyl-N-oleoyl taurate, alkylated naphtalene sulfonate, sodium salt, mixture of isomers of dibutyl naphthalene sulphonic acid sodium salt, sodium di isopropyl naphthalene sulphonate, sodium Lauryl sulfate, dioctyl sulfate, alkyl naphthalene sulfonates, phosphate esters, sulphosuccinates and non-ionics such as tridexyl alcohol ethoxylate, alkyl or alkaryl sulfonates such as alkyl benzene sulfonates, alpha olefin sulfonate and alkyl naphthalene sulfonates, ethoxylated or non-ethoxylated alkyl or alkyaryl carboxylates, alkyl or alkyaryl phosphate esters, alkyl polysaccharide, di or mono alkyl sulfosuccinate derivatives, alpha olefin sulfonates, alkyl naphthalene sulfonates, dialkyl sulphosuccinates, butyl, dibutyl, isopropyl and diisopropyl naphthalene sulfonate salts, C₁₂ alkyl benzene sulfonate or C₁₀-C₁₆ alkyl benzene sulfonate.

Examples of Wetting-spreading-penetrating agent used herein for CS (Capsule Suspension) formulation include but not limited to Organosilicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof etc;

Examples of Wetting-spreading-penetrating agent used herein for Oil dispersion (OD) formulation include but not limited to Organo silicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof etc;

Examples of Wetting-spreading-penetrating agent used herein for Suspension Concentrate (SC) formulation include but not limited to Organo silicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof etc.

Examples of Wetting-spreading-penetrating agent used herein for Suspo-emulsion (SE) formulation include but not limited to Organo silicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof etc.

Examples of Wetting-spreading-penetrating agent used herein for WG (Wettable Granule), WDG (Water Dispersible Granule) formulation include but not limited to Organo silicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof etc.

A dispersant or a dispersing agent is a substance which adsorbs onto the surface of particles and helps to preserve the state of dispersion of the particles and prevents them from re-aggregating. Dispersants are added to agrochemical formulations to facilitate dispersion and suspension during manufacture, and to ensure the particles re-disperse into water in a spray tank. They are widely used in wettable powders, suspension concentrates and water-dispersible granules. Surfactants that are used as dispersants have the ability to adsorb strongly onto a particle surface and provide a charged or steric barrier to re-aggregation of particles. The most commonly used surfactants are anionic, non-ionic, or mixtures of the two types. For wettable powder formulations, the most common dispersants are sodium lingo sulphonates. In recent years, new types of very high molecular weight polymeric surfactants have been developed as dispersants. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces.

Examples of dispersing agent used herein for CS (Capsule Suspension) formulation include but not limited to Ethoxylated lignosulfonic acid salts, lignosulfonic acid salts, oxidized lignins, lignin salts, salts of styrenemaleic anhydride copolymers, polyvinyl alcohol, salts of partial esters of styrene-maleic anhydride copolymers, partial salts of polyacrylic acid and partial salts of polyacrylic acid terpolymers. the surfactant is lignosulfonate of calcium or sodium or mixtures thereof or a modified kraft lignin with a high sulfonic acid group, dibutylnaphthalenesulfonic acid, fatty acids, alkyl- and alkylarylsulfonates, alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkyl phenyl polyglycol ethers, tributyl phenyl polyglycol ethers, alkyl aryl polyether alcohols, is tridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulphite waste liquors, and proteins, denatured proteins, polysaccharides, ammonium salts of sulfonates, sulfates, phosphates or carboxylates, alkylarylsulfonates, diphenyl sulfonates, alpha-olefin sulfonates, sulfonates of fatty acids and oils, sulfonates of ethoxylated alkylphenols, sulfonates of condensed naphthalene, sulfonates of dodecyl- and tridecyl benzenes, sulfonates of naphthalene and alkylnaphthalenes, sulfosuccinates or sulfosuccinates, alkoxylates, N-alkylated fatty acid amides, amine oxides, esters or sugar-based surfactants, alkylphenols, amines (e.g. tallow amine), amides, aryl phenols, fatty acids or fatty acid esters which have been alkoxylated. Ethylene oxide and/or propylene oxide may be employed for the alkoxylation, preferably ethylene oxide, polyethylene oxide and polypropylene oxide, polyacids or polybases.

Examples of Dispersing agent used herein for Granule (GR) and Controlled Release Granule (CR-GR) formulation include but not limited to Copolymer of propylene oxide (PO) and ethylene oxide (EO) and/or an ethoxylated tristyrene phenol, copolymer of PO and EO is alpha-butyl-omega-hydroxypoly (oxypropylene) block polymer with poly(oxyethylene), ethoxylated tristyrene phenol is alpha-[2,4,6-tris[1-(phenyl)ethyl] phenyl]-omega-hydroxy poly(oxyethylene, poly(oxy-1,2-ethanediyl)-alpha-C10-15 alkyl-omega-hydroxy phosphate or sulphate and/or a C10-13alkylbenzenesulfonic acid, tristyrylphenols, nonylphenols, dinonylphenol and octyl phenols, styryl phenol poly ethoxyester phosphate, alkoxylated C14-20 fatty amines.

Examples of dispersants or dispersing agent used herein for SC (Suspension concentrate) formulation include but not limited to alkylated naphthalene sulfonate, sodium salt, sodium salt of naphthalene sulfonate condensate, sodium ligno sulfonate, sodium ploycarboxylate, EO/PO based copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide.

Examples of dispersants or dispersing agent used herein for Oil dispersion (OD) formulation includes but not limited to alkyl sulfonates, alkyl benzene sulfonates, alkyl aryl sulfonates, alkylphenolalkoxylates, tristyrylphenol ethoxylates, natural or synthetic fatty ethoxylate alcohols, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers), fatty acid-polyalkylene glycol condensates, polyamine-fatty acid condensates, polyester condensates, salts of polyolefin condensates, sodium ligno sulfonate, sodium ploycarboxylate, EO/PO based copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide.

Examples of dispersants or dispersing agent used herein for SE (Suspo Emulsion) formulation includes but not limited to alkylated naphthalene sulfonate, sodium salt, sodium salt of naphthalene sulfonate condensate, sodium ligno sulfonate, sodium ploycarboxylate, EO/PO block copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyryl phenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide, polyesters, polyamides, poly-carbonates, polyurea and polyurethanes, acrylic polymers and copolymers, styrene copolymers, butadiene copolymers, polysaccharides such as starch and cellulose derivatives, vinylalcohol, vinylacetate and vinylpyrrolidone polymers and copolymers, polyethers, epoxy, phenolic and melamine resins, polyolefins and define copolymers and mixtures thereof. Examples of preferred polymers are acrylate polymers such as poly(methacrylate), poly(ethyl methacrylate), poly(methyl methacrylate), acrylate copoylmers and styrene-acrylic copolymers as defined herein below, poly(styrene-co maleic anhydride), cellulosic polymers such as ethyl cellulose, cellulose acetate, cellulose acetatebutyrate, acetylated mono, di, and triglycerides, poly(vinylpyrrolidone), vinyl acetate polymers and copolymers, poly(alkylene glycol), styrene butadiene copolymers, poly(orthoesters), alkyd resins, and mixtures of two or more of these. Polymers that are biodegradable are also useful in the present invention. As used herein, a polymer is biodegradable if is not water soluble, but is degraded over a period of several weeks when placed in an application environment. Examples of biodegradable polymers that are useful in the present invention include biodegradable polyesters, starch, polylactic acid starch blends, polylactic acid, poly(lactic acid-glycolic acid) copolymers, polydioxanone, cellulose esters, ethyl cellulose, cellulose acetate butyrate, starch esters, starch esteraliphatic polyester blends, modified corn starch, polycaprolactone, poly(namylmethacrylate), wood rosin, polyanhydrides, polyvinylalcohol, polyhydroxybutyratevalerate, biodegradable aliphatic polyesters, and polyhydroxybutyrate or mixtures thereof.

Examples of dispersants or dispersing agent used herein for WG (Wettable Granule), WDG (Water Dispersible Granule) formulation include but not limited to naphthalene sulfonic acid, sodium salt condensated with formaldehyde, polyalcoxylated alkylphenol, naphthalenesulfonic acid formaldehyde condensate, methylnaphtaline-formaldehyde-condensate sodium salt, napthalene condensates, lignosulfonates, polyacrylates and phosphate esters, calcium lignosulfonate, lignin sulfonate sodium salt.

Antifoaming agent for the present formulation is selected from various compounds and selectively used according to the formulation. Generally, there are two types of antifoam agents, namely silicones and non-silicones. Silicones are usually aqueous emulsions of dimethyl poly siloxane while the non-silicone anti-foam agents are water-insoluble oils, such as octanol and nonanol, or silica. In both cases, the function of the anti-foam agent is to displace the surfactant from the air-water interface.

Examples of antifoaming agent used herein for CS (Capsule Suspension) formulation include but not limited to silicone oil, silicone compound, C10˜C20 saturated fat acid compounds or C8˜-C10 aliphatic alcohols compound, Silicone antifoam emulsion, Dimethyl siloxane, Polydimethyl siloxane, Vegetable oil based antifoam, tallow based fatty acids, polyalkyleneoxide modified polydimethylsiloxane etc;

Examples of Antifoaming agent used herein for SC (Suspension concentrate), Oil dispersion (OD) formulation and SE (Suspo Emulsion) formulation include but not limited to silicone oil, silicone compound, C10˜C20 saturated fat acid compounds or C8˜C10 aliphatic alcohols compound, silicone antifoam emulsion, dimethyl siloxane, poly dimethyl siloxane, vegetable oil based antifoam, tallow based fatty acids, polyalkylene oxide modified polydimethylsiloxane.

Examples of Antifoaming agent used herein for WG (Wettable Granule), WDG (Water Dispersible Granule) formulation includes but not limited to polydimethyl siolxane.

Anti-freezing agent for the present formulation is selected from various compounds and selectively used according to the formulation.

Examples of Anti-freezing agent used herein for CS (Capsule Suspension) formulation include but not limited to ethylene glycol, propane diols, glycerine or the urea, Glycol (Monoethylene glycol, Diethylene glycol, Polypropylene glycol, Polyethylene glycol), Glycerine, Urea, Magnesium sulphate heptahydrate, sodium chloride etc.

Examples of Anti-freezing agent used herein for SC (Suspension concentrate) and Oil dispersion (OD) formulation and SE (Suspo Emulsion) formulation include but not limited to ethylene glycol, propane diols, glycerine or the urea, glycol (monoethylene glycol, diethylene glycol, polypropylene glycol, polyethylene glycol), glycerine, urea, magnesium sulfate heptahydrate, sodium chloride.

Disintegrating agent used herein for the WG (Wettable Granule), WDG (Water Dispersible Granule) formulation is selected from citric acid, succinic acid or the sodium bicarbonate.

Examples of Preservatives used herein for CS (Capsule Suspension) formulation include but not limited to 1,2-benzisothiazolin-3(2H)-one, sodium salt, Sodium benzoate, 2-bromo-2-nitropropane-1,3-diol, Formaldehyde, Sodium o-phenyl phenate, 5-chloro-2-methyl-4-isothiazolin-3-one & 2-methyl-4-isothiazolin-3-one.

Preservative used herein for the SC (Suspension concentrate) formulation and Oil dispersion (OD) formulation include but not limited to 1,2-benzisothiazolin-3(2H)-one, sodium salt, Sodium benzoate, 2-bromo-2-nitropropane-1,3-diol, Formaldehyde, Sodium o-phenylphenate, 5-chloro-2-methyl-4-isothiazolin-3-one & 2-methyl-4-isothiazolin-3-one.

Preservative used herein for the SE (Suspo Emulsion) formulation include but not limited to propionic acid and its sodium salt, sorbic acid and its sodium or potassium salt, benzoic acid and its sodium salt, p-hydroxy benzoic acid sodium salt; methyl p-hydroxy benzoate; and biocide such as sodium benzoate, 1,2-benzisothiazoline-3-one, 2-methyl-4-isothiazolin-3-one, 5-chloro-2-methyl-4-isothiazolin-3-one, potassium sorbate, para hydroxy benzoates or mixtures thereof.

Examples of Thickeners used herein for CS (Capsule Suspension) formulation include but not limited to 1 Xanthan gum, Carboxy methyl cellulose, Attapulgite clay, Bentonite clay.

Thickeners or gelling agents are used mainly in the formulation of suspension concentrates, emulsions and suspo-emulsions to modify the rheology or flow properties of the liquid and to prevent separation and settling of the dispersed particles or droplets. Thickening, gelling, and anti-settling agents generally fall into two categories, namely water-insoluble particulates and water-soluble polymers.

Examples of thickeners used herein for SC (Suspension concentrate) formulation include but not limited to xanthan gum, PVK, carboxymethylcelluloses, polyvinyl alcohols, gelatin, sodium carboxy methylcellulose, hydroxyethyl cellulose, sodium polyacrylate, modified starch.

Examples of thickeners used herein for SE (Suspo Emulsion) formulation include various compound depending upon the nature of the composition. Thickening, gelling, and anti-settling agents generally fall into two categories, namely water-insoluble particulates and water-soluble polymers. It is possible to produce suspension concentrate formulations using clays and silicas. Examples of these types of materials, include, but are limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and 15 seaweeds are synthetic derivatives of cellulose or mixtures thereof. Examples of these types of materials include, but are not limited to, guar gum; locust bean gum; carrageenam; xanthan gum; alginates; methyl cellulose; sodium carboxymethyl cellulose (SCMC); hydroxyethyl cellulose (HEC) or mixtures thereof. Other types of anti-settling agents are based on modified starches, polyacrylates, polyvinyl 20 alcohol and polyethylene oxide or mixtures.

Suspension aid or the suspending agent in the present description denotes a natural or synthetic, organic or inorganic material with which the active substance is combined in order to facilitate its application to the plant, to the seeds or to the soil. This carrier is hence generally inert, and it must be agriculturally acceptable, in particular to the plant being treated. The carrier may be solid (clays, natural or synthetic silicates, silica, resins, waxes, solid fertilizers, and the like or mixtures thereof) or liquid (water, alcohols, ketones, petroleum fractions, aromatic or paraffinic hydrocarbons, chlorinated hydrocarbons, liquefied gases, and the like or mixtures thereof).

Examples of suspending agent used herein for CS (Capsule Suspension) formulation include but not limited to Aluminium Magnesium Silicate, Bentonite clay, Silica, Attapulgite clay.

Examples of suspending agent used herein for SC (Suspension concentrate) formulation, SE (Suspo Emulsion) formulation include but not limited to Aluminum Magnesium Silicate, Bentonite clay, Silica, Attapulgite clay.

Controllled release agent used herein for Granule (GR) and Controlled Release Granule (CR-GR) formulation includes but not limited to xanthan gum, PVK, carboxymethyl celluloses, polyvinyl alcohols, gelatin, sodium carboxymethylcellulose, hydroxyethyl cellulose, Sodium Polyacrylate, modified starch, parafin wax, polyvinyl acetate, montan wax and vinyl acetate, polyethylene glycol 6000, cationic hydrosoluble polymer, C4 alkylated polyvinyl pyrrolidone.

Carrier for the present formulation is selected from selected from various compounds and selectively used according to the formulation.

Examples of Carrier used herein for Oil dispersion (OD) formulation include but not limited to olive oil, kapok oil, castor oil, papaya oil, camellia oil, sesame oil, corn oil, rice bran oil, peanut oil, cotton seed oil, soybean oil, rapeseed oil, linseed oil, tung oil, sunflower oil, safflower oil, coconut oil, alkyl ester of vegetable oils, (e.g. rapeseed oil methyl ester or rapeseed oil ethyl ester, rapeseed oil propyl esters, rapeseed oil butyl esters, neem oil, tall oil fatty acids esters etc.), diesel, mineral oil, fatty acid amides (e.g. C1-C3 amines, alkylamines or alkanolamines with C6-Ci8 carboxylic acids), fatty acids, tall oil fatty acids, alkyl esters of fatty acids (e.g. Ci, Methyl and ethyl oleate, methyl and ethyl soyate, alkyl benzenes and alkyl naphthalenes, polyalkylene glycol ethers, fatty acid diesters, fatty alkylamides and diamides, dialkylene carbonates, ketones and alcohols. The above oil based carrier/diluting agents may be used as solo or mixture of two or more if desired. All the said oils used as a carrier or diluent are procured from the vendor based in Gujarat State.

Examples of Carrier used herein for WG (Wettable Granule), WDG (Water Dispersible Granule) formulation includes but not limited to china clay, silica, lactose anhydrous, ammonium sulfate, sodium sulfate anhydrous, corn starch, urea, EDTA, urea formaldehyde resin, diatomaceous earth, kaolin, bentonite, kieselguhr, fuller's earth, attapulgite clay, bole, loess, talc, chalk, dolomite, limestone, lime, calcium carbonate, powdered magnesia, magnesium oxide, magnesium sulfate, sodium chloride, gypsum, calcium sulfate, pyrophyllite, silicates and silica gels; fertilizers such as, for example, ammonium sulfate, ammonium phosphate, ammonium nitrate and urea; natural products of vegetable origin such as, for example, grain meals and flours, bark meals, wood meals, nutshell meals and cellulosic powders; and synthetic polymeric materials such as, for example, ground or powdered plastics and resins, bentonites, zeolites, titanium dioxide, iron oxides and hydroxides, aluminium oxides and hydroxides, or organic materials such as bagasse, charcoal, or synthetic organic polymers.

Examples of Carries used herein for Granule (GR) and Controlled Release Granule (CR-GR) formulation include but not limited to Diatomaceous earth, attapulgite or zeolites, dolomite, limestone, silica, fly ash, hydrated lime, wheat flour, wood flour, ground wheat straw, cellulose and soy flour, bentonite, kaolin, attapulgite, diatomaceous earth, calcium carbonate, talc, muscovite mica, fused sodium potassium, aluminum silicate, perlite, talc and muscovite mica, urea, sulfur-coated urea, isobutylidene diurea, ammonium nitrate, ammonium sulfate, ammonium phosphate, triple super phosphate, phosphoric acid, potassium sulfate, potassium nitrate, potassium metaphosphate, potassium chloride, dipotassium carbonate, potassium oxide and a combination of these. Calcium, magnesium, sulfur, iron, manganese, copper, zinc; oxides, humic acid, Wood floor, Calcium silicate, Cellulose granules, Magnesium stearate.

Examples of Solvents used herein for CS (Capsule Suspension) formulation include but not limited to Hydrocarbon solvent such a an aliphatic, cyclic and aromatic hydrocarbons (e.g. toluene, xylene, paraffin, tetrahydronaphthalene, alkylated naphthalene or their derivatives, mineral oil fractions of medium to high boiling point (such as kerosene, diesel oil, coal tar oils)); a vegetable oil such as corn oil, rapeseed oil; a fatty acid ester such as C1-C10-alkylester of a C10-C22-fatty acid; or, methyl- or ethyl esters of vegetable oils such as rapeseed oil methyl ester or corn oil methyl ester, acetophenone, 2-Heptanon, 3-heptanone, 2-hexanone, 5-methyl-2-hexanone, 5-methyl-3-heptanone, 3-methyl-2-hexanone, 4-methyl-2-hexanone, 2-methyl-3-hexanone, 4-methyl-3-hexanone, 5-methyl-3-hexanone, 3-ethyl-2-pentanone, 3,3-dimethyl-2-pentanone, 3,4-dimethyl-2-pentanone, 4,4-dimethyl-2-pentanone, 2,2-dimethyl-3-pentanone, 2,4-dimethyl-3-pentanone, 2-octanone, 2,5-dimethyl-3-hexanone, 2,2-dimethyl-3-hexanone, 3,3-dimethyl-2-hexanone, 3,4-dimethyl-2-hexanone, 4,4-dimethyl-3-hexanone, 3-ethyl-4-methyl-2-pentanone, 2-methyl-3-heptanone, 2-methyl-4-heptanone, 3-methyl-2-heptanone, 3-methyl-4-heptanone, 5-methyl-3-heptanone, 6-methyl-2-heptanone, 6-methyl-3-heptanone, 3-octanone, 4-octanone, 2,2,4-trimethyl-3-pentanone, 3-ethyl-3-methyl-2-pentanone, 5-methyl-2-heptanone, isoprene. All the said oils used as a solvents are procured from the vendor based in Gujarat State.

Examples of Solvents used herein for Granule (GR) and Controlled Release Granule (CR-GR) formulation include but not limited to Fatty acid methyl ester, cyclohexane, xylene, mineral oil or kerosene, mixtures or substituted naphthalenes, mixtures of mono- and polyalkylated aromatics, dibutyl phthalate or dioctyl phthalate, ethylene glycol monomethyl or monoethyl ether, butyrolactone, octanol, castor oil, soybean oil, cottonseed oil, epoxidised coconut oil or soybean oil, aromatic hydrocarbons, dipropyleneglycol monomethylether, polypropylene glycol [M.W. 2000-4000], polyoxyethylene polyoxypropylene glycols, polyoxypropylene polyoxyethylene glycols, diethyleneglycol, polyethylene glycol [M.W. 200-4000 amu], methoxy polyethylene glycols 350, 550, 750, 2000, 5000; glycerol, methyl oleate, n-octanol, alkyl phosphates such as tri-n-butyl phosphate, propylene carbonate and isoparaffinic, tetrahydrofurfuryl alcohol, gamma-butyrolactone, N-methyl-2-pyrrolidone, tetramethylurea, dimethylsulfoxide, N,N-dimethylacetamide, Diacetone alcohol, Polybutene, Propylene carbonate, Dipropylene glycol isomer mixture. All the said oils used as a solvents are procured from the vendor based in Gujarat State.

Example of solvents used herein for the SE (Suspo Emulsion) formulation includes but not limited to water, water soluble alcohols and dihydroxy alcohol ethers. Water soluble alcohol or lower alcohol (1-4 carbon atoms) includes-methanol, ethanol, n-propanol, isopropanol, n-butanol, tert-butanol. Macromolecular alcohol includes polyethylene glycol, sorbitol, glucitol etc., dihydroxy alcohol ethers includes dihydroxy alcohol alkyl ether or dihydroxy alcohol aryl ethers. The examples of dihydroxy alcohol alkyl ether include ethylene glycol methyl ether, diethylene glycol methyl ether, propylene glycol methyl ether, di-propylene glycol methyl ether, ethylene glycol ethyl ether, diethylene glycol ethyl ether, propylene glycol ethyl ether, di-propylene glycol ethyl ether, etc. The examples of dihydroxy alcohol aryl ethers include ethylene glycol phenyl ether, 5 diethylene glycol phenyl ether, propylene glycol phenyl ether, di-propylene glycol phenyl ether, and the like. Any of the mentioned solvent can be used either alone or in combinations thereof. Paraffinic hydrocarbons, cyclohexanone, isophorone and ester solvents such as methyloleate, dimethylamide and morpholineamide derivatives of C6-C16 fatty acids, and mono-alkylene carbonates such as ethylene carbonate, propylene carbonate and butylene carbonates, dimethylsulfoxide (DMSO), 2-ethylhexanol and n-butanol, n-alkylpyrrolidones, fatty acid dimethyl esters, fatty acid esters, dibasic esters, aromatic hydrocarbons and/or aliphatic hydrocarbons, one or more dimethylamides, such as C8-dimethylamide, C10-dimethylamide, C12-dimethylamide, ethylene glycol, propylene glycol, polyalkylene glycols, aromatic hydrocarbons, methylpyrrolidinone (NMP); dimethylformamide (DMF); dimethylisosorbide (DMI); isophorone; acetophenone; 1,3-dimethyl-2-imidazolidonone; lactate esters; dimethyl and diethylcarbonates; alcohols including methanol; ethanol; iso-propanol; n-propanol; n-butanol; iso-butanol; and tert-butanol; Methyl L-lactate, 2-Ethylhexyl L-lactate, Ethyl L-lactate, n-Butyl L-lactate, Octyl phenyl ethoxylates.

Examples of Colouring agents for Granule (GR) and Controlled Release Granule (CR-GR) formulation include but not limited to Crystal violet, Thalocyano dye chlorinated, Aerosol green FFB dye, Rodamine, Azo compound.

Emulsifying agent used herein for the Oil dispersion (OD) formulation includes but not limited to castor oil ethoxylates, alcohol ethoxylates, fatty acid ethoxylates, sorbitan ester ethoxylates, sulphosuccinate, calcium salts of dodecylbenzene sulphonate, alkylammonium salts of alkylbenzene sulphonate, alkylsulphosuccinate salts, ethylene oxide-propylene oxide block copolymers, ethoxylated alkylamines, ethoxylated alkyl phenols, polyoxyethylenesorbitan monolaurate.

Example of emulsifier used herein for the Suspo-emulsion (SE) formulation includes but not limited to salts of dodecylbenzene sulphonate, e.g. Ca-salts or amine salts, and sulphonates of other C11-C16 alkylbenzenes, alkylether sulphates, alkylphenoletherphosphates and ester phosphates; non-ionic surfactants such as alkoxylated alcohols and alkylphenols, ethoxylated fatty acids, ethoxylated vegetable oils, e.g. ethoxylated castor oil, fatty acid esters, e.g. of sorbitol, and their ethoxylated derivatives, ethoxylated amines, and condensates of glycerol; and catanionic emulsifiers such as a cationic amine, optionally in combination with an alkylsulphonate or ether sulphonate or ether phosphate, alkoxylated alcohols; alkoxylated alkylphenols; ethoxylated fatty acids; ethoxylated vegetable oils; ethoxylated tristyrylphenol; fatty acid esters of sorbitol and ethoxylated derivatives thereof; ethoxylated amines and condensates of glycerol; sulfonated alkylbenzenes in the range C11-C16 and salts thereof; alkylether sulphates; alkyletherphosphates; alkylphenoletherphosphates; or combinations thereof; salts of phosphate esters of ethoxylated tristyrylphenol; salts of sulphated ethers of ethoxylated tristyrylphenol; or a catanionic system, wherein a cationic amine is present in combination with an alkylsulphonate, an alkylethersulphonate, an ether sulphate, or an ether phosphate such as an alkyletherphosphate, nonylphenol polyethoxy ethanols, castor oil polyglycol ethers, polyadducts of ethylene oxide and polypropylene, tributyl phenoxy polyethoxy ethanol, octyl phenoxy polyethoxy ethanol.

Stabilizers or stabilizing agent used herein for the Oil dispersion (OD) formulation includes but not limited to hectorite clay, aluminum magnesium silicate, bentonite clay, silica, attapulgite clay.

Examples of Stabilizers or stabilizing agent used herein for the Suspo-emulsion (SE) formulation includes but not limited to butylated hydroxytoluene (BHT) and epoxidized soybean oil (ESBO), Epichlorhydrin.

Examples of Wall forming material 1 used herein for CS (Capsule Suspension) formulation include but not limited to Tetramethylene diisocyanate, pentamethylene diisocyanate, hexamethylene diisocyanate, toluene diisocyanate, diphenylmethene-4,4′-diisocyanate, polymethylene polyphenylene isocyanate, 2,4,4′-diphenyl ether tri-isocyanate, 3,3′-dimethyl-4,4′-diphenyl diisocyanate, 3,3′-dimethoxy-4,4′-diphenyl diisocyanate, 1,5-naphthylene diisocyanate and 4,4′ 4″-triphenylmethane tri-isocyanate, toluene diisocyanate or polymethylene polyphenylisocyanate, polyurethane comprising of polyfunctional iso cyanate and a polyamine in polarized form.

Examples of Wall forming material 2 used herein for CS (Capsule Suspension) formulation include but not limited to Ammonia, hexamine, ethylene diamine, propylene-1,3-diamine, tetramethylenediamine, pentamethylene diamine, 1,6-hexamethylene diamine, diethylene triamine, triethylenetetramine, tetra ethylene pentamine, pentaethylene hexamine, 4,9-dioxadodecane-1, 12-diamine, 1,3-phenylene diamine, 2,4- and 2,6-toluenediamine and 4,4′-diaminodiphenylmethane, 1,3-phenylenediamine, 2,4- and 2,6-toluenediamine, 4,4′-diaminodiphenylmethane, 1,5-diaminonaphthalene, 1,3,5-triaminobenzene, 2,4,6-triaminotoluene, 1,3,6-triaminonaphthalene, 2,4,4′-triaminodiphenyl ether, 3,4,5-triamino-1,2,4-triazole and 1,4,5,8-tetraminoanthraquinone.

Examples of Buffering agent used herein for CS (Capsule Suspension) formulation include but not limited to Sodium hydroxide, potassium hydroxide, acetic acid, sulphuric acid, hydrochloric acid, ortho phosphoric acid, ammonium hydroxide.

Buffering agent used herein for the SE (Suspo Emulsion) formulation includes but not limited to calcium hydroxyapatite, Potassium Dihydrogen Phosphate, Sodium Hydroxide, carbonated apatite, calcium carbonate, sodium bicarbonate, tricalcium phosphate, calcium phosphates, carbonated calcium phosphates, amine monomers, lactate dehydrogenase and magnesium hydroxide.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. The invention shall now be described with reference to the following specific examples. It should be noted that the example(s) appended below illustrate rather than limit the invention, and that those skilled in the art will be able to design many alternative embodiments without departing from the scope of the present invention.

These and other aspects of the invention may become more apparent from the examples set forth herein below. These examples are provided merely as illustrations of the invention and are not intended to be construed as a limitation thereof.

### Example 1

Granule (GR) formulation of Cyantraniliprole 0.5%+Zinc 1%+Flupyrimin 1%

| Chemical composition | % (w/w) |
|---|---|
| Cyantraniliprole | 0.50 |
| Zinc* | 1.00 |
| Flupyrimin | 1.00 |
| Wetting agent | 3.00 |
| Dispersing agent | 1.00 |
| Colourant | 0.50 |
| Solvent | 4.00 |
| Carrier | 89.00 |
| Total | 100.00 |

*Zinc here may or may not be nano particle form. The source of Zinc may be Zinc oxide, zinc sulphate, zinc lactate, zinc gluconate, zinc proteino-lacto gluconate.

Storage Stability-

Cyantraniliprole 0.5%+Zinc 1%+Flupyrimin 1% Granule (GR) formulation

Laboratory storage stability

| | Specification | | At 54 ± | At 0 ± |
|---|---|---|---|---|
| Parameters | (in house) | Initial | 2° C. | 2° C. |
| Cyantraniliprole content percent by mass | 0.475 to 0.55 | 0.53 | 0.52 | 0.51 |
| Zinc content percent by mass | 0.95 to 1.1 | 1.05 | 1.05 | 1.05 |
| Flupyrimin content percent by mass | 0.95 to 1.1 | 1.07 | 1.05 | 1.07 |
| pH range (1% aq. Suspension) | 4.0 to 7.0 | 5.50 | 5.50 | 5.50 |
| Dustiness | <20 mg | 10 | 10 | 10 |
| Dry sieve (300 micron) percent by mass min. | >90% | 99.5 | 99.2 | 99.3 |
| Attrition Resistance (<100 micron) | <5% | 2.1 | 2.1 | 2.1 |
| Bulk density (g/ml) | 1.25 to 1.50 | 1.3 | 1.3 | 1.3 |
| Moisture content percent by mass max. | max. 2% | 1 | 1 | 1 |

Room temperature storage stability

| | specification | 1 | 6 | 12 |
|---|---|---|---|---|
| Parameters | (in house) | month | months | months |
| Cyantraniliprole content percent by mass | 0.475 to 0.55 | 0.53 | 0.52 | 0.51 |
| Zinc content percent by mass | 0.95 to 1.1 | 1.05 | 1.05 | 1.05 |
| Flupyrimin content percent by mass | 0.95 to 1.1 | 1.07 | 1.05 | 1.03 |
| pH range (1% aq. Suspension) | 4.0 to 7.0 | 5.50 | 5.50 | 5.50 |
| Dustiness | <20 mg | 10 | 10 | 10 |
| Dry sieve (300 micron) percent by mass min. | >90% | 99.5 | 96.35 | 96.25 |
| Attrition Resistance (<100 micron) | <5% | 2.1 | 2.1 | 2.1 |
| Bulk density (g/ml) | 1.25 to 1.50 | 1.3 | 1.3 | 1.3 |
| Moisture content percent by mass max. | max. 2% | 1 | 1 | 1 |

Procedure: Manufacturing process of Granules (GR)/Soil Applied Granules (SAG):

Preparation of Granules (GR) / Soil Applied Granules (SAG):

| | |
|---|---|
| Step 1 | Charged required quantity of carrier into the booth mixture with help of |
| | bucket elevator, then add other raw material (as technical, solvent, |
| | Surfactant, stabilizer, and binder) into the booth mixture and at this point |
| | add filler and allow mixing for another 20 minutes for homogenization. |
| Step 2 | After completion of raw material addition and proper mixing, stop booth |
| | mixture for sampling. |
| Step 3- | Sample is sent for QC approval and approved material is unloaded into the |
| | approved packing materials as per the requirement. |

### Example 2

Granule (GR) formulation of Chlorantraniliprole 0.5%+Zinc 2%+Sulphur 18%+Fipronil 0.6%

| Chemical composition | % (w/w) |
|---|---|
| Chorantraniliprole | 0.50 |
| Zinc* | 2.00 |
| Sulphur | 18.00 |
| Fipronil | 0.60 |
| Wetting agent | 3.00 |
| Dispersing agent | 1.00 |
| Colourant | 0.50 |
| Solvent | 4.00 |
| Carrier | 70.40 |

*Zinc here may or may not be nano particle form. The source of Zinc may be Zinc oxide, zinc sulphate, zinc lactate, zinc gluconate, zinc proteino-lacto gluconate.

Storage Stability-

Storage stability study in laboratory and at room temperature shows that Chlorantraniliprole 0.5%+Zinc 2%+Sulphur 18%+Fipronil 0.6% GR formulation complies all the in-house parameters like active ingredients content, pH range, dustiness, dry sieve, attrition resistance, bulk density and moisture content.

Procedure: Manufacturing Process as per Example 1

### Example 3

Controlled Release Granule (CR-GR) Formulation of Cyantraniliprole 0.6%+Brassinolide 0.003%+Clothianidin 1% GR-SL (Granule Slow Release)

| Chemical composition | % (w/w) |
|---|---|
| Cyantraniliprole a.i. | 0.60 |
| Brassinolide a.i. | 0.003 |
| Clothianidin a.i. | 1.00 |
| Emulsifier | 1.00 |
| Controlled release agent-1 | 2.00 |
| Preservative | 0.05 |
| Antifoaming agent | 0.05 |
| Thickners | 0.50 |
| Controlled release agent-2 | 2.00 |
| Wetting agent | 3.00 |
| Dispersing agent | 1.00 |
| Water | 5.00 |
| Colourant | 0.50 |
| Innerts | 2.50 |
| Solvent | 4.00 |
| Carrier | 76.80 |
| Total | 100.00 |

Storage Stability-

Cyantraniliprole 0.6%+Brassinolide 0.003%+Clothianidin 1% Controlled Release Granule (CR-GR) formulation:

Laboratory storage stability

| | Specification | | At 54 ± | At 0 ± |
|---|---|---|---|---|
| Parameters | (in house) | Initial | 2° C. | 2° C. |
| Cyantraniliprole content percent by mass | 0.57 to 0.66 | 0.65 | 0.62 | 0.65 |
| Brassinolide content percent by mass | 0.00285 to 0.0033 | 0.003 | 0.003 | 0.003 |
| Clothianidin content percent by mass | 0.95 to 1.10 | 1.05 | 1.03 | 1.05 |
| pH range (1% aq. Suspension) | 4.0 to 7.0 | 5.50 | 5.50 | 5.50 |
| Dustiness | <20 mg | 10 | 10 | 10 |
| Dry sieve (300 micron) percent by mass min. | >90% | 99.5 | 99.2 | 99.3 |
| Attrition Resistance (<100 micron) | <5% | 2.1 | 2.1 | 2.1 |
| Bulk density (g/ml) | 1.25 to 1.50 | 1.35 | 1.35 | 1.35 |
| Moisture content percent by mass max. | max. 2% | 1.5 | 1.5 | 1.5 |

Room temperature storage stability

| | specification | 1 | 6 | 12 |
|---|---|---|---|---|
| Parameters | (in house) | month | months | months |
| Cyantraniliprole content percent by mass | 0.57 to 0.66 | 0.65 | 0.63 | 0.62 |
| Brassinolide content percent by mass | 0.00285 to 0.0033 | 0.003 | 0.003 | 0.003 |
| Clothianidin content percent by mass | 0.95 to 1.10 | 1.05 | 1.03 | 1.02 |
| pH range (1% aq. Suspension) | 4.0 to 7.0 | 5.50 | 5.50 | 5.50 |
| Dustiness | <20 mg | 10 | 10 | 10 |
| Dry sieve (300 micron) percent by mass min. | >90% | 99.5 | 96.35 | 96.25 |
| Attrition Resistance (<100 micron) | <5% | 2.1 | 2.1 | 2.1 |
| Bulk density (g/ml) | 1.25 to 1.50 | 1.35 | 1.35 | 1.35 |
| Moisture content percent by mass max. | max. 2% | 1.5 | 1.5 | 1.4 |

Procedure: Manufacturing Process of Controlled Release Granules (CR-GR) Formulation for Soil Application:

Preparation of controlled release granules (CR-GR) formulation:

| | |
|---|---|
| Part A | Preparation of active ingredient A slurry for Bentonite Granules |
| Step 1 | Load the Bentonite Granule carrier into an appropriate blender equipped with a |
| | heating jacket. |
| Step 2 | Charge water to a vessel, equipped with a high shear stirrer. Under stirring, add |
| | Dispersing and wetting agent. Continue stirring until the mixture gets |
| | homogenized. Then, again under the stirring add the active ingredient A |
| | technical to the vessel. |
| Step 3- | Pass the whole mixed mass through a bead-mill until specified particle size is |
| | achieved. Homogenize the milled suspension thoroughly. |
| Step 4- | Under gentle stirring, add Slow releasing agent 1 to milled slurry. Continue to |
| | stir until the suspension is thoroughly mixed. |
| Step 5- | Spray this slurry on Blank Bentonite granules by means of suitable spray nozzle |
| | and mix until uniform. |
| Part B | Preparation of active ingredient B slurry for Bentonite Granules |
| Step 1 | Mix the active ingredient B technical and solvent along with suitable |
| | Emulsifiers and wetting agent and make a solution |
| Step 2 | Now add Slow releasing agent 2 to this slurry and mix until uniform |
| Step 3- | Spray this slurry on active ingredient A treated Bentonite granules by means of |
| | suitable spray nozzle and mix until uniform. |
| Part C | Preparation of active ingredient C slurry for Bentonite Granules |
| Step 1 | Charge Water, colorant and the active ingredient C to the vessel, equipped with |
| | a high shear stirrer. Under stirring, add the thickener gradually. Now add |
| | Paraffin wax and continue to stir after the addition is completed and until the |
| | mixture is thoroughly mixed. |
| Step 2 | Now charge the active ingredient C gel solution onto these granules by means |
| | of suitable spray nozzle and mix until uniform. |
| Step 3 | Now add China clay and Silica on these coated Bentonite granules to make them |
| | free-flowing and mix until uniform |
| Step 4- | Dry the granules in the blender to about 40-450 C. The final product should be |
| | a free flowing, non-sticky granule. |
| Step 5- | Final product is sent for QC approval. |

### Example 4

Controlled Release Granule (CR-GR) Formulation of Chlorantraniliprole 0.5%+Salicylic Acid 0.4%+Thiamethoxam 1.25%

| Chemical composition | % (w/w) |
|---|---|
| Chlorantraniliprole a.i. | 0.50 |
| Salicylic acid a.i. | 0.40 |
| Thiamethoxam a.i. | 1.25 |
| Emulsifier | 1.00 |
| Controlled release agent-1 | 3.00 |
| Preservative | 0.05 |
| Antifoaming agent | 0.05 |
| Thickners | 0.50 |
| Controlled release agent-2 | 3.00 |
| Wetting agent | 3.00 |
| Dispersing agent | 1.00 |
| Water | 5.00 |
| Colourant | 0.50 |
| Innerts | 2.50 |
| Solvent | 4.00 |
| Carrier | 74.25 |
| Total | 100.00 |

Storage Stability-

Storage stability study in laboratory and at room temperature shows that Chlorantraniliprole 0.5%+Salicylic acid 0.4%+Thiamethoxam 1.25% GR-SL (Granule slow release) formulation complies all the in-house parameters like active ingredients content, pH range, dustiness, dry sieve, attrition resistance, bulk density and moisture content.

Procedure: Manufacturing Process as Per Example 3

### Example 5

Controlled Release Granule (CR-GR) Formulation of Cyantraniliprole 0.5%+Zinc 2.0%+Humic Acid 2.0%+Clothianidin 1.0%

| Chemical composition | % (w/w) |
|---|---|
| Cyantraniliprole a.i. | 0.50 |
| Zinc a.i. | 2.00 |
| Humic acid a.i. | 2.00 |
| Clothianidin a.i. | 1.00 |
| Emulsifier | 1.00 |
| Slow releasing agent 1 | 2.00 |
| Preservative | 0.05 |
| Antifoaming agent | 0.05 |
| Thickners | 0.50 |
| Slow releasing agent 2 | 1.50 |
| Wetting agent | 3.00 |
| Dispersing agent | 1.00 |
| Water | 5.00 |
| Colourant | 0.50 |
| Inerts | 2.50 |
| Solvent | 6.00 |
| Carrier | 71.40 |
| Total | 100.00 |

Storage Stability-

Cyantraniliprole 0.5%+Zinc 2.0%+Humic Acid 2.0%+Clothianidin 1.0% Controlled Release Granule (CR-GR) formulation:

Laboratory storage stability for 14 days

| | Specification | | At 54 ± | At 0 ± |
|---|---|---|---|---|
| Parameters | (In house) | Initial | 2° C. | 2° C. |
| Cyantraniliprole content percent by mass | 0.475 to 0.55 | 0.52 | 0.51 | 0.52 |
| Zinc content percent by mass | 1.90 to 2.20 | 2.10 | 2.10 | 2.10 |
| Humic acid content percent by mass | 1.90 to 2.20 | 2.10 | 2.10 | 2.10 |
| Clothianidin content percent by mass | 0.95 to 1.10 | 1.10 | 1.09 | 1.10 |
| pH range (1% aq. Suspension) | 4.0 to 6.0 | 5.00 | 5.10 | 5.00 |
| Dustiness | <20 mg | 10.00 | 10.00 | 10.00 |
| Dry sieve (300 micron) percent by mass min. | >90% | 99.50 | 99.20 | 99.40 |
| Attrition Resistance (<100 micron) | <5% | 2.10 | 2.10 | 2.00 |
| Bulk density (g/ml) | 1.25 to 1.50 | 1.30 | 1.30 | 1.30 |
| Moisture content percent by mass max. | max. 2% | 1.50 | 1.50 | 1.50 |

Room temperature storage stability up to 12 months

| | specification | 1 | 6 | 12 |
|---|---|---|---|---|
| Parameters | (in house) | month | month | month |
| Cyantraniliprole content percent by mass | 0.475 to 0.55 | 0.52 | 0.52 | 0.51 |
| Zinc content percent by mass | 1.90 to 2.20 | 2.10 | 2.10 | 2.08 |
| Humic acid content percent by mass | 1.90 to 2.20 | 2.10 | 2.10 | 2.08 |
| Clothianidin content percent by mass | 0.95 to 1.10 | 1.10 | 1.08 | 1.06 |
| pH range (1% aq. Suspension) | 4.0 to 6.0 | 5.20 | 5.10 | 5.00 |
| Dustiness | <20 mg | 10.0 | 10.0 | 10.0 |
| Dry sieve (300 micron) percent by mass min. | >90% | 99.50 | 96.35 | 96.25 |
| Attrition Resistance (<100 micron) | <5% | 2.10 | 2.10 | 2.10 |
| Bulk density (g/ml) | 1.25 to 1.50 | 1.30 | 1.30 | 1.30 |
| Moisture content percent by mass max. | max. 2% | 1.50 | 1.50 | 1.40 |

Procedure: Manufacturing Process as Per Example 3

### Example 6

OD (Oil Dispersion) Formulation of Cyantraniliprole 5%+Brassinolide 0.025%+Methoxyfenozide 10%

| Chemical composition | % (w/w) |
|---|---|
| Cyantraniliprole a.i. | 5.00 |
| Brassinolide a.i. | 0.025 |
| Methoxyfenozide a.i. | 10.00 |
| Wetting-spreading-penetrating agent | 5.00 |
| Dispersing agent | 4.50 |
| Emulsifying agent | 8.00 |
| Stabilizer | 1.50 |
| Antifoaming agent | 0.30 |
| Preservative | 0.20 |
| Antifreezing agent | 5.00 |
| Carrier as solvent | 60.48 |
| Total | 100.00 |

Storage stability—Cyantraniliprole 5%+Brassinolide 0.025%+Methoxyfenozide 10% OD (Oil Dispersion) Formulation

Laboratory storage for 14 days

| | Specification | | At 54 ± | At 0 ± |
|---|---|---|---|---|
| Parameters | (in house) | Initial | 2° C. | 2° C. |
| Cyantraniliprole content percent by mass | 4.75 to 5.50 | 5.20 | 5.15 | 5.20 |
| Brassinolide content percent by mass | 0.02375 to 0.02625 | 0.026 | 0.026 | 0.026 |
| Methoxyfenozide content percent by mass | 9.50 to 11 | 10.50 | 10.30 | 10.40 |
| Cyantraniliprole suspensibility percent min. | 80 | 97.60 | 95.20 | 97.40 |
| Brassinolide suspensibility percent min. | 80 | 98.20 | 96.80 | 97.80 |
| Methoxyfenozide suspesnibility precent min. | 80 | 98.60 | 98.40 | 98.20 |
| pH range (1% aq. Suspension) | 5.5 to 8.5 | 6.80 | 6.80 | 6.80 |
| Pourability | 95% min. | 97.60 | 97.20 | 97.50 |
| Specific gravity | 1.02-1.08 | 1.04 | 1.04 | 1.04 |
| Viscosity at spindle no. 62, 20 rpm | 350-800 cps | 650 | 630 | 670 |
| Particle size (micron) | D50 < 3, | 2.2, 8.6 | 2.4, 8.8 | 2.5, 8.9 |
| | D90 < 10 | | | |
| Persistent foam ml (after 1 minute) max. | 60 | nil | 2 | nil |

Room temperature storage

| | Specification | 1 | 6 | 12 |
|---|---|---|---|---|
| Parameters | (in house) | month | months | months |
| Cyantraniliprole content percent by mass | 4.75 to 5.50 | 5.20 | 5.15 | 5.10 |
| Brassinolide content percent by mass | 0.02375 to 0.02625 | 0.026 | 0.026 | 0.026 |
| Methoxyfenozide content percent by mass | 9.50 to 11 | 10.50 | 10.40 | 10.30 |
| Cyantraniliprole suspensibility percent min. | 80 | 97.60 | 97.40 | 96.80 |
| Brassinolide suspensibility percent min. | 80 | 98.20 | 97.89 | 97.20 |
| Methoxyfenozide suspesnibility precent min. | 80 | 98.60 | 98.50 | 98.40 |
| pH range (1% aq. Suspension) | 5.5 to 8.5 | 6.90 | 6.80 | 6.80 |
| Pourability | 95% min. | 97.20 | 97.00 | 96.80 |
| Specific gravity | 1.02-1.08 | 1.05 | 1.05 | 1.05 |
| Viscosity at spindle no. 62, 20 rpm | 350-800 cps | 660 | 660 | 680 |
| Particle size (micron) | D50 < 3, | 2.2, 8.6 | 2.4, 8.8 | 2.5, 8.9 |
| | D90 < 10 | | | |
| Persistent foam ml (after 1 minute) max. | 60 | nil | 2 | nil |

Procedure: Manufacturing Process of Oil Dispersion (OD) Formulation:

Preparation of Oil dispersion (OD) formulation:

| | |
|---|---|
| Part A | Preparation of the liquid premix |
| Step 1 | Charge Vegetable oil or solvent or both into a vessel with anchor stirrer. |
| Step 2 | Under stirring, add the emulsifier and dispersing agent and stir until all ingredients are |
| | dissolved completely. |
| Part B | Preparation of the slurry |
| Step 1 | Now, charge the liquid premix into a second vessel, equipped with a cooling and heating |
| | device and a high shear stirrer. |
| Step 2 | Add the active ingredient and homogenize thoroughly. Pre-mill this mixture and finally |
| | mill it using a bead mill to achieve a particle size distribution as required by the |
| | specification. |
| Part C | Preparation of the Thickener gel |
| Step 1 | Charge the vegetable/plant/seed oil or solvent to the vessel, equipped with a high shear |
| | stirrer. |
| Step 2 | Add gradually the thickener which is organophilic clay, maintaining high-shear mixing |
| | throughout. Stirring is continued until thoroughly mixed. |
| Step 3 | Under stirring, the thickener activating agent propylene carbonate is added. Allow the |
| | gel to swell whilst maintaining mixing. |
| Part D | Preparation of the final formulation |
| Step 1 | Now add the thickener gel or silica and disperse the mixture by using a high shear stirrer. |
| Step 2 | Finally add the recommended wetting and spreading agent or adjuvants (silicone or |
| | non-silicone based) to this formulation and disperse by using high shear stirrer. |
| Step 3 | Check the finished formulation to specification. |
| Step 4 | After approval, material is packed in required pack sizes. |

### Example 7

OD (Oil Dispersion) Formulation of Cyantraniliprole 5%+Salicylic Acid 2%+Flupyrimin 10%

| Chemical composition | % (w/w) |
|---|---|
| Cyantraniliprole a.i. | 5.00 |
| Salicylic acid a.i. | 2.00 |
| Flupyrimin a.i. | 10.00 |
| Wetting-spreading-penetrating agent | 4.50 |
| Dispersing agent | 4.50 |
| Emulsifying agent | 8.00 |
| Stabilizer | 1.50 |
| Antifoaming agent | 0.30 |
| Preservative | 0.20 |
| Antifreezing agent | 5.00 |
| Carrier as solvent | 59.00 |
| Total | 100.00 |

Storage Stability-

Storage stability study in laboratory and at room temperature shows that Cyantraniliprole 5%+Salicylic acid 2%+Flupyrimin 10% OD formulation complies all the in-house parameters like active ingredients content, suspensibility, pH range, pourability, specific gravity, viscosity, particle size and foaming.

Procedure: Manufacturing Process as Per Example 6

### Example 8

SC (Suspension Concentrate) Formulation of Cyantraniliprole 5%+Ortho Silicic Acid 2%+Flupyrimin 10%

| Chemical composition | % (w/w) |
|---|---|
| Cyantraniliprole a.i. | 5.00 |
| Ortho Silicic Acid a.i. | 2.00 |
| Flupyrimin a.i. | 10.00 |
| Wetting-spreading-penetrating agent | 3.00 |
| Dispersing agent 1 | 4.50 |
| Dispersing agent 2 | 3.00 |
| Suspending agent | 2.00 |
| Antifoaming agent | 0.30 |
| Preservative | 0.20 |
| Antifreezing agent | 5.00 |
| Thickner | 0.15 |
| Diluent Water | 64.85 |
| Total | 100.00 |

Storage Stability-

Cyantraniliprole 5%+Ortho Silicic Acid 2%+Flupyrimin 10% SC (Suspension Concentrate)

Laboratory storage stability

| | Specification | | At 54 ± | At 0 ± |
|---|---|---|---|---|
| Parameters | (in house) | Initial | 2° C. | 2° C. |
| Cyantraniliprole content percent by mass | 4.75 to 5.50 | 5.20 | 5.10 | 5.18 |
| Ortho Silicic Acid content percent by mass | 1.90 to 2.20 | 2.10 | 2.05 | 2.08 |
| Flupyrimin content percent by mass | 9.50 to 10.5 | 10.20 | 10.10 | 10.15 |
| Cyantraniliprole suspensibility percent min. | 80 | 96.14 | 95.15 | 96.03 |
| Ortho Silicic Acid suspensibility percent min. | 80 | 97.16 | 97.10 | 96.80 |
| Flupyrimin suspesnibility precent min. | 80 | 97.15 | 97.12 | 97.50 |
| pH range (1% aq. Suspension) | 4.0 to 6.5 | 5.50 | 5.60 | 5.50 |
| Pourability | 95% min. | 97.40 | 97.20 | 97.50 |
| Specific gravity | 1.02-1.08 | 1.03 | 1.03 | 1.03 |
| Viscosity at spindle no. 62, 20 rpm | 350-800 cps | 650 | 660 | 675 |
| Particle size (micron) | D50 < 3, | 2.2, 8.6 | 2.4, 8.8 | 2.5, 8.9 |
| | D90 < 10 | | | |
| Persistent foam ml (after 1 minute) max. | 60 | nil | 3 | nil |

Room temperature storage stability up to 12 months

| | Specification | 1 | 6 | 12 |
|---|---|---|---|---|
| Parameters | (in house) | month | month | month |
| Cyantraniliprole content percent by mass | 4.75 to 5.50 | 5.20 | 5.15 | 5.10 |
| Ortho Silicic Acid content percent by mass | 1.90 to 2.20 | 2.10 | 2.08 | 2.05 |
| Flupyrimin content percent by mass | 9.50 to 10.5 | 10.20 | 10.15 | 10.10 |
| Cyantraniliprole suspensibility percent min. | 80 | 96.14 | 95.15 | 96.03 |
| Ortho Silicic Acid suspensibility percent min. | 80 | 97.16 | 97.10 | 96.80 |
| Flupyrimin suspesnibility precent min. | 80 | 97.15 | 97.12 | 97.50 |
| pH range (1% aq. Suspension) | 4.0 to 6.5 | 5.50 | 5.60 | 5.65 |
| Pourability | 95% min. | 97.40 | 97.20 | 97.50 |
| Specific gravity | 1.02-1.08 | 1.03 | 1.03 | 1.03 |
| Viscosity at spindle no. 62, 20 rpm | 350-800 cps | 650 | 660 | 670 |
| Particle size (micron) | D50 < 3, | 2.2, 8.6 | 2.4, 8.8 | 2.5, 8.9 |
| | D90 < 10 | | | |
| Persistent foam ml (after 1 minute) max. | 60 | nil | 2 | nil |

Procedure: Manufacturing Process of Suspension Concentrate (SC)

Preparation of Suspension Concentrate (SC) formulation:

| | |
|---|---|
| Step 1 | 2% Gel Preparation: Charge the required quantity of water to a vessel, equipped |
| | with a high shear stirrer and start the agitation. Add the required amount of |
| | preservative. Mix until homogenous. Add the required amount of thickener and mix |
| | vigorously until it is fully wetted. |
| Step 2 | Charge the required quantity of water to a vessel, equipped with bulk agitator and |
| | a high shear homogenizer and start agitation. Add the required amount of ant |
| | freezing agent and mix until uniform. Add the antifoaming agent and ensure that it |
| | is well dispersed. Add the wetting and dispersing agent and mix until uniform. |
| | Ensure that the dispersing agent is fully dispersed. |
| Step 3 | Now add the active ingredient and continue agitating the vessel contents until all |
| | components get dissolved. Mill this pre-mix through a Colloid mill and |
| | subsequently through a Dyno mill to meet the specified particle size. |
| Step 4 | Now add remaining antifoaming agent to this SC mill base to a vessel, equipped |
| | with bulk agitator. Mix until uniform. Add the required amount of 2% aqueous pre- |
| | gel and suspending agent and continue agitation until the formulation is |
| | homogeneous and has the target viscosity is reached. |
| Step 5 | Final product is sent for QC approval. |
| Step 6 | After approval, material is packed in required pack sizes. |

### Example 9

SC (Suspension Concentrate) Formulation of Chlorantraniliprole 5%+Brassinolide 0.05%+Methoxyfenozide 20.0%

| Chemical composition | % (w/w) |
|---|---|
| Chlorantraniliprole a.i. | 5.00 |
| Brassinolide a.i. | 0.05 |
| Methoxyfenozide a.i. | 20.00 |
| Wetting-spreading-penetrating agent | 4.00 |
| Dispersing agent 1 | 4.50 |
| Dispersing agent 2 | 1.00 |
| Suspending agent | 1.00 |
| Antifoaming agent | 0.30 |
| Preservative | 0.20 |
| Antifreezing agent | 5.00 |
| Thickner | 0.15 |
| Diluent Water | 58.80 |
| Total | 100.00 |

Storage Stability-

Storage stability study in laboratory and at room temperature shows that Chlorantraniliprole 5%+Brassinolide 0.05%+Methoxyfenozide 20% SC formulation complies all the in-house parameters like active ingredients content, suspensibility, pH range, pourability, specific gravity, viscosity, particle size and anti-foaming.

Procedure: Manufacturing Process as Per Example 8

### Example 10

SE (Suspo Emulsion) Formulation of Broflanilide 1.2%+Salicylic Acid 2%+Pyriproxyfen 5%

| Chemical composition | % (w/w) |
|---|---|
| Broflanilide a.i. | 1.20 |
| Salicylic acid a.i. | 2.00 |
| Pyriproxyfen a.i. | 5.00 |
| Solvent | 10.00 |
| Wetting-spreading-penetrating agent | 4.00 |
| Dispersing agent 1 | 4.50 |
| Dispersing agent 2 | 3.00 |
| Suspending agent | 2.00 |
| Antifoaming agent | 0.30 |
| Preservative | 0.20 |
| Antifreezing agent | 5.00 |
| Thickner | 0.15 |
| Diluent Water | 62.65 |
| Total | 100.00 |

Storage Stability-

Cyantraniliprole 5%+Ortho Silicic acid 2%+Flupyrimin 10% SE (Suspo Emulsion) formulation.

Laboratory storage stability

| | Specification | | At 54 ± | At 0 ± |
|---|---|---|---|---|
| Parameters | (in house) | Initial | 2° C. | 2° C. |
| Broflanilide content percent by mass | 1.14 to 1.32 | 1.26 | 1.20 | 1.25 |
| Salicylic acid content percent by mass | 1.9 to 2.2 | 2.00 | 2.00 | 2.00 |
| Pyriproxyfen content percent by mass | 4.75 to 5.5 | 5.15 | 5.10 | 5.14 |
| Broflanilide suspensibility percent min. | 80 | 96.14 | 95.15 | 96.03 |
| Salicylic acid suspensibility percent min. | 80 | 97.16 | 97.10 | 96.80 |
| Pyriproxyfen suspesnibility precent min. | 80 | 97.15 | 97.12 | 96.80 |
| pH range (1% aq. Suspension) | 4.5 to 6.5 | 5.20 | 5.10 | 5.30 |
| Pourability | 95% min. | 97.40 | 97.20 | 97.50 |
| Specific gravity | 1.02-1.08 | 1.03 | 1.03 | 1.03 |
| Viscosity at spindle no. 62, 20 rpm | 350-800 cps | 650 | 660 | 675 |
| Particle size (micron) | D50 < 3, | 2.2, 8.6 | 2.4, 8.8 | 2.5, 8.9 |
| | D90 < 10 | | | |
| Persistent foam ml (after 1 minute) max. | 60 | nil | 3 | nil |

Room temperature storage stability up to 12 months

| | Specification | 1 | 6 | 12 |
|---|---|---|---|---|
| Parameters | (in house) | month | months | months |
| Broflanilide content percent by mass | 1.14 to 1.32 | 1.26 | 1.24 | 1.22 |
| Salicylic acid content percent by mass | 1.9 to 2.2 | 2.00 | 2.00 | 2.00 |
| Pyriproxyfen content percent by mass | 4.75 to 5.5 | 5.15 | 5.10 | 5.06 |
| Broflanilide suspensibility percent min. | 80 | 96.14 | 95.15 | 96.03 |
| Salicylic acid suspensibility percent min. | 80 | 97.16 | 97.10 | 96.80 |
| Pyriproxyfen suspesnibility precent min. | 80 | 97.15 | 97.12 | 96.80 |
| pH range (1% aq. Suspension) | 4.5 to 6.5 | 5.20 | 5.10 | 5.40 |
| Pourability | 95% min. | 97.40 | 97.20 | 97.50 |
| Specific gravity | 1.02-1.08 | 1.03 | 1.03 | 1.03 |
| Viscosity at spindle no. 62, 20 rpm | 350-800 cps | 650 | 660 | 675 |
| Particle size (micron) | D50 < 3, | 2.2, 8.6 | 2.4, 8.8 | 2.5, 8.9 |
| | D90 < 10 | | | |
| Persistent foam ml (after 1 minute) max. | 60 | nil | 3 | nil |

Procedure: Manufacturing Process of Suspo Emulsion (SE) Formulation:

Preparation of Suspo Emulsion (SE) formulation:

| | |
|---|---|
| Step 1- | 2% Gel Preparation: Charge the required quantity of water to a vessel, equipped |
| | with a high shear stirrer and start the agitation. Add the required amount of |
| | preservative. Mix until homogenous. Add the required amount of thickener and |
| | mix vigorously until it is fully wetted. |
| Step 2- | Oil Phase: Charge solvent into the vessel and then add active technical slowly and |
| | if required, heat it for 50° C. so that technical can be dissolved in solvent and then |
| | add emulsifier. |
| Step 3- | Charge the required quantity of water to a vessel, equipped with bulk agitator and |
| | a high shear homogenizer and start agitation. Add the required amount of ant |
| | freezing agent and mix until uniform. Add the antifoaming agent and ensure that it |
| | is well dispersed. Add the wetting and dispersing agent and mix until uniform. |
| | Ensure that the dispersing agent is fully dispersed. |
| Step 4- | Now add the active ingredient and continue agitating the vessel contents until all |
| | components get dissolved. Mill this pre-mix through a Colloid mill and |
| | subsequently through a Dyno mill to meet the specified particle size. |
| Step 5- | Now add remaining antifoaming agent to this mill base to a vessel, equipped with |
| | bulk agitator. Mix until uniform. |
| Step 6- | Now add oil phase in aqueous phase and stir for 30 minutes using homogenizer. |
| Step 7- | Add the required amount of 2% aqueous pre-gel and also suspending agent and |
| | continue agitation until the formulation is homogeneous and has the target |
| | viscosity. Mix well. |
| Step 8- | Final product is sent for QC approval. |
| Step 9- | After approval, material is packed in required pack sizes. |

### Example 11

WG (Water Dispersible Granule/Wettable Granule) Formulation of Cyantraniliprole 10%+Salicylic Acid 4%+Pymetrozine 25%

| Chemical composition | % (w/w) |
|---|---|
| Cyantraniliprole a.i. | 10.00 |
| Salicylic acid a.i. | 4.00 |
| Pymetrozine a.i. | 25.00 |
| Wetting-spreading-penetrating agent | 2.00 |
| Dispersing agent I | 6.00 |
| Dispersing agent II | 2.00 |
| Disintegrating agent | 0.50 |
| Antifoaming agent | 1.00 |
| Carrier | 49.50 |
| Total | 100.00 |

Storage Stability-

Cyantraniliprole 10%+Salicylic acid 4%+Pymetrozine 25% WG (Water dispersible granule/Wettable Granule) formulation

Laboratory storage for 14 days

| | Specification | | At 54 ± | At 0 ± |
|---|---|---|---|---|
| Parameters | (in house) | Initial | 2° C. | 2° C. |
| Cyantraniliprole content percent by mass | 9.50 to 10.50 | 10.30 | 10.10 | 10.20 |
| Salicylic acid content percent by mass | 3.80 to 4.40 | 4.20 | 4.20 | 4.20 |
| Pymetrozine content percent by mass | 24.25 to 26.25 | 26.00 | 25.60 | 25.90 |
| Cyantraniliprole suspensibility percent min. | 70 | 98.80 | 97.60 | 98.50 |
| Salicylic acid suspensibility percent min. | 70 | 96.50 | 95.60 | 96.20 |
| Pymetrozine suspensibility percent min. | 70 | 95.50 | 94.20 | 94.60 |
| pH range (1% aq. Suspension) | 6.0 to 9.0 | 7.20 | 7.10 | 7.20 |
| Wettability sec. max. | 60 | 7 | 8 | 8 |
| Wet sieve (45 micron) percent by mass min. | 98.5 | 99.6 | 99.2 | 99.5 |
| Bulk density (g/ml) | 0.45 to 0.65 | 0.5 | 0.5 | 0.5 |
| Moisture content percent by mass max. | max. 2% | 2 | 2 | 2 |

Room temperature storage stability up to 12 months

| | specification | 1 | 6 | 12 |
|---|---|---|---|---|
| Parameters | (in house) | month | months | months |
| Cyantraniliprole content percent by mass | 9.50 to 10.50 | 10.30 | 10.20 | 10.10 |
| Salicylic acid content percent by mass | 3.80 to 4.40 | 4.20 | 4.20 | 4.10 |
| Pymetrozine content percent by mass | 24.25 to 26.25 | 26.00 | 25.80 | 25.60 |
| Cyantraniliprole suspensibility percent min. | 70 | 98.50 | 98.30 | 98.00 |
| Salicylic acid suspensibility percent min. | 70 | 96.50 | 96.20 | 95.80 |
| Pymetrozine suspensibility percent min. | 70 | 95.50 | 95.20 | 94.60 |
| pH range (1% aq. Suspension) | 6.0 to 9.0 | 7.20 | 7.20 | 7.10 |
| Wettability sec. max. | 60 | 7 | 8 | 8 |
| Wet sieve (45 micron) percent by mass min. | 98.5 | 99.6 | 99.3 | 99.2 |
| Bulk density (g/ml) | 0.45 to 0.65 | 0.5 | 0.5 | 0.5 |
| Moisture content percent by mass max. | max. 2% | 2 | 2 | 2 |

Procedure: Manufacturing Process of WG/WDG (Water Dispersible Granule):

Preparation of WG/WDG (Water Dispersible Granule):

| | |
|---|---|
| Step 1- | Before starting the process, check the cleanliness of all equipment's in plant |
| | and get approval by QC dept. |
| Step 2- | Check the electrical connection and standardize the weighing balance. |
| Step 3- | Take exact weight of active ingredients (technical) in blender and then add |
| | required quantity of binder & surfactants and mix it till its complete |
| | homogenization. |
| Step 4- | Mill this homogenized Mixture till required wet sieve and post blend again for |
| | homogeneity. |
| Step 5- | Pass the above homogenous material through Extruder for granulation. |
| Step 6- | Now transfer the granules through Fluid Bed Dryer to remove excess moisture. |
| Step 7- | Transfer these granules to vibro shifter. |
| Step 8- | Collect the final material from the vibro shifter into drum. |
| Step 9- | Finally send the sample to QC for approval. |
| Step 10- | After approval by QC, transfer the material into different size of drums. |

### Example 12

WG (Water Dispersible Granule/Wettable Granule) Formulation of Broflanilide 2%+Ortho Silicic Acid 4%+Dichloromezotiaz 4%

| Chemical composition | % (w/w) |
|---|---|
| Broflanilide a.i. | 2.00 |
| Ortho silicic acid a.i. | 4.00 |
| Dichloromezotiaz a.i. | 4.00 |
| Wetting-spreading-penetrating agent | 2.00 |
| Dispersing agent I | 6.00 |
| Dispersing agent II | 2.00 |
| Disintegrating agent | 0.50 |
| Antifoaming agent | 1.00 |
| Carrier | 78.50 |
| Total | 100.00 |

Storage Stability-

Storage stability study in laboratory and at room temperature shows that Broflanildie 2%+Ortho silicic acid 4%+Dichloromezotiaz 4% WG formulation complies all the in-house parameters like active ingredients content, wettability, wet sieve percent by mass, buld density, 10 pH range and mositure content.

Procedure: Manufacturing Process as Per Example 11

### Example 13

ZC (Zeon Concntrate) Formulation of Cyantraniliprole 10%+Jasmonic Acid 2%+Emamectin Benzoate 1.5%

| Chemical composition | % (w/w) |
|---|---|
| Cyantraniliprole a.i. | 10.00 |
| Jasmonic acid a.i.* | 2.00 |
| Emamectin benzoate acid | 1.50 |
| Wetting-spreading-penetrating agent | 4.50 |
| Dispersing agent 1 | 4.50 |
| Dispersing agent 2 | 2.00 |
| Solvent | 8.00 |
| Wall forming material 1 | 1.00 |
| Wall forming material 2 | 0.50 |
| Suspending agent | 1.50 |
| Antifoaming agent | 0.30 |
| Buffering agent | 0.50 |
| Preservative | 0.20 |
| Antifreezing agent | 5.00 |
| Thickner | 0.15 |
| Diluent Water | 58.35 |
| Total | 100.00 |

*Jasmonic acid may be used as their salt (methyl jasmonate)

Storage Stability-

Cyantraniliprole 10%+Jasmonic acid 2%+Emamectin benzoate 1.5% ZC (Zeon Concntrate) formulation.

Laboratory storage for 14 days

| | Specification | | At 54 ± | At 0 ± |
|---|---|---|---|---|
| Parameters | (in house) | Initial | 2° C. | 2° C. |
| Cyantraniliprole content percent by mass | 9.475 to 10.50 | 10.30 | 10.20 | 10.25 |
| Jasmonic acid content percent by mass | 1.89 to 2.20 | 2.10 | 2.10 | 2.10 |
| Emamectin benzoate content percent by mass | 1.4175 to 1.65 | 1.60 | 1.55 | 1.60 |
| Cyantraniliprole suspensibility percent min. | 80 | 98.5 | 97.6 | 98.2 |
| Jasmonic acid suspensibility percent min. | 80 | 97.5 | 96.5 | 97.2 |
| Emamectin benzoate suspesnibility precent min. | 80 | 98.2 | 97.0 | 97.8 |
| pH range (1% aq. Suspension) | 5.0 to 7.0 | 6.00 | 6.00 | 6.00 |
| Pourability | 95% min. | 97.4 | 97.2 | 97.5 |
| Specific gravity | 1.05-1.10 | 1.05 | 1.05 | 1.05 |
| Viscosity at spindle no. 62, 20 rpm | 350-800 cps | 510 | 518 | 520 |
| Particle size (micron) | D50 < 3, | 2.2,8.6 | 2.4,8.8 | 2.5,8.9 |
| | D90 < 10 | | | |
| Persistent foam ml (after 1 minute) max. | 60 | nil | 3 | nil |

Room temperature storage

| | Specification | 1 | 6 | 12 |
|---|---|---|---|---|
| Parameters | (in house) | month | month | month |
| Cyantraniliprole content percent by mass | 9.475 to 10.50 | 10.30 | 10.20 | 10.10 |
| Jasmonic acid content percent by mass | 1.89 to 2.20 | 2.10 | 2.10 | 2.10 |
| Emamectin benzoate content percent by mass | 1.4175 to 1.65 | 1.60 | 1.55 | 1.50 |
| Cyantraniliprole suspensibility percent min. | 80 | 98.5 | 98.0 | 97.0 |
| Jasmonic acid suspensibility percent min. | 80 | 97.5 | 96.5 | 95.5 |
| Emamectin benzoate suspesnibility precent min. | 80 | 98.2 | 97.5 | 97.0 |
| pH range (1% aq. Suspension) | 5.0 to 7.0 | 6.0 | 6.0 | 6.0 |
| Pourability | 95% min. | 97.4 | 97.4 | 97.3 |
| Specific gravity | 1.05-1.10 | 1.05 | 1.05 | 1.05 |
| Viscosity at spindle no. 62, 20 rpm | 350-800 cps | 515 | 520 | 523 |
| Particle size (micron) | D50 < 3, | 2.2,8.6 | 2.2,8.6 | 2.2,8.7 |
| | D90 < 10 | | | |
| Persistent foam ml (after 1 minute) max. | 60 | nil | nil | 2 |

### Example 14

ZC (Zeon Concntrate) Formulation of Broflanilide 2%+Fulvic Acid 3%+Emamectin Benzoate 1.5%

| Chemical composition | % (w/w) |
|---|---|
| Broflanilide a.i. | 2.00 |
| Fulvic acid a.i. | 3.00 |
| Emamectin benzoate acid | 1.50 |
| Wetting-spreading-penetrating agent | 4.00 |
| Dispersing agent 1 | 4.50 |
| Dispersing agent 2 | 2.00 |
| Solvent | 8.00 |
| Wall forming material 1 | 1.00 |
| Wall forming material 2 | 0.50 |
| Suspending agent | 1.50 |
| Antifoaming agent | 0.30 |
| Buffering agent | 0.50 |
| Preservative | 0.20 |
| Antifreezing agent | 5.00 |
| Thickner | 0.15 |
| Diluent Water | 65.85 |
| Total | 100.00 |

Storage Stability-

Storage stability study in laboratory and at room temperature shows that Broflanildie 2%+Fulvic 3%+Emamectin benzoate 1.5% ZC formulation complies all the in-house parameters like active ingredients content, suspensibility, pH, pourability, specific gravity, viscosity, particle size and anti-foaming.

Procedure: Manufacturing Process as Per Example 11

### Example 15

Most preferred formulations:

| | Compound B- | | active ingredients(%) | | | Formulation | |
|---|---|---|---|---|---|---|---|
| Compound A-Diamide | Plant Health | Compound C- | Compound | Compound | Compound | strength | |
| compound | additive(s) | Insecticide(s) | A | B | C | (%) | Type |
| Chlorantraniliprole | Brassinolide | Clothianidin | 0.5 | 0.003 | 1 | 1.50 | GR-SL |
| Cyantraniliprole | Brassinolide | Clothianidin | 0.6 | 0.003 | 1 | 1.60 | GR-SL |
| Cyclaniliprole | Brassinolide | Clothianidin | 0.6 | 0.003 | 1 | 1.60 | GR-SL |
| Tetraniliprole | Brassinolide | Clothianidin | 0.5 | 0.003 | 1 | 1.50 | GR-SL |
| Flubendiamide | Brassinolide | Clothianidin | 0.5 | 0.003 | 1 | 1.50 | GR-SL |
| Chlorantraniliprole | Salicylic acid | Thiamethoxam | 0.5 | 0.4 | 1.25 | 2.15 | GR-SL |
| Cyantraniliprole | Salicylic acid | Thiamethoxam | 0.6 | 0.4 | 1.25 | 2.25 | GR-SL |
| Cyclaniliprole | Salicylic acid | Thiamethoxam | 0.6 | 0.4 | 1.25 | 2.25 | GR-SL |
| Tetraniliprole | Salicylic acid | Thiamethoxam | 0.5 | 0.4 | 1.25 | 2.15 | GR-SL |
| Chlorantraniliprole | Zinc | Clothianidin | 0.4 | 3.4 | 1.2 | 5.00 | GR |
| Chlorantraniliprole | Zinc | Thiamethoxam | 0.4 | 3.4 | 1.2 | 5.00 | GR |
| Tetraniliprole | Zinc | Clothianidin | 0.5 | 3.4 | 1.2 | 5.10 | GR |
| Tetraniliprole | Zinc | Thiamethoxam | 0.5 | 3.4 | 1.2 | 5.10 | GR |
| Chlorantraniliprole | Zinc | Flupyrimin | 0.3 | 1 | 1 | 2.30 | GR |
| Cyantraniliprole | Zinc | Flupyrimin | 0.5 | 1 | 1 | 2.50 | GR |
| Cyclaniliprole | Zinc | Flupyrimin | 0.5 | 1 | 1 | 2.50 | GR |
| Tetraniliprole | Zinc | Flupyrimin | 0.5 | 1 | 1 | 2.50 | GR |
| Chlorantraniliprole | Zinc | Triflume zopyrim | 0.3 | 1 | 0.5 | 1.80 | GR |
| Cyantraniliprole | Zinc | Triflumezopyrim | 0.5 | 1 | 0.5 | 2.00 | GR |
| Cyclaniliprole | Zinc | Triflumezopyrim | 0.5 | 1 | 0.5 | 2.00 | GR |
| Tetraniliprole | Zinc | Triflumezopyrim | 0.5 | 1 | 0.5 | 2.00 | GR |
| Chlorantraniliprole | Brassinolide | Methoxyfenozide | 5 | 0.05 | 1.5 | 20.00 | SC |
| Cyantraniliprole | Brassinolide | Methoxyfenozide | 5 | 0.025 | 1.5 | 10.00 | OD |
| Tetraniliprole | Brassinolide | Methoxyfenozide | 5 | 0.025 | 1.5 | 10.00 | OD |
| Broflanilide | Brassinolide | Methoxyfenozide | 1.8 | 0.05 | 1.5 | 20.00 | OD |
| Flubendiamide | Brassinolide | Methoxyfenozide | 6.67 | 0.033 | 13.33 | 20.03 | OD |
| Chlorantraniliprole | Brassinolide | Emamectin benzoate | 5 | 0.05 | 1.5 | 20.00 | OD |
| Cyantraniliprole | Brassinolide | Emamectin benzoate | 10 | 0.05 | 1.5 | 10.00 | OD |
| Tetraniliprole | Brassinolide | Emamectin benzoate | 10 | 0.05 | 1.5 | 10.00 | OD |
| Broflanilide | Brassinolide | Emamectin benzoate | 1.8 | 0.05 | 1.5 | 20.00 | OD |
| Flubendiamide | Brassinolide | Emamectin benzoate | 10 | 0.05 | 1.5 | 11.55 | OD |
| Chlorantraniliprole | Salicylic acid | Emamectin benzoate | 6 | 3 | 1.5 | 10.50 | ZC |
| Cyantraniliprole | Jasmonic acid | Emamectin benzoate | 10 | 2 | 1.5 | 13.50 | ZC |
| Tetraniliprole | Amino acid | Emamectin benzoate | 10 | 3 | 1.5 | 14.50 | ZC |
| Broflanilide | Fulvic acid | Emamectin benzoate | 2 | 3 | 1.5 | 6.50 | ZC |
| Flubendiamide | Fulvic acid | Emamectin benzoate | 20 | 3 | 1.5 | 24.50 | ZC |
| Chlorantraniliprole | Ortho silicic acid | Dichloromezotiaz | 5 | 4 | 4 | 13.00 | WG |
| Cyantraniliprole | Ortho silicic acid | Dichloromezotiaz | 10 | 4 | 4 | 18.00 | WG |
| Tetraniliprole | Ortho silicic acid | Dichloromezotiaz | 10 | 4 | 4 | 18.00 | WG |
| Broflanilide | Ortho silicic acid | Dichloromezotiaz | 2 | 4 | 4 | 10.00 | WG |
| Chlorantraniliprole | Ortho silicic acid | Flupyrimin | 2.5 | 2 | 10 | 14.50 | SC |
| Cyantraniliprole | Ortho silicic acid | Flupyrimin | 5 | 2 | 10 | 17.00 | SC |
| Tetraniliprole | Ortho silicic acid | Flupyrimin | 5 | 2 | 10 | 17.00 | SC |
| Broflanilide | Ortho silicic acid | Flupyrimin | 1 | 2 | 10 | 13.00 | SC |
| Cyantraniliprole | Brassinolide | Diafenthiuron | 5 | 0.02 | 20 | 25.02 | OD |
| Cyantraniliprole | Brassinolide | Pyriproxyfen | 5 | 0.02 | 5 | 10.02 | SE |
| Cyantraniliprole | Brassinolide | Flonicamid | 10 | 0.04 | 10 | 20.04 | WG |
| Cyantraniliprole | Brassinolide | Tolfenpyrad | 5 | 0.02 | 10 | 15.02 | OD |
| Cyantraniliprole | Brassinolide | Pymetrozine | 10 | 0.04 | 20 | 30.04 | WG |
| Cyantraniliprole | Brassinolide | Spiromesifen | 5 | 0.02 | 12 | 17.02 | OD |
| Cyantraniliprole | Brassinolide | Spiropidion | 10 | 0.04 | 10 | 20.04 | WG |
| Cyantraniliprole | Brassinolide | Afidopyropen | 5 | 0.02 | 4 | 9.02 | SC |
| Cyantraniliprole | Brassinolide | Pyrifluquinazon | 10 | 0.04 | 8 | 18.04 | OD |
| Cyantraniliprole | Brassinolide | Dimpropyridaz | 10 | 0.04 | 5 | 15.04 | SC |
| Cyantraniliprole | Fulvic acid | Diafenthiuron | 5 | 1 | 25 | 31.00 | SC |
| Cyantraniliprole | Fulvic acid | Pyriproxyfen | 5 | 1 | 5 | 11.00 | SE |
| Cyantraniliprole | Fulvic acid | Flonicamid | 10 | 2 | 10 | 22.00 | WG |
| Cyantraniliprole | Fulvic acid | Tolfenpyrad | 5 | 1 | 10 | 16.00 | SC |
| Cyantraniliprole | Fulvic acid | Pymetrozine | 10 | 2 | 20 | 32.00 | WG |
| Cyantraniliprole | Fulvic acid | Spiromesifen | 5 | 1 | 12 | 18.00 | OD |
| Cyantraniliprole | Fulvic acid | Spiropidion | 10 | 2 | 10 | 22.00 | WG |
| Cyantraniliprole | Fulvic acid | Afidopyropen | 5 | 1 | 4 | 10.00 | SC |
| Cyantraniliprole | Fulvic acid | Pyrifluquinazon | 10 | 2 | 8 | 20.00 | SC |
| Cyantraniliprole | Fulvic acid | Dimpropyridaz | 10 | 2 | 5 | 17.00 | SC |
| Cyantraniliprole | Salicylic acid | Diafenthiuron | 5 | 2 | 25 | 32.00 | SC |
| Cyantraniliprole | Salicylic acid | Diafenthiuron | 5 | 2 | 20 | 27.00 | OD |
| Cyantraniliprole | Salicylic acid | Pyriproxyfen | 5 | 2 | 5 | 12.00 | SE |
| Cyantraniliprole | Salicylic acid | Flonicamid | 10 | 4 | 10 | 24.00 | WG |
| Cyantraniliprole | Salicylic acid | Tolfenpyrad | 5 | 2 | 10 | 17.00 | SC |
| Cyantraniliprole | Salicylic acid | Tolfenpyrad | 5 | 2 | 10 | 17.00 | OD |
| Cyantraniliprole | Salicylic acid | Pymetrozine | 10 | 4 | 20 | 34.00 | WG |
| Cyantraniliprole | Salicylic acid | Spiromesifen | 5 | 2 | 12 | 19.00 | OD |
| Cyantraniliprole | Salicylic acid | Spiropidion | 10 | 4 | 10 | 24.00 | WG |
| Cyantraniliprole | Salicylic acid | Afidopyropen | 5 | 2 | 4 | 11.00 | SC |
| Cyantraniliprole | Salicylic acid | Pyrifluquinazon | 10 | 4 | 8 | 22.00 | SC |
| Cyantraniliprole | Salicylic acid | Pyrifluquinazon | 10 | 4 | 8 | 22.00 | OD |
| Cyantraniliprole | Salicylic acid | Dimpropyridaz | 10 | 4 | 5 | 19.00 | SC |
| Broflanilide | Brassinolide | Diafenthiuron | 2 | 0.04 | 40 | 42.04 | SC |
| Broflanilide | Brassinolide | Pyriproxyfen | 1 | 0.02 | 5 | 6.02 | SE |
| Broflanilide | Brassinolide | Flonicamid | 5 | 0.1 | 25 | 30.10 | WG |
| Broflanilide | Brassinolide | Tolfenpyrad | 2 | 0.04 | 15 | 17.04 | SC |
| Broflanilide | Brassinolide | Pymetrozine | 4 | 0.08 | 40 | 44.08 | WG |
| Broflanilide | Brassinolide | Spiromesifen | 2 | 0.04 | 20 | 22.04 | OD |
| Broflanilide | Brassinolide | Spiropidion | 4 | 0.08 | 20 | 24.08 | WG |
| Broflanilide | Brassinolide | Afidopyropen | 2 | 0.04 | 5 | 7.04 | SC |
| Broflanilide | Brassinolide | Pyrifluquinazon | 4 | 0.08 | 16 | 20.08 | SC |
| Broflanilide | Brassinolide | Dimpropyridaz | 4 | 0.08 | 10 | 14.08 | SC |
| Broflanilide | Salicylic acid | Diafenthiuron | 1.2 | 2 | 25 | 28.20 | SC |
| Broflanilide | Salicylic acid | Pyriproxyfen | 1.2 | 2 | 5 | 8.20 | SE |
| Broflanilide | Salicylic acid | Flonicamid | 6 | 10 | 25 | 41.00 | WG |
| Broflanilide | Salicylic acid | Tolfenpyrad | 2.4 | 4 | 15 | 21.40 | OD |
| Broflanilide | Salicylic acid | Pymetrozine | 4.8 | 8 | 40 | 52.80 | WG |
| Broflanilide | Salicylic acid | Spiromesifen | 1.2 | 2 | 10 | 13.20 | OD |
| Broflanilide | Salicylic acid | Spiropidion | 2.4 | 4 | 10 | 16.40 | WG |
| Broflanilide | Salicylic acid | Afidopyropen | 2.4 | 4 | 5 | 11.40 | SC |
| Broflanilide | Salicylic acid | Pyrifluquinazon | 2.4 | 4 | 8 | 14.40 | SC |
| Broflanilide | Salicylic acid | Dimpropyridaz | 2.4 | 4 | 5 | 11.40 | SC |
| Broflanilide | Fulvic acid | Diafenthiuron | 1.2 | 1 | 25 | 27.20 | SC |
| Broflanilide | Fulvic acid | Pyriproxyfen | 1.2 | 1 | 5 | 7.20 | SE |
| Broflanilide | Fulvic acid | Flonicamid | 6 | 5 | 25 | 36.00 | WG |
| Broflanilide | Fulvic acid | Tolfenpyrad | 2.4 | 2 | 15 | 19.40 | SC |
| Broflanilide | Fulvic acid | Pymetrozine | 4.8 | 4 | 40 | 48.80 | WG |
| Broflanilide | Fulvic acid | Spiromesifen | 2.4 | 2 | 20 | 24.40 | OD |
| Broflanilide | Fulvic acid | Spiropidion | 4.8 | 4 | 20 | 28.80 | WG |
| Broflanilide | Fulvic acid | Afidopyropen | 2.4 | 2 | 5 | 9.40 | SC |
| Broflanilide | Fulvic acid | Pyrifluquinazon | 4.8 | 4 | 16 | 24.80 | SC |
| Broflanilide | Fulvic acid | Dimpropyridaz | 4.8 | 4 | 10 | 18.80 | SC |
| Chlorantraniliprole | Sulphur | Clothianidin | 0.5 | 20 | 1 | 21.50 | GR-SL |
| Cyantraniliprole | Sulphur | Clothianidin | 0.5 | 20 | 1 | 21.50 | GR |
| Cyclaniliprole | Sulphur | Clothianidin | 0.5 | 20 | 1 | 21.50 | GR |
| Tetraniliprole | Sulphur | Clothianidin | 0.5 | 20 | 1 | 21.50 | GR |
| Cyhalodiamide | Sulphur | Clothianidin | 0.5 | 20 | 1 | 21.50 | GR |
| Chlorantraniliprole | Sulphur | Thiamethoxam | 0.4 | 20 | 1.25 | 21.65 | GR |
| Cyantraniliprole | Sulphur | Thiamethoxam | 0.4 | 20 | 1.25 | 21.65 | GR |
| Cyclaniliprole | Sulphur | Thiamethoxam | 0.4 | 20 | 1.25 | 21.65 | GR |
| Tetraniliprole | Sulphur | Thiamethoxam | 0.4 | 20 | 1.25 | 21.65 | GR |
| Cyhalodiamide | Sulphur | Thiamethoxam | 0.4 | 20 | 1.25 | 21.65 | GR |
| Chlorantraniliprole | Sulphur | Flupyrimin | 0.4 | 20 | 1 | 21.40 | GR |
| Cyantraniliprole | Sulphur | Flupyrimin | 0.4 | 20 | 1 | 21.40 | GR |
| Cyclaniliprole | Sulphur | Flupyrimin | 0.4 | 20 | 1 | 21.40 | GR |
| Tetraniliprole | Sulphur | Flupyrimin | 0.4 | 20 | 1 | 21.40 | GR |
| Cyhalodiamide | Sulphur | Flupyrimin | 0.4 | 20 | 1 | 21.40 | GR |
| Chlorantraniliprole | Sulphur | Triflumezopyrim | 0.4 | 20 | 0.5 | 20.90 | GR |
| Cyantraniliprole | Sulphur | Triflumezopyrim | 0.4 | 20 | 0.5 | 20.90 | GR |
| Cyclaniliprole | Sulphur | Triflumezopyrim | 0.4 | 20 | 0.5 | 20.90 | GR |
| Tetraniliprole | Sulphur | Triflumezopyrim | 0.4 | 20 | 0.5 | 20.90 | GR |
| Cyhalodiamide | Sulphur | Triflumezopyrim | 0.4 | 20 | 0.5 | 20.90 | GR |
| Chlorantraniliprole | Humic acid | Flupyrimin | 0.2 | 2.5 | 1 | 3.70 | GR |
| Cyantraniliprole | Humic acid | Flupyrimin | 0.5 | 2.5 | 1 | 4.00 | GR |
| Cyclaniliprole | Humic acid | Flupyrimin | 0.5 | 2.5 | 1 | 4.00 | GR |
| Tetraniliprole | Humic acid | Flupyrimin | 0.5 | 2.5 | 1 | 4.00 | GR |
| Cyhalodiamide | Humic acid | Flupyrimin | 0.3 | 2.5 | 1 | 3.80 | GR |
| Cyantraniliprole | Salicylic acid | Triflumezopyrim | 10 | 4 | 4 | 18.00 | OD |
| Cyantraniliprole | Salicylic acid | Flupyrimin | 5 | 2 | 10 | 17.00 | OD |
| Cyantraniliprole | Salicylic acid | Pymetrozine | 10 | 4 | 25 | 39.00 | WG |
| Cyantraniliprole | Salicylic acid | Benzpyrimoxan | 5 | 2 | 6 | 13.00 | OD |
| Chlorantraniliprole | Brassinolide | Fipronil | 0.75 | 2 | 0.6 | 3.35 | GR |
| Cyantraniliprole | Brassinolide | Fipronil | 0.75 | 2 | 0.6 | 3.35 | GR |
| Cyclaniliprole | Brassinolide | Fipronil | 0.75 | 2 | 0.6 | 3.35 | GR |
| Tetraniliprole | Brassinolide | Fipronil | 0.75 | 2 | 0.6 | 3.35 | GR |
| Chlorantraniliprole | Zinc | Fipronil | 0.75 | 2 | 0.6 | 3.35 | GR |
| Cyantraniliprole | Zinc | Fipronil | 0.75 | 2 | 0.6 | 3.35 | GR |
| Cyclaniliprole | Zinc | Fipronil | 0.75 | 2 | 0.6 | 3.35 | GR |
| Tetraniliprole | Zinc | Fipronil | 0.75 | 2 | 0.6 | 3.35 | GR |
| Chlorantraniliprole | Sulphur | Fipronil | 0.75 | 20 | 0.6 | 21.35 | GR |
| Cyantraniliprole | Sulphur | Fipronil | 0.75 | 20 | 0.6 | 21.35 | GR |
| Cyclaniliprole | Sulphur | Fipronil | 0.75 | 20 | 0.6 | 21.35 | GR |
| Tetraniliprole | Sulphur | Fipronil | 0.75 | 20 | 0.6 | 21.35 | GR |
| Isocycloseram | Ortho silicic acid | Methoxyfenozide | 5 | 4 | 20 | 29.00 | SC |
| Isocycloseram | Ortho silicic acid | Emamectin benzoate | 10 | 8 | 3 | 21.00 | SC |
| Isocycloseram | Ortho silicic acid | Dichloromezotiaz | 5 | 4 | 4 | 13.00 | WG |
| Chlorantraniliprole | Salicylic acid | Lambda cyhalothrin | 6 | 4 | 4.9 | 14.90 | ZC |
| Cyantraniliprole | Salicylic acid | Lambda cyhalothrin | 6 | 4 | 4.9 | 14.90 | ZC |
| Tetraniliprole | Salicylic acid | Lambda cyhalothrin | 6 | 4 | 4.9 | 14.90 | ZC |
| Cyclaniliprole | Salicylic acid | Lambda cyhalothrin | 6 | 4 | 4.9 | 14.90 | ZC |
| Cyhalodiamide | Salicylic acid | Lambda cyhalothrin | 6 | 4 | 4.9 | 14.90 | ZC |
| Flubendiamide | Salicylic acid | Lambda cyhalothrin | 5 | 4 | 4.9 | 13.90 | ZC |
| Broflanilide | Salicylic acid | Lambda cyhalothrin | 3 | 4 | 4.9 | 11.90 | ZC |
| Isocycloseram | Salicylic acid | Lambda cyhalothrin | 5 | 4 | 4.9 | 13.90 | ZC |
| Fluxametamide | Salicylic acid | Lambda cyhalothrin | 6 | 4 | 4.9 | 14.90 | ZC |
| Cyantraniliprole | Chitosan | Clothianidin | 0.5 | 2 | 1 | 3.50 | GR-SL |
| Cyantraniliprole | Chitosan | Thiamethoxam | 0.5 | 2 | 1.25 | 3.75 | GR-SL |
| Cyantraniliprole | Chitosan | Fipronil | 0.5 | 2 | 0.6 | 3.10 | GR-SL |
| Cyantraniliprole | Chitosan | Flupyrimin | 0.5 | 2 | 1 | 3.50 | GR-SL |
| Chlorantraniliprole | Chitosan | Clothianidin | 0.4 | 2 | 1 | 3.40 | GR |
| Chlorantraniliprole | Chitosan | Thiamethoxam | 0.4 | 2 | 1.25 | 3.65 | GR |
| Chlorantraniliprole | Chitosan | Fipronil | 0.4 | 2 | 0.6 | 3.00 | GR |
| Chlorantraniliprole | Chitosan | Flupyrimin | 0.4 | 2 | 1 | 3.40 | GR |

### Biological Examples

Biological Examples:

A synergistic effect exists wherever the action of a combination of active ingredient is greater than the sum of the action of each of the components alone. Therefore, a synergistically effective amount or an effective amount of a synergistic composition or combination is an amount that exhibits greater pesticidal activity than the sum of the pesticidal activities of the individual components.

In the field of agriculture, it is often understood that the term “synergy” is as defined by Colby S. R. in an article entitled “Calculation of the synergistic and antagonistic responses of herbicide combinations” published in the journal Weeds, 1967, 15, p.20-22, incorporated herein by reference in its entirety. The action expected for a given combination of two or three active components can be calculated as follows:

Colby's formula for calculating synergism between three active ingredients

$$E = ( X + Y + Z ) - \frac{( XY + XZ + YZ )}{100} + \frac{( XYZ )}{10000}$$

Where, E=Expected % control by mixture/combination of Compound A, Compound B and Compound C in a defined dose
X=Observed % control by Compound A
Y=Observed % control by Compound B
Z=Observed % control by Compound C

$$Ratio = \frac{Observed Value ( \% control )}{Expected Value ( \% control )}$$

If ratio of O/E>1, means synergism observed

Colby's formula for calculating synergism between two active ingredients

$$E = X + Y - \frac{XY}{100}$$

Where, E=Expected % control by mixture/combination of Compound A and Compound Bin a defined dose
X=Observed % control by Compound A
Y=Observed % control by Compound B

$$Ratio = \frac{Observed Value ( \% control )}{Expected Value ( \% control )}$$

Ratio of O/E>1, means is synergism observed

Field Bio-Efficacy Studies:

The field trials have been carried out on different crops to judge the synergism and benefits of innovative ready-mix combinations in comparison to prior arts.

Experiment 1: Control of Insect-Pests Infesting Sugarcane Crop

Crop & Variety: Sugarcane, Co-0238

Location: Dhanaula, Dist. Amroha, Uttar Pradesh

Treatments: 20

Plot size: 6 m×0.90 cm×4 row

Planting material: 12 buds per meter (3 budded setts, 4 setts per meter)

Time of Application: At the time of planting

Method of Application: In furrow application, over the setts and cover up with soil. The required dose was mixed up with sand to bulk out further and broadcasted over planted setts in open furrow and then cover up with soil.

Agronomic Practices: All agronomic practices followed as per the crop requirement.

Observation Methods:

Early shoot borer (Chilo infuscatellus) incidence (%):

Fifty shoots per plot were selected randomly and presence of characteristic “dead heart” (damaged shoots) were recorded to calculate percent shoot damage by early shoot borer at 90 (DAP) days after planting.

$$\% Early Shoot Borer ( ESB ) Incidence = \frac{Number of dead hearts }{Total number of shoots observed } \times 100$$

Early shoot borer (ESB) control calculated by below formula,

$$\% Early Shoot Borer ( ESB ) control = 100 - \frac{\% ESB incidence in treatment }{\% ESB incidence in untreated plot} \times 100$$

% Early shoot borer control data used to check the synergism by applying Colby's formula given above.

Tiller count: count the number of tillers per 2-meter row length at 60 DAP (days after planting) Shoot count: count the number of shoots per 2-meter row length at 150 DAP (days after planting).

Plant damage by Termite (Odontotermes spp. and Microtermes spp.) (%): Twenty plants at random were observed to record the plant damage due to termites.

Plant damage by White grub (Holotrichia consanguinea) (%): Twenty plants at random from each plot were observed to record the plant damage due to White grub.

$$Percent plant damage due to White grub = \frac{Damaged plants}{Total number of plants observed} \times 100$$

White grub larval count:

The soil from three spot (30 cm×30 cm×30 cm) at random from each plot were dugout from root zone taken out and presence of grub/larvae were recorded.

Cane length (cm): Cane length (cm) measured before harvesting.

TABLE 1
Treatment details for bio efficacy against
insect-pests infesting sugarcane

| Treatment | |
|---|---|
| Number | Treatment composition with application rate per hectare |
| T1 | Chlorantraniliprole 0.5% + Brassinolide 0.003% + |
| | Clothianidin 1% GR-SL, 10 kg (Ready-mix) |
| T2 | Cyantraniliprole 0.6% + Brassinolide 0.003% + |
| | Clothianidin 1% GR-SL, 10 kg (Ready-mix) |
| T3 | Cyclaniliprole 0.6% + Brassinolide 0.003% + Clothianidin |
| | 1% GR-SL, 10 kg (Ready-mix) |
| T4 | Tetraniliprole 0.5% + Brassinolide 0.003% + Clothianidin |
| | 1% GR-SL, 10 kg (Ready-mix) |
| T5 | Chlorantraniliprole 18.5% SC-250 ml + Brassinolide 0.2% |
| | SC-150 ml (Prior art) |
| T6 | Cyantraniliprole 10.26% OD-600 ml + Brassinolide 0.2% |
| | SC-150 ml (Prior art) |
| T7 | Cyclaniliprole 4.5% SL-1200 ml + Brassinolide 0.2% SC- |
| | 150 ml (Prior art) |
| T8 | Tetraniliprole 20% SC-250 ml + Brassinolide 0.2% SC-150 |
| | ml (Prior art) |
| T9 | Chlorantraniliprole 18.5% SC-250 ml + Clothianidin 50% |
| | WDG-200 g (Prior art) |
| T10 | Cyantraniliprole 10.26% OD-600 ml + Clothianidin 50% |
| | WDG-200 g (Prior art) |
| T11 | Cyclaniliprole 4.5% SL-1200 ml + Clothianidin 50% |
| | WDG-200 g (Prior art) |
| T12 | Tetraniliprole 20% SC-250 ml + Clothianidin 50% WDG- |
| | 200 g (Prior art) |
| T13 | Brassinolide 0.2% SC-150 ml + Clothianidin 50% WDG- |
| | 200 g (Prior art) |
| T14 | Chlorantraniliprole 18.5% SC-250 ml |
| T15 | Cyantraniliprole 10.26% OD-600 ml |
| T16 | Cyclaniliprole 4.5% SL-1200 ml |
| T17 | Tetraniliprole 20% SC-250 ml |
| T18 | Brassinolide 0.2% SC-150 ml |
| T19 | Clothianidin 50% WDG-200 g |
| T20 | UTC (Untreated Check) |

TABLE 2
Bioefficacy against sugarcane early shoot borer (ESB),
Chilo infuscatellus and Tiller and shoot count.

| | % Early shoot borer | | | | | |
|---|---|---|---|---|---|---|
| | (ESB) control | | | | Tiller | Shoot |
| Treatment | Obs. | Cal. | Colby's | Synergism | count at | count at |
| Number | Value | Value | ratio | (Y/N) | 60 DAP | 150 DAP |
| T1 | 96.2 | 82.00 | 1.17 | Y | 54.2 | 44.4 |
| T2 | 94.8 | 81.04 | 1.17 | Y | 53.8 | 43.2 |
| T3 | 97.2 | 82.38 | 1.18 | Y | 52.8 | 42.6 |
| T4 | 95.6 | 81.61 | 1.17 | Y | 52.6 | 42.2 |
| T5 | 65.8 | 67.39 | 0.98 | N | 41.8 | 33.4 |
| T6 | 63.4 | 65.64 | 0.97 | N | 42.6 | 34.0 |
| T7 | 66.8 | 68.08 | 0.98 | N | 42.2 | 33.7 |
| T8 | 65.2 | 66.69 | 0.98 | N | 41.4 | 33.2 |
| T9 | 78.2 | 79.36 | 0.99 | N | 46.2 | 37.2 |
| T10 | 75.4 | 78.25 | 0.96 | N | 45.8 | 36.6 |
| T11 | 77.6 | 79.80 | 0.97 | N | 46.8 | 37.4 |
| T12 | 76.8 | 78.91 | 0.97 | N | 45.4 | 36.2 |
| T13 | 50.2 | 51.87 | 0.97 | N | 42.2 | 33.8 |
| T14 | 62.6 | | | | 39.6 | 31.6 |
| T15 | 60.6 | | | | 39.8 | 31.8 |
| T16 | 63.4 | | | | 38.6 | 30.8 |
| T17 | 61.8 | | | | 38.2 | 30.6 |
| T18 | 12.8 | | | | 33.4 | 26.6 |
| T19 | 44.8 | | | | 41 | 32.8 |
| T20 | 0.0 | | | | 31.6 | 20 |

All innovative controlled/slow release granular (GR-SL) mix formulations (T1, T2, T3 and T4) shows synergism in terms of efficacy against early shoot borer control (>94% control) and also provides very good residual control (duration of control) compared to all prior art treatments (T5 to T13).

The number of tillers and productive shoots are much higher in GR-SL formulations (T1, T2, T3 and T4) compared to all prior art treatments (T5 to T13).

TABLE 3
Control of termite and white grub in sugarcane

| | % Plant damage by termite | | | % Plant | White grub | Cane |
|---|---|---|---|---|---|---|
| Treatment | 60 | 90 | 120 | damage by | larvae per | length |
| Number | DAS | DAS | DAS | white grub | cubic feet | (cm) |
| T1 | 0 | 0 | 0 | 0.42 | 0.2 | 244 |
| T2 | 0 | 0 | 0 | 0.36 | 0.2 | 248 |
| T3 | 0 | 0 | 0 | 0.40 | 0.4 | 246 |
| T4 | 0 | 0 | 0 | 0.32 | 0.2 | 245 |
| T5 | 0.36 | 1.64 | 5.84 | 2.16 | 1.8 | 224 |
| T6 | 0.40 | 1.82 | 6.16 | 2.40 | 2.0 | 221 |
| T7 | 0.42 | 1.9 | 6.42 | 2.36 | 1.6 | 223 |
| T8 | 0.36 | 1.84 | 5.96 | 2.28 | 2.2 | 222 |
| T9 | 0.12 | 0.56 | 2.84 | 1.62 | 0.8 | 230 |
| T10 | 0.10 | 0.62 | 2.46 | 1.48 | 1.0 | 233 |
| T11 | 0.14 | 0.72 | 2.64 | 1.52 | 1.4 | 229 |
| T12 | 0.12 | 0.64 | 2.74 | 1.70 | 1.0 | 228 |
| T13 | 0.24 | 0.86 | 4.68 | 3.26 | 2.6 | 232 |
| T14 | 1.20 | 2.84 | 8.28 | 4.82 | 3.2 | 216 |
| T15 | 1.32 | 2.58 | 9.42 | 3.94 | 3.0 | 219 |
| T16 | 1.10 | 2.9 | 8.86 | 4.12 | 3.0 | 218 |
| T17 | 1.20 | 2.76 | 9.2 | 3.68 | 3.2 | 217 |
| T18 | 1.16 | 6.24 | 16.82 | 10.26 | 4.2 | 215 |
| T19 | 0.46 | 1.96 | 7.62 | 5.82 | 2.8 | 218 |
| T20 | 6.20 | 10.73 | 23.84 | 22.64 | 6.8 | 212 |

All innovative controlled/slow release granular (GR-SL) ready mix formulations (T1, T2, T3, T4) shows cent percent protection against termite damage (up to 120 days). The white grub damage was recorded lowest and grub populations were also recorded lowest in innovative ready-mix formulations compared to all prior art treatments. Cane height were recorded highest in all innovative ready-mix formulations.

### Conclusion

1. Synergism was observed in innovative controlled/slow release granular (GR-SL) ready mix formulations.

2. The innovative controlled/slow release granular (GR-SL) ready mix formulations provide excellent control of ESB (early shoot borer), termite and white grub.

3. The innovative controlled/slow release granular (GR-SL) ready mix formulations provide longer duration of control of all key pests of sugarcane.

4. The innovative controlled/slow release granular (GR-SL) ready mix formulations produces higher number of productive shoots contributing to the cane yield.

5. Other visual observations are excellent plant growth and vigor, dark green color leaves, large leaf blades, increased girth of cane, profuse root system which are directly contributing to the cane yield. Farmers has to spend less on insect control.

Experiment 2: Control of Insect-Pests Infesting Sugarcane Crop

Crop & Variety: Sugarcane, Co-0238

Location: Yamunanagar, Haryana

Treatments: 19

Plot size: 6 m×0.90 cm×4 row

Planting material: 12 buds per meter (3 budded setts, 4 setts per meter)

Time of Application: At the time of planting

Method of Application: In furrow application, over the setts and cover up with soil. The required dose was mixed up with sand to bulk out further and broadcasted over planted setts in open furrow and then cover up with soil.

Agronomic Practices: All agronomic practices followed as per the crop requirement.

Observation Methods: Same as given in Experiment 1.

TABLE 4
Treatment details for bio-efficacy against
insect-pests infesting sugarcane

| Treatment | |
|---|---|
| Number | Treatment composition with application rate per hectare |
| T1 | Cyantraniliprole 0.5% + Sulphur 20% + Clothianidin |
| | 1% GR-SL, 8 kg (Ready mix) |
| T2 | Cyantraniliprole 0.4% + Sulphur 20% + Clothianidin |
| | 1.2% GR-SL, 8 kg (Ready mix) |
| T3 | Cyantraniliprole 0.3% + Sulphur 20% + Clothianidin |
| | 1.5% GR-SL, 8 kg (Ready mix) |
| T4 | Cyantraniliprole 10.26% OD-400 ml + Sulphur 80% |
| | WP-2 kg + Clothianidin 50% WDG-160 g (tank mix) |
| T5 | Cyantraniliprole 10.26% OD-320 ml + Sulphur 80% |
| | WP-2 kg + Clothianidin 50% WDG-192 g (tank mix) |
| T6 | Cyantraniliprole 10.26% OD-240 ml + Sulphur 80% |
| | WP-2 kg + Clothianidin 50% WDG-240 g (tank mix) |
| T7 | Cyantraniliprole 10.26% OD-400 ml + Clothianidin |
| | 50% WDG-160 g (Prior art) |
| T8 | Cyantraniliprole 10.26% OD-320 ml + Clothianidin |
| | 50% WDG-192 g (Prior art) |
| T9 | Cyantraniliprole 10.26% OD-240 ml + Clothianidin |
| | 50% WDG-240 g (Prior art) |
| T10 | Cyantraniliprole 10.26% OD-400 ml + Sulphur 80% |
| | WP-2 kg (Prior art) |
| T11 | Sulphur 80% WP-2 kg + Clothianidin 50% WDG-240 g |
| | (Prior art) |
| T13 | Cyantraniliprole 10.26% OD-320 ml |
| T14 | Cyantraniliprole 10.26% OD-240 ml |
| T15 | Sulphur 80% WP-2 kg |
| T16 | Clothianidin 50% WDG-160 g |
| T17 | Clothianidin 50% WDG-192 g |
| T18 | Clothianidin 50% WDG-240 g |
| T19 | UTC (Untreated Check) |

TABLE 5
Bioefficacy against insect-pests infesting sugarcane

| | | | | | Tiller | | | |
|---|---|---|---|---|---|---|---|---|
| | | | | | count | % Top | | |
| | % Early shoot borer (ESB) control | | | | at 60 | borer | Shoot | Cane |
| | 60 DAP | | | | DAP | control | count | height |
| Treatment | | | | Synergism | 60 | 150 | 150 | (cm) at |
| Number | Obs. Value | Cal. Value | Colby's ratio | (Y/N) | DAP | DAP | DAP | Harvest |
| T1 | 100 | 79.15 | 1.26 | Y | 48.6 | 88.4 | 36.4 | 258.2 |
| T2 | 98.2 | 77.34 | 1.27 | Y | 47.2 | 82.4 | 35.4 | 257.3 |
| T3 | 94.6 | 77.20 | 1.23 | Y | 46.8 | 80.6 | 35 | 253.6 |
| T4 | 85.6 | 79.15 | 1.08 | Y | 47.6 | 66.2 | 35.8 | 243.7 |
| T5 | 83 | 77.34 | 1.07 | Y | 46.4 | 62.4 | 34.8 | 240.1 |
| T6 | 80.2 | 77.20 | 1.04 | Y | 45.2 | 54.8 | 34 | 239.7 |
| T7 | 75.2 | 77.63 | 0.97 | N | 39.6 | 62.8 | 29.8 | 236.4 |
| T8 | 72.8 | 75.68 | 0.96 | N | 38.6 | 58.8 | 30 | 234.9 |
| T9 | 70.6 | 75.54 | 0.93 | N | 36.4 | 50.4 | 27.2 | 235.1 |
| T10 | 65.4 | 67.01 | 0.98 | N | 34.2 | 57.8 | 25.6 | 228.5 |
| T11 | 50.2 | 51.91 | 0.97 | N | 32.6 | 46.8 | 24.4 | 230.6 |
| T12 | 64.6 | | | | 33.6 | 56.8 | 25.2 | 227.3 |
| T13 | 59.2 | | | | 31.2 | 54.6 | 23.4 | 222.5 |
| T14 | 52.6 | | | | 29.4 | 46.2 | 22 | 218.7 |
| T15 | 6.8 | | | | 24.8 | 1.2 | 18.6 | 210.7 |
| T16 | 36.8 | | | | 26.4 | 30.4 | 19.8 | 224.4 |
| T17 | 40.4 | | | | 28.8 | 38.2 | 21.6 | 225.6 |
| T18 | 48.4 | | | | 31.2 | 44.8 | 23.4 | 228.3 |
| T19 | 0.0 | | | | 22.4 | 0 | 16.8 | 206.7 |

The ready mix controlled/slow releasing granular formulations (T1, T2, T3) shows synergistic activity against early shoot borer (ESB) control compared to all prior arts (T7 to T11). The level of synergism (ratio>1.23) was observed strong in ready mix slow releasing granular formulations (T1, T2, T3) compared to their on-farm mixing treatments (T4, T5, T6).

The ready-mix slow releasing granular formulations (T1, T2, T3) also produces higher number of tillers and shoots. Top borer control was observed excellent in the treatments of ready-mix slow releasing granular formulations and also produces cane with maximum heights in comparison with prior art treatments.

Experiment 3: Control of Insect Pests of Cumin

Crop: Cumin

Location: Bhildi, Gujarat

Plot size: 30 sq. mt.

Number of Treatments: 18

Application Time: 15 days after sowing just before irrigation.

Method of Application: Broadcasting in to soil

Agronomic Practices: All agronomic practices followed as per the crop requirement.

Observation Methods:

Aphid (Aphis gossypii) control (%): Record the aphid population by aphid index (0 to 4) and calculate % aphid control.

Helicoverpa armigera larval control (%): Record the number of live larval population per sq.mt area by shaking the plant from 5 spot per plot. Calculate % larval control.

Spodoptera exigua larval control (%): same as above. % Insect control data are used to calculate synergism by using Colby's formula.

Yield: Record the yield per plot in kg at the time of harvest.

TABLE 6
Treatment details for bio efficacy
against insect-pests of cumin crop.

| Treatment | |
|---|---|
| Number | Treatment details with use rate per hectare |
| T1 | Chlorantraniliprole 0.5% + Zinc 2% + Sulphur 18% + |
| | Clothianidin 0.6% GR-10 kg (Ready mix) |
| T2 | Chlorantraniliprole 0.5% + Zinc 2% + Sulphur 18% + |
| | Fipronil 0.6% GR-10 kg (Ready mix) |
| T3 | Chlorantraniliprole 0.5% + Zinc 2% + Salicylic acid |
| | 0.25% + Clothianidin 0.6% GR-10 kg (Ready mix) |
| T4 | Chlorantraniliprole 0.5% + Zinc 2% + Salicylic acid |
| | 0.25% + Fipronil 0.6% GR-10 kg (Ready mix) |
| T5 | Chlorantraniliprole 18.5% SC-250 ml + Zinc 12% WP- |
| | 1667 g + Sulphur 90% WG-2 kg (A + B1 Prior art) |
| T6 | Chlorantraniliprole 18.5% SC-250 ml + Zinc 12% WP- |
| | 1667 g + Salicylic acid 4% WP-625 g (A + B2 Prior art) |
| T7 | Chlorantraniliprole 18.5% SC-250 ml + Clothianidin |
| | 50% WDG-120 g (A + C1 Prior art) |
| T8 | Chlorantraniliprole 18.5% SC-250 ml + Fipronil 0.6% |
| | GR-10 kg (A + C2 Prior art) |
| T9 | Zinc 12% WP-1667 g + Sulphur 90% WG-2 kg + |
| | Clothianidin 50% WDG-120 g (B1 + C1 Prior art) |
| T10 | Zinc 12% WP-1667 g + Sulphur 90% WG-2 kg + Fipronil |
| | 0.6% GR-10 kg (B1 + C2 Prior art) |
| T11 | Zinc 12% WP-1667 g + Salicylic acid 4% WP-625 g + |
| | Clothianidin 50% WDG-120 g (B2 + C1 Prior art) |
| T12 | Zinc 12% WP-1667 g + Salicylic acid 4% WP-625 g + |
| | Fipronil 0.6% GR-10 kg (B2 + C2 Prior art) |
| T13 | Chlorantraniliprole 18.5% SC-250 ml (A) |
| T14 | Zinc 12% WP-1667 g + Sulphur 90% WG-2 kg (B1) |
| T15 | Zinc 12% WP-1667 g + Salicylic acid 4% WP-625 g (B2) |
| T16 | Clothianidin 50% WDG-120 g (C1) |
| T17 | Fipronil 0.6% GR-10 kg (C2) |
| T18 | Untreated Control Check (UTC) |

TABLE 7
Bio-efficacy against insect-pests of cumin crop and yield.

| | | | | % Helicoverpa larval | | | | | % |
|---|---|---|---|---|---|---|---|---|---|
| | % Aphid control | | | control | | | | | Increase |
| | 40 DAS | | | 75 DAS | | | | | in yield |
| Treatment | Obs. | Cal. | Colby's | Obs. | Cal. | Colby's | Synergism | Yield | over |
| Number | Value | Value | ratio | Value | Value | ratio | (Y/N) | (kg/plot) | UTC |
| T1 | 100 | 79.01 | 1.27 | 92.4 | 82.72 | 1.12 | Y | 2.60 | 120.34 |
| T2 | 90.6 | 72.37 | 1.25 | 94.6 | 85.34 | 1.11 | Y | 2.50 | 111.86 |
| T3 | 100 | 79.66 | 1.26 | 91.6 | 82.79 | 1.11 | Y | 2.52 | 113.56 |
| T4 | 88.4 | 73.22 | 1.21 | 95.6 | 85.40 | 1.12 | Y | 2.48 | 110.17 |
| T5 | 40.4 | 46.45 | 0.87 | 74.2 | 77.02 | 0.96 | N | 1.86 | 57.63 |
| T6 | 44.2 | 48.10 | 0.92 | 73 | 77.11 | 0.95 | N | 1.92 | 62.71 |
| T7 | 75.0 | 75.07 | 1.00 | 80.2 | 81.65 | 0.98 | N | 2.16 | 83.05 |
| T8 | 65.2 | 67.18 | 0.97 | 81.0 | 84.43 | 0.96 | N | 2.08 | 76.27 |
| T9 | 64.6 | 66.99 | 0.96 | 25.6 | 29.16 | 0.88 | N | 1.76 | 49.15 |
| T10 | 53.8 | 56.55 | 0.95 | 33.4 | 39.90 | 0.84 | N | 1.72 | 45.76 |
| T11 | 66.8 | 68.01 | 0.98 | 25.6 | 29.46 | 0.87 | N | 1.64 | 38.98 |
| T12 | 52.4 | 57.89 | 0.91 | 36.6 | 40.16 | 0.91 | N | 1.60 | 35.59 |
| T13 | 36.4 | | | 75.6 | | | | 1.56 | 32.20 |
| T14 | 15.8 | | | 5.8 | | | | 1.42 | 20.34 |
| T15 | 18.4 | | | 6.2 | | | | 1.38 | 16.95 |
| T16 | 60.8 | | | 24.8 | | | | 1.52 | 28.81 |
| T17 | 48.4 | | | 36.2 | | | | 1.48 | 25.42 |
| T18 | 0.0 | | | 0.0 | | | | 1.18 | 0.00 |

The ready-mix granular application of innovative combinations (T1, T2, T3, T4) shows synergism in terms of efficacy against Aphid and Helicoverpa larval control and also yielded higher (minimum 27% over prior arts and 110% over untreated) cumin seed yield as compared to all prior art treatments (T5 to T12).

Experiment 4: Bio-Efficacy Against Insect Pests Infesting Tomato Crop

Crop & Variety: Tomato, Abhinav

Location Anand, Gujarat

Treatments: 20

Plot size: 20 sq.m

Spacing: 90 cm×15 cm

Time of Application: 7 days after transplanting

Method of Application: Ring application around the plant and covered with soil.

Agronomic Practices: All agronomic practices followed as per the crop requirement.

Observation Methods:

Leaf miner control (%): Count the number of healthy leaves and damaged leaves per plant.

Record observations from 5 plants per plot and calculate % leaf miner control by given Formula.

$$\% Leaf miner damage = \frac{number of damaged leaflet }{number of total leaflet observed} \times 100$$

$$\% Leaf miner control = 100 - \frac{\% Leaf miner damaged in treatment }{\% Leaf miner damaged in untreated plot} \times 100$$

% Leaf miner control data used to check the synergism by applying Colby's formula.

Damage by Nematode: Efficacy against nematode has been assessed by observing the infestation on root at 60 days after transplanting. % reduction in nematode infestation has been worked out.

| Root galling index | Description |
|---|---|
| 0 | No galling |
| 1 | trace infection with a few small galls |
| 2 | <25% root galls |
| 3 | 25-50% root galls |
| 4 | 51-74% root galls |
| 5 | >75% root galls |

TABLE 8
Treatment details for bio-efficacy evaluation
of ready-mix formulations in tomato crop

| Treatment | |
|---|---|
| Number | Treatment composition with application rate per hectare |
| T1 | Chlorantraniliprole 0.5% + Salicylic acid 0.4% + |
| | Thiamethoxam 1.25% GR- SL, 10 kg (Ready-Mix) |
| T2 | Cyantraniliprole 0.6% + Salicylic acid 0.4% + |
| | Thiamethoxam 1.25% GR- SL, 10 kg (Ready-Mix) |
| T3 | Cyclaniliprole 0.6% + Salicylic acid 0.4% + |
| | Thiamethoxam 1.25% GR-SL, 10 kg (Ready-Mix) |
| T4 | Tetraniliprole 0.5% + Salicylic acid 0.4% + |
| | Thiamethoxam 1.25% GR-SL, 10 kg (Ready-Mix) |
| T5 | Chlorantraniliprole 18.5% SC-250 ml + Salicylic |
| | acid 4% WP-1000 g (Prior art) |
| T6 | Cyantraniliprole 10.26% OD-600 ml + Salicylic acid |
| | 4% WP-1000 g (Prior art) |
| T7 | Cyclaniliprole 4.5% SL-1200 ml + Salicylic acid 4% |
| | WP-1000 g (Prior art) |
| T8 | Tetraniliprole 20% SC-250 ml + Salicylic acid 4% |
| | WP-1000 g (Prior art) |
| T9 | Chlorantraniliprole 18.5% SC-250 ml + Thiamethoxam |
| | 25% WG-500 g (Prior art) |
| T10 | Cyantraniliprole 10.26% OD-600 ml + Thiamethoxam |
| | 25% WG-500 g (Prior art) |
| T11 | Cyclaniliprole 4.5% SL-1200 ml + Thiamethoxam 25% |
| | WG-500 g (Prior art) |
| T12 | Tetraniliprole 20% SC-250 ml + Thiamethoxam 25% |
| | WG-500 g (Prior art) |
| T13 | Salicylic acid 4% WP-1000 g + Thiamethoxam 25% WG- |
| | 500 g (Prior art) |
| T14 | Chlorantraniliprole 18.5% SC-250 ml |
| T15 | Cyantraniliprole 10.26% OD-600 ml |
| T16 | Cyclaniliprole 4.5% SL-1200 ml |
| T17 | Tetraniliprole 20% SC-250 ml |
| T18 | Salicylic acid 4% WP-1000 g |
| T19 | Thiamethoxam 25% WG-500 g |
| T20 | UTC (Untreated Check) |

TABLE 9
Efficacy against tomato leaf miner, Liriomyza trifolii and root know nematode
(RKN) Meloidogyne spp.

| | | | | Root galling | % Reduction | |
|---|---|---|---|---|---|---|
| | | | | Index (Root | root knot | Number of |
| Treatment | % Leaf miner damage control | | | knot nematode | nematode | fruits/10 |
| Number | Obs. Value | Cal. Value | Colby's ratio | damage) | damage | plants |
| T1 | 96.6 | 83.81 | 1.15 | 1.2 | 72.7 | 126.4 |
| T2 | 96.4 | 83.55 | 1.15 | 1.3 | 70.5 | 118.2 |
| T3 | 97.2 | 83.20 | 1.17 | 1.2 | 72.7 | 120.4 |
| T4 | 96.2 | 83.90 | 1.15 | 1.2 | 72.7 | 109.6 |
| T5 | 64.8 | 65.70 | 0.99 | 2.3 | 47.7 | 82.8 |
| T6 | 64.2 | 65.14 | 0.99 | 2.1 | 52.3 | 80.4 |
| T7 | 63.2 | 64.40 | 0.98 | 2.4 | 45.5 | 77.6 |
| T8 | 64.2 | 65.89 | 0.97 | 2.3 | 47.7 | 80.4 |
| T9 | 80.8 | 82.63 | 0.98 | 2.8 | 36.4 | 76.4 |
| T10 | 81.4 | 82.35 | 0.99 | 2.6 | 40.9 | 75.8 |
| T11 | 80.2 | 81.97 | 0.98 | 2.9 | 34.1 | 80 |
| T12 | 81.8 | 82.72 | 0.99 | 2.8 | 36.4 | 78.8 |
| T13 | 55.6 | 56.01 | 0.99 | 2.4 | 45.5 | 64.2 |
| T14 | 63.2 | | | 3.6 | 18.2 | 68.4 |
| T15 | 62.6 | | | 3.4 | 22.7 | 67.2 |
| T16 | 61.8 | | | 3.5 | 20.5 | 69.2 |
| T17 | 63.4 | | | 3.7 | 15.9 | 68.6 |
| T18 | 6.8 | | | 2.4 | 45.5 | 46.4 |
| T19 | 52.8 | | | 3.4 | 22.7 | 38.2 |
| T20 | 0.0 | | | 4.4 | 0.0 | 32.6 |

All innovative controlled/slow release (GR-SL) ready mix granular (T1, T2, T3, T4) shows synergism in terms of efficacy against leaf miner and root know nematode. Other visual observations show excellent crop vigor, greenery, a greater number of flowers, branches and fruits, a greater number of secondary and tertiary roots. Overall, more crop canopy compared to all prior art treatments.

Experiment 5: Control of Insect-Pests of Paddy/Rice Crop

Crop: Paddy

Location: Kurud, Dhamtari, Chattishgarh

Plot size: 24 sq. mt. (6 m×4 m)

Number of Treatments: 30

Application Time: 20 DATP (Days after transplanting)

Method of Application: Soil application. The required quantity of ready-mix granules and other prior art treatments was mixed with sand and manually broad casted.

Agronomic Practices: All agronomic practices followed as per the crop requirement.

Observation Methods:

Leaf folder (Cnaphalocrocis medinalios) & stem borer (Scirpophaga incertulas) control: The infestation by stem borer and leaf folder was observed as dead heart (DH), white ear (WE), and leaf folder damaged leaves (LFD) appeared during vegetative stage and reproductive stages from 10 hills per plot. The observation on percent dead hearts at vegetative stage and the leaf damage as percent damaged leaves were recorded at 30, 45 DATP (Days after transplanting) and white ear was recorded before harvest of the crop. The leaf was considered to be damaged by the leaf folder if at least ⅓ of its area showed symptoms.

The percentage of DH, WE and LFD in each individual plot was calculated by using formulae described below:

$$\% Dead Heart ( DH \% ) = \frac{Number of dead heart per 10 hills}{Total number of tillers per 10 hills} \times 100$$

$$\% Stem borer control ( Dead Heart symptoms ) = 100 - \frac{Dead heart ( \% ) in treatment }{Dead heart ( \% ) in untreated} \times 100$$

$$White ear ( WE \% ) = \frac{Number of white ear per 10 hills}{Total number of bearing panicle per 10 hills} \times 100$$

$$\% Stem borer control ( White ear symptoms ) = 100 - \frac{White ear ( \% ) in treatment }{White ear ( \% ) in untreated} \times 100$$

$$Leaf folder damage ( LFD \% ) = \frac{Number of infested leaves per 10 hills}{Total number of leaves per 10 hills} \times 100$$

$$Leaf folder control ( \% ) = 100 - \frac{Leaf folder damage ( \% ) in treatment }{Leaf folder damage ( \% ) in untreated} \times 100$$

% Brown Plant Hopper (BPH), Nilaparvata lugens control: Count the number of hoppers (BPH) per hill, observe 10 hills per plot. Record the observations when moderate infestation noticed in untreated plot. Calculate the % Hoppers (BPH) control (observed value) as below formula.

$$\% Hoppers ( BPH ) control = 100 - \frac{Number of live BPH in treated plot}{Number of live BPH in untreated plot} \times 100$$

The calculated value of % control was used to worked out the Colby's formula to judge the synergism.

Tiller count: Count the number of productive tillers per hill. Record observations from 10 hills per plot at the time of harvesting.

TABLE 10
Treatment details for field bio-efficacy
against insect-pests infesting paddy crop

| Treatment | |
|---|---|
| Number | Treatment composition with application rate per hectare |
| T1 | Chlorantraniliprole 0.3% + Zinc 1% + Triflumezopyrim 0.5% |
| | GR-10 kg (ready mix) |
| T2 | Cyantraniliprole 0.5% + Zinc 1% + Triflumezopyrim 0.5% |
| | GR-10 kg (ready mix) |
| T3 | Tetraniliprole 0.5% + Zinc 1% + Triflumezopyrim 0.5% |
| | GR-10 kg (ready mix) |
| T4 | Cyclaniliprole 0.5% + Zinc 1% + Triflumezopyrim 0.5% |
| | GR-10 kg (ready mix) |
| T5 | Chlorantraniliprole 0.3% + Zinc 1% + Flupyrimin 1% |
| | GR-10 kg (ready mix) |
| T6 | Cyantraniliprole 0.5% + Zinc 1% + Flupyrimin 1% |
| | GR-10 kg (ready mix) |
| T7 | Tetraniliprole 0.5% + Zinc 1% + Flupyrimin 1% GR- |
| | 10 kg (ready mix) |
| T8 | Cyclaniliprole 0.5% + Zinc 1% + Flupyrimin 1% GR- |
| | 10 kg (ready mix) |
| T9 | Chlorantraniliprole 18.5% SC-150 ml + Zinc 12% WP-833 g |
| | (prior art) |
| T10 | Cyantraniliprole 10.26% OD-500 ml + Zinc 12% WP-833 g |
| | (prior art) |
| T11 | Tetraniliprole 20% SC-250 ml + Zinc 12% WP-833 g |
| | (prior art) |
| T12 | Cyclaniliprole 4.5% SL-1000 ml + Zinc 12% WP-833 g |
| | (prior art) |
| T13 | Chlorantraniliprole 18.5% SC-150 ml + Triflumezopyrim |
| | 10.6% SC-471.7 ml (prior art) |
| T14 | Cyantraniliprole 10.26% OD-500 ml + Triflumezopyrim |
| | 10.6% SC-471.7 ml (prior art) |
| T15 | Tetraniliprole 20% SC-250 ml + Triflumezopyrim 10.6% |
| | SC-471.7 ml (prior art) |
| T16 | Cyclaniliprole 4.5% SL-1000 ml + Triflumezopyrim 10.6% |
| | SC-471.7 ml (prior art) |
| T17 | Chlorantraniliprole 18.5% SC-150 ml + Flupyrimin 2% GR- |
| | 5 kg (prior art) |
| T18 | Cyantraniliprole 10.26% OD-500 ml + Flupyrimin 2% GR-5 |
| | kg (prior art) |
| T19 | Tetraniliprole 20% SC-250 ml + Flupyrimin 2% GR-5 kg |
| | (prior art) |
| T20 | Cyclaniliprole 4.5% SL-1000 ml + Flupyrimin 2% GR-5 kg |
| | (prior art) |
| T21 | Zinc 12% WP-833 g + Triflumezopyrim 10.6% SC-471.7 ml |
| | (prior art) |
| T22 | Zinc 12% WP-833 g + Flupyrimin 2% GR-5 kg (prior art) |
| T23 | Chlorantraniliprole 18.5% SC-150 ml |
| T24 | Cyantraniliprole 10.26% OD-500 ml |
| T25 | Tetraniliprole 20% SC-250 ml |
| T26 | Cyclaniliprole 4.5% SL-1000 ml |
| T27 | Zinc 12% WP-833 g |
| T28 | Triflumezopyrim 10.6% SC-471.7 ml |
| T29 | Flupyrimin 2% GR-5 kg |
| T30 | UTC (Untreated Check) |

TABLE 11
Field bio-efficacy of innovative ready-mix granular formulations against
insect-pests infesting paddy crop

| | | | | % Stem borer control | | | % Stem borer control | | | |
|---|---|---|---|---|---|---|---|---|---|---|
| | % Leaf folder control | | | (Dead heart symptoms) | | | (White ear symptoms) | | | |
| | 30 DATP | | | 45 DATP | | | Before harvest | | | |
| Treatment | Obs. | Cal. | Colby's | Obs. | Cal. | Colby's | Obs. | Cal. | Colby's | Synergism |
| Number | Value | Value | ratio | Value | Value | ratio | Value | Value | ratio | (Y/N) |
| T1 | 100 | 81.34 | 1.23 | 88.2 | 73.36 | 1.20 | 96.6 | 83.81 | 1.15 | Y |
| T2 | 100 | 81.04 | 1.23 | 87.4 | 74.92 | 1.17 | 96.4 | 83.55 | 1.15 | Y |
| T3 | 100 | 80.63 | 1.24 | 90.2 | 73.93 | 1.22 | 97.2 | 83.20 | 1.17 | Y |
| T4 | 100 | 81.44 | 1.23 | 86.8 | 72.51 | 1.20 | 96.2 | 83.90 | 1.15 | Y |
| T5 | 100 | 85.73 | 1.17 | 100 | 86.04 | 1.16 | 98.4 | 86.49 | 1.14 | Y |
| T6 | 100 | 85.50 | 1.17 | 100 | 86.86 | 1.15 | 96.2 | 86.27 | 1.12 | Y |
| T7 | 100 | 85.19 | 1.17 | 100 | 86.34 | 1.16 | 95.6 | 85.97 | 1.11 | Y |
| T8 | 100 | 85.81 | 1.17 | 100 | 85.60 | 1.17 | 97.2 | 86.56 | 1.12 | Y |
| T9 | 64.8 | 65.70 | 0.99 | 62.6 | 64.58 | 0.97 | 64.8 | 65.70 | 0.99 | N |
| T10 | 65.0 | 65.14 | 1.00 | 65.8 | 66.65 | 0.99 | 65.0 | 65.14 | 1.00 | N |
| T11 | 63.2 | 64.40 | 0.98 | 64.8 | 65.33 | 0.99 | 63.2 | 64.40 | 0.98 | N |
| T12 | 64.2 | 65.89 | 0.97 | 62.2 | 63.45 | 0.98 | 64.2 | 65.89 | 0.97 | N |
| T13 | 74.6 | 79.98 | 0.93 | 70.8 | 71.72 | 0.99 | 80.8 | 82.63 | 0.98 | N |
| T14 | 75.2 | 79.65 | 0.94 | 72.2 | 73.38 | 0.98 | 81.4 | 82.35 | 0.99 | N |
| T15 | 76.4 | 79.22 | 0.96 | 71.6 | 72.33 | 0.99 | 80.2 | 81.97 | 0.98 | N |
| T16 | 77.2 | 80.09 | 0.96 | 69.4 | 70.82 | 0.98 | 81.8 | 82.72 | 0.99 | N |
| T17 | 84.2 | 84.69 | 0.99 | 84.4 | 85.19 | 0.99 | 84.4 | 85.50 | 0.99 | N |
| T18 | 84.0 | 84.44 | 0.99 | 85.6 | 86.05 | 0.99 | 83.8 | 85.26 | 0.98 | N |
| T19 | 83.6 | 84.11 | 0.99 | 84.6 | 85.50 | 0.99 | 83.6 | 84.95 | 0.98 | N |
| T20 | 83.8 | 84.77 | 0.99 | 83.6 | 84.71 | 0.99 | 85.2 | 85.58 | 1.00 | N |
| T21 | 48.8 | 49.30 | 0.99 | 28.2 | 29.16 | 0.97 | 56 | 56.01 | 1.00 | N |
| T22 | 60.6 | 61.23 | 0.99 | 60.4 | 62.89 | 0.96 | 62.4 | 63.28 | 0.99 | N |
| T23 | 63.2 | | | 62.4 | | | 63.2 | | | N |
| T24 | 62.6 | | | 64.6 | | | 62.6 | | | N |
| T25 | 61.8 | | | 63.2 | | | 61.8 | | | N |
| T26 | 63.4 | | | 61.2 | | | 63.4 | | | N |
| T27 | 6.8 | | | 5.8 | | | 6.8 | | | N |
| T28 | 45.6 | | | 24.8 | | | 52.8 | | | N |
| T29 | 58.4 | | | 60.6 | | | 60.6 | | | N |
| T30 | 0.0 | | | 0.0 | | | 0.0 | | | N |

The granular formulation of all innovative ready mixtures (T1 to T8) shows synergism in terms of efficacy against key lepidopteran insects, paddy leaf folder and stem borer compared to all prior arts treatments (T9 to T22).

TABLE 12
Field bio-efficacy of innovative ready-mix granular formulations
against insect-pests infesting paddy crop

| | % BPH control | | | | Number of |
|---|---|---|---|---|---|
| | 75 DATP | | | | productive |
| Treatment | Obs. | Cal. | Colby's | Synergism | tillers at |
| Number | Value | Value | ratio | (Y/N) | before harvest |
| T1 | 96.2 | 87.97 | 1.09 | Y | 48.40 |
| T2 | 97.8 | 89.12 | 1.10 | Y | 49.40 |
| T3 | 96.6 | 88.02 | 1.10 | Y | 48.60 |
| T4 | 95.2 | 88.52 | 1.08 | Y | 48.00 |
| T5 | 98.4 | 89.51 | 1.10 | Y | 47.60 |
| T6 | 97.2 | 90.52 | 1.07 | Y | 49.20 |
| T7 | 96.8 | 89.56 | 1.08 | Y | 47.60 |
| T8 | 98.4 | 89.99 | 1.09 | Y | 48.80 |
| T9 | 57.8 | 59.35 | 0.97 | N | 34.40 |
| T10 | 59.4 | 63.25 | 0.94 | N | 33.80 |
| T11 | 56.2 | 59.54 | 0.94 | N | 32.60 |
| T12 | 58.6 | 61.21 | 0.96 | N | 33.20 |
| T13 | 86.6 | 87.04 | 0.99 | N | 40.20 |
| T14 | 87.4 | 88.28 | 0.99 | N | 39.80 |
| T15 | 86.4 | 87.09 | 0.99 | N | 40.40 |
| T16 | 87.0 | 87.63 | 0.99 | N | 39.60 |
| T17 | 88.2 | 88.70 | 0.99 | N | 40.20 |
| T18 | 88.8 | 89.78 | 0.99 | N | 39.40 |
| T19 | 88.0 | 88.75 | 0.99 | N | 37.80 |
| T20 | 88.6 | 89.22 | 0.99 | N | 40.20 |
| T21 | 71.8 | 72.53 | 0.99 | N | 34.60 |
| T22 | 75.6 | 76.06 | 0.99 | N | 31.60 |
| T23 | 56.2 | | | N | 28.80 |
| T24 | 60.4 | | | N | 27.80 |
| T25 | 56.4 | | | N | 29.40 |
| T26 | 58.2 | | | N | 29.80 |
| T27 | 7.2 | | | N | 21.60 |
| T28 | 70.4 | | | N | 26.80 |
| T29 | 74.2 | | | N | 26.20 |
| T30 | 0.0 | | | N | 18.60 |

The granular formulation of all innovative ready mixtures (T1 to T8) shows also shows synergistic efficacy against key sucking pests of paddy i.e., brown plant hopper (BPH) and also produces higher number of productive tillers compared to all prior arts treatments (T9 to T22). Summery:

The ready-mix granular formulations of innovative combinations provide season long control of key pests of paddy crop i.e., leaf folder, stem bore and brown plan hopper (BPH). This will help the farmer to reduce the frequent pesticidal spray in paddy field at different interval. The single granular application controls the key insects up to the harvest. These combinations will be highly useful to all paddy farmers as it will reduces frequent exposure to the pesticides, granular formulations are easy to handle and apply, labor and costing saving.

Experiment 6: Control of Insect-Pests of Paddy/Rice Crop

Crop: Paddy

Location: Raichur, Karnataka

Plot size: 24 sq. mt. (6 m×4 m)

Number of Treatments: 24

Application Time: 18 DATP (Days after transplanting)

Method of Application: Soil application. The required quantity of ready-mix granules and other prior art treatments was mixed with sand and manually broad casted.

Agronomic Practices: All agronomic practices followed as per the crop requirement.

Observation Methods: As given in experiment 5.

TABLE 13
Treatment details for Field bio-efficacy of innovative
ready-mix controlled/slow release granular (GR-SL) formulations
against insect-pests infesting paddy crop

| Treatment | |
|---|---|
| Number | Treatment details with application Rate (ml or g per Hectare) |
| T1 | Cyantraniliprole 0.5% + Zinc 2% + Humic acid 2% + |
| | Clothianidin 1% GR-SL @10 kg (Ready mix) |
| T2 | Cyantraniliprole 0.5% + Zinc 2% + Humic acid 2% + |
| | Thiamethoxam 1% GR-SL @10 kg (Ready mix) |
| T3 | Cyantraniliprole 0.5% + Zinc 2% + Humic acid 2% + |
| | Triflumezopyrim 0.6% GR-SL @10 kg (Ready mix) |
| T4 | Cyantraniliprole 0.5% + Zinc 2% + Humic acid 2% + |
| | Flupyrimin 1% GR-SL @10 kg (Ready mix) |
| T5 | Cyantraniliprole 0.5% + Zinc 2% + Humic acid 2% + |
| | Fipronil 0.6% GR-SL @10 kg (Ready mix) |
| T6 | (Zinc 12% WP-1667 g + Humic acid 90% WP-222.2 g) + |
| | Clothianidin 50% WDG-200 g, B + C1 (prior art) |
| T7 | (Zinc 12% WP-1667 g + Humic acid 90% WP-222.2 g) + |
| | Thiamethoxam 25% WG-400 g, B + C2 (prior art) |
| T8 | (Zinc 12% WP-1667 g + Humic acid 90% WP-222.2 g) + |
| | Triflumezopyrim 10.6% SC-566 ml, B + C3 (prior art) |
| T9 | (Zinc 12% WP-1667 g + Humic acid 90% WP-222.2 g) + |
| | Flupyrimin 2% GR-5 kg, B + C4 (prior art) |
| T10 | (Zinc 12% WP-1667 g + Humic acid 90% WP-222.2 g) + |
| | Fipronil 0.3% GR-20 kg, B + C5 (prior art) |
| T11 | Cyantraniliprole 10.26% OD-500 ml + Clothianidin 50% |
| | WDG-200 g, A + C1 (prior art) |
| T12 | Cyantraniliprole 10.26% OD-500 ml + Thiamethoxam 25% |
| | WG-400 g, A + C2 (prior art) |
| T13 | Cyantraniliprole 10.26% OD-500 ml + Triflumezopyrim |
| | 10.6% SC-566 ml, A + C3 (prior art) |
| T14 | Cyantraniliprole 10.26% OD-500 ml + Flupyrimin 2% GR-5 |
| | kg, A + C4 (prior art) |
| T15 | Cyantraniliprole 10.26% OD-500 ml + Fipronil 0.3% GR-20 |
| | kg, A + C5 (prior art) |
| T16 | Cyantraniliprole 10.26% OD-500 ml + (Zinc 12% WP-1667 |
| | g + Humic acid 90% WP-222.2 g) A + B (prior art) |
| T17 | Clothianidin 50% WDG-200 g (C1) |
| T18 | Thiamethoxam 25% WG-400 g (C2) |
| T19 | Triflumezopyrim 10.6% SC-566 ml (C3) |
| T20 | Flupyrimin 2% GR-5 kg (C4) |
| T21 | Fipronil 0.3% GR-20 kg (C5) |
| T22 | Zinc 12% WP-1667 g + Humic acid 90% WP-222.2 g (B) |
| T23 | Cyantraniliprole 10.26% OD-500 ml (A) |
| T24 | UTC (Untreated Check) |

TABLE 14a
Field bio efficacy against Leaf folder and stem bore infesting paddy crop

| | | | | % Stem borer control | | | % Stem borer control | | |
|---|---|---|---|---|---|---|---|---|---|
| | | | | (Dead heart symptoms) | | | (White ear symptoms) | | |
| | % Leaf folder control | | | 45 DATP | | | 90 DATP | | |
| Treatment | 30 DATP | | | Obs. | Cal. | Colby's | Obs. | Cal. | Colby's |
| Number | Obs. Value | Cal. Value | Colby's ratio | Value | Value | ratio | Value | Value | ratio |
| T1 | 92.6 | 82.38 | 1.12 | 90.4 | 81.94 | 1.10 | 75.2 | 69.95 | 1.08 |
| T2 | 90.2 | 81.44 | 1.11 | 88.4 | 80.29 | 1.10 | 72.4 | 68.44 | 1.06 |
| T3 | 89.6 | 80.72 | 1.11 | 87.2 | 79.54 | 1.10 | 72.8 | 67.80 | 1.07 |
| T4 | 99.2 | 91.22 | 1.09 | 98.4 | 89.01 | 1.11 | 89.6 | 83.10 | 1.08 |
| T5 | 96.2 | 90.66 | 1.06 | 93.4 | 88.25 | 1.06 | 85.2 | 79.36 | 1.07 |
| T6 | 42.4 | 44.24 | 0.96 | 45.2 | 47.49 | 0.95 | 24.6 | 27.77 | 0.89 |
| T7 | 40.8 | 41.27 | 0.99 | 40.6 | 42.72 | 0.95 | 21.2 | 24.13 | 0.88 |
| T8 | 37.8 | 38.99 | 0.97 | 36.8 | 40.51 | 0.91 | 20.8 | 22.59 | 0.92 |
| T9 | 71.2 | 72.21 | 0.99 | 64.2 | 68.05 | 0.94 | 56.2 | 59.38 | 0.95 |
| T10 | 68.8 | 70.46 | 0.98 | 62.8 | 65.85 | 0.95 | 46.4 | 50.38 | 0.92 |
| T11 | 78.2 | 79.84 | 0.98 | 78.2 | 80.32 | 0.97 | 62.4 | 68.63 | 0.91 |
| T12 | 77.4 | 78.76 | 0.98 | 75.4 | 78.53 | 0.96 | 61.8 | 67.05 | 0.92 |
| T13 | 76.6 | 77.94 | 0.98 | 74.2 | 77.71 | 0.95 | 60.4 | 66.39 | 0.91 |
| T14 | 87.8 | 89.95 | 0.98 | 85.6 | 88.03 | 0.97 | 75.4 | 82.36 | 0.92 |
| T15 | 87.6 | 89.32 | 0.98 | 84.4 | 87.20 | 0.97 | 71.2 | 78.45 | 0.91 |
| T16 | 71.2 | 72.38 | 0.98 | 65.4 | 68.42 | 0.96 | 52.4 | 60.15 | 0.87 |
| T17 | 36.2 | | | 42.8 | | | 24.6 | | |
| T18 | 32.8 | | | 37.6 | | | 20.8 | | |
| T19 | 30.2 | | | 35.2 | | | 19.2 | | |
| T20 | 68.2 | | | 65.2 | | | 57.6 | | |
| T21 | 66.2 | | | 62.8 | | | 48.2 | | |
| T22 | 12.6 | | | 8.2 | | | 4.2 | | |
| T23 | 68.4 | | | 65.6 | | | 58.4 | | |
| T24 | 0.0 | | | 0.0 | | | 0.0 | | |

TABLE 14b
Field bio efficacy against brown plant hopper
(BPH) and paddy tiller count and grain yield.

| | % BPH Control | | | | |
|---|---|---|---|---|---|
| | 100 DATP | | | Productive | |
| Treatment | Obs. | Cal. | Colby's | Tillers at | Grain Yield |
| Number | Value | Value | ratio | 100 DATP | (kg/plot) |
| T1 | 82.6 | 73.85 | 1.12 | 45.8 | 14.30 |
| T2 | 76.2 | 69.52 | 1.10 | 44.6 | 13.80 |
| T3 | 84.8 | 76.94 | 1.10 | 43.6 | 14.20 |
| T4 | 81.4 | 71.22 | 1.14 | 46.2 | 14.60 |
| T5 | 62.8 | 46.15 | 1.36 | 44.2 | 13.50 |
| T6 | 62.4 | 67.15 | 0.93 | 34.6 | 11.10 |
| T7 | 56.8 | 61.70 | 0.92 | 33.8 | 10.60 |
| T8 | 67.2 | 71.03 | 0.95 | 33.4 | 10.80 |
| T9 | 60.4 | 63.84 | 0.95 | 34.2 | 11.50 |
| T10 | 26.8 | 32.35 | 0.83 | 32.4 | 10.50 |
| T11 | 70.4 | 73.10 | 0.96 | 37.8 | 12.30 |
| T12 | 65.4 | 68.64 | 0.95 | 36.4 | 11.90 |
| T13 | 72.8 | 76.28 | 0.95 | 35.6 | 12.00 |
| T14 | 67.4 | 70.39 | 0.96 | 38.6 | 12.60 |
| T15 | 40.6 | 44.60 | 0.91 | 36.4 | 11.60 |
| T16 | 20.4 | 22.63 | 0.90 | 37.6 | 11.30 |
| T17 | 66.2 | | | 31.2 | 8.8 |
| T18 | 60.6 | | | 30.6 | 8.0 |
| T19 | 70.2 | | | 29.8 | 8.6 |
| T20 | 62.8 | | | 31.8 | 9.4 |
| T21 | 30.4 | | | 28.6 | 8.2 |
| T22 | 2.8 | | | 30.6 | 7.4 |
| T23 | 20.4 | | | 32.4 | 9.1 |
| T24 | 0.0 | | | 22.4 | 5.8 |

The granular formulation of all innovative ready mixtures (T1 to T5) shows also shows synergistic efficacy against key lepidopteran pests like leaf folder and stem borer and key hemipteran pests like brown plant hopper and also provides residual control (long duration of control). The granular formulation of all innovative ready mixtures (T1 to T5) shows also produces higher number of productive tillers and grain yield per plot as compared to all prior arts treatments (T6 to T16).

Experiment 7: Control of Insect-Pests of Paddy/Rice Crop

Crop: Paddy

Location: Gorakhpur, Uttar Pradesh

Plot size: 30 sq. mt. (6 m×5 m)

Number of Treatments: 20

Application Time: First spray-30 DATP, Second spray-60 DATP (Days after transplanting)

Method of Application: Foliar spray with knap sack sprayer.

Water volume: 400 & 500 liter per hectare

Agronomic Practices: All agronomic practices followed as per the crop requirement.

Observation Methods:

Leaf folder (Cnaphalocrocis medinalios) & stem borer (Scirpophaga incertulas) control: The infestation by stem borer and leaf folder was observed as dead heart (DH), white ear (WE), and leaf folder damaged leaves (LFD) appeared during vegetative stage and reproductive stages from 10 hills per plot. The observation on percent dead hearts at vegetative stage and the leaf damage as percent damaged leaves were recorded at 45 DATP and white ear was recorded before harvest of the crop. The leaf was considered to be damaged by the leaf folder if at least ⅓ of its area showed symptoms.

The percentage of DH, WE and LFD in each individual plot was calculated by using formulae described below:

$$\% Dead Heart ( DH \% ) = \frac{Number of dead heart per 10 hills}{Total number of tillers per 10 hills} \times 100$$

$$\% Stem borer control ( Dead Heart symptoms ) = 100 - \frac{Dead heart ( \% ) in treatment }{Dead heart ( \% ) in untreated} \times 100$$

$$White ear ( WE \% ) = \frac{Number of white ear per 10 hills}{Total number of bearing panicle per 10 hills} \times 100$$

$$\% Stem borer control ( White ear symptoms ) = 100 - \frac{White ear ( \% ) in treatment }{White ear ( \% ) in untreated} \times 100$$

$$Leaf folder damage ( LFD \% ) = \frac{Number of infested leaves per 10 hills}{Total number of leaves per 10 hills} \times 100$$

$$Leaf folder control ( \% ) = 100 - \frac{Leaf folder damage ( \% ) in treatment }{Leaf folder damage ( \% ) in untreated} \times 100$$

% Brown Plant Hopper (BPH), Nilaparvata lugens control:

Count the number of hoppers (BPH) per hill, observe 10 hills per plot at 75 DATP.

Calculate the % Hoppers (BPH) control (observed value) as below formula.

$$\% Hoppers ( BPH ) control = 100 - \frac{Number of live BPH in treated plot}{Number of live BPH in untreated plot} \times 100$$

The calculated value of % control was used to worked out the Colby's formula to judge the synergism.

Tiller count: Count the number of productive tillers per hill. Record observations from 10 hills per plot at the time of harvesting.

TABLE 15
Treatment details for field bio-efficacy
against insect-pests infesting paddy crop

| Treatment | |
|---|---|
| Number | Treatment composition with application rate per hectare |
| T1 | Cyantraniliprole 10% + Salicylic acid 4% + |
| | Triflumezopyrim 4% OD-500 ml (ready mix) |
| T2 | Cyantraniliprole 5% + Salicylic acid 2% + Flupyrimin |
| | 10% OD-1000 ml (ready mix) |
| T3 | Cyantraniliprole 10% + Salicylic acid 4% + Pymetrozine |
| | 25% WG-500 g (ready mix) |
| T4 | Cyantraniliprole 5% + Salicylic acid 2% + Benzpyrimoxan |
| | 6% OD-1000 ml (ready mix) |
| T5 | Triflumezopyrim 10.6% SC-188.7 ml + Salicylic acid 4% |
| | WP-500 ml (prior art) |
| T6 | Flupyrimin 10% SC-1000 ml + Salicylic acid 4% WP-500 ml |
| | (prior art) |
| T7 | Pymetrozine 50% WG-250 g + Salicylic acid 4% WP-500 ml |
| | (prior art) |
| T8 | Benzpyrimoxan 10% SC-600 ml + Salicylic acid 4% WP-500 |
| | ml (prior art) |
| T9 | Triflumezopyrim 10.6% SC-188.7 ml + Cyantraniliprole |
| | 10.26% OD-500 ml (prior art) |
| T10 | Flupyrimin 10% SC-1000 ml + Cyantraniliprole 10.26% |
| | OD-500 ml (prior art) |
| T11 | Pymetrozine 50% WG-250 g + Cyantraniliprole 10.26% |
| | OD-500 ml (prior art) |
| T12 | Benzpyrimoxan 10% SC-600 ml + Cyantraniliprole 10.26% |
| | OD-500 ml (prior art) |
| T13 | Salicylic acid 4% WP-500 ml + Cyantraniliprole 10.26% |
| | OD-500 ml (prior art) |
| T14 | Triflumezopyrim 10.6% SC-188.7 ml |
| T15 | Flupyrimin 10% SC-1000 ml |
| T16 | Pymetrozine 50% WG-250 g |
| T17 | Benzpyrimoxan 10% SC-600 ml |
| T18 | Salicylic acid 4% WP-500 ml |
| T19 | Cyantraniliprole 10.26% OD-500 ml |
| T20 | UTC (Untreated Check) |

TABLE 16a
Field bio-efficacy against insect-pests infesting paddy crop

| | | | | % Stem borer control | | | |
|---|---|---|---|---|---|---|---|
| | | | | (Dead heart symptoms) | | | |
| | % Leaf folder control | | | 45 DATP | | | |
| Treatment | 45 DATP | | | Obs. | Cal. | Colby's | Synergism |
| Number | Obs. Value | Cal. Value | Colby's ratio | Value | Value | ratio | (Y/N) |
| T1 | 98.4 | 73.71 | 1.33 | 92.6 | 76.44 | 1.21 | Y |
| T2 | 100.0 | 88.12 | 1.13 | 100.0 | 88.47 | 1.13 | Y |
| T3 | 95.6 | 72.93 | 1.31 | 92.0 | 75.83 | 1.21 | Y |
| T4 | 93.6 | 73.29 | 1.28 | 91.4 | 75.23 | 1.21 | Y |
| T5 | 92.8 | 16.81 | 5.52 | 19.6 | 20.41 | 0.96 | N |
| T6 | 60.6 | 62.41 | 0.97 | 60.2 | 61.04 | 0.99 | N |
| T7 | 13.6 | 14.33 | 0.95 | 16.8 | 18.36 | 0.92 | N |
| T8 | 14.2 | 15.48 | 0.92 | 16.2 | 16.31 | 0.99 | N |
| T9 | 70.8 | 72.44 | 0.98 | 73.8 | 74.72 | 0.99 | N |
| T10 | 87.0 | 87.55 | 0.99 | 86.2 | 87.63 | 0.98 | N |
| T11 | 70.4 | 71.62 | 0.98 | 72.4 | 74.07 | 0.98 | N |
| T12 | 70.6 | 72.00 | 0.98 | 71.6 | 73.42 | 0.98 | N |
| T13 | 67.8 | 69.85 | 0.97 | 70.6 | 72.41 | 0.97 | N |
| T14 | 12.8 | | | 14.6 | | | |
| T15 | 60.6 | | | 58.2 | | | |
| T16 | 10.2 | | | 12.4 | | | |
| T17 | 11.4 | | | 10.2 | | | |
| T18 | 4.6 | | | 6.8 | | | |
| T19 | 68.4 | | | 70.4 | | | |
| T20 | 0.0 | | | 0.0 | | | |

TABLE 16b
Field bio-efficacy against insect-pests infesting paddy crop

| | | | | % Stem borer control | | | |
|---|---|---|---|---|---|---|---|
| | | | | (White ear symptoms) | | | Number of |
| | % BPH control | | | Before harvest | | | productive |
| Treatment | 75 DATP | | | Obs. | Cal. | Colby's | tillers before |
| Number | Obs. Value | Cal. Value | Colby's ratio | Value | Value | ratio | harvest |
| T1 | 98.6 | 87.26 | 1.13 | 90.2 | 65.25 | 1.38 | 46.60 |
| T2 | 95.4 | 79.60 | 1.20 | 97.6 | 84.29 | 1.16 | 47.60 |
| T3 | 90.2 | 77.83 | 1.16 | 89.6 | 64.49 | 1.39 | 45.80 |
| T4 | 88.2 | 76.65 | 1.15 | 90.2 | 64.26 | 1.40 | 45.20 |
| T5 | 80.2 | 81.60 | 0.98 | 10.2 | 12.25 | 0.83 | 31.60 |
| T6 | 68.4 | 70.52 | 0.97 | 56.8 | 60.34 | 0.94 | 32.20 |
| T7 | 65.8 | 67.96 | 0.97 | 8.4 | 10.33 | 0.81 | 30.60 |
| T8 | 64.8 | 66.26 | 0.98 | 6.8 | 9.76 | 0.70 | 29.80 |
| T9 | 83.4 | 85.05 | 0.98 | 60.2 | 63.73 | 0.94 | 39.60 |
| T10 | 75.4 | 76.06 | 0.99 | 80.4 | 83.61 | 0.96 | 38.60 |
| T11 | 71.2 | 73.98 | 0.96 | 58.8 | 62.93 | 0.93 | 38.20 |
| T12 | 70.8 | 72.60 | 0.98 | 60.2 | 62.70 | 0.96 | 37.60 |
| T13 | 38.8 | 41.04 | 0.95 | 60.6 | 62.06 | 0.98 | 34.20 |
| T14 | 78.4 | | | 8.4 | | | 28.40 |
| T15 | 65.4 | | | 58.6 | | | 29.20 |
| T16 | 62.4 | | | 6.4 | | | 27.40 |
| T17 | 60.4 | | | 5.8 | | | 26.40 |
| T18 | 14.8 | | | 4.2 | | | 23.80 |
| T19 | 30.8 | | | 60.4 | | | 31.40 |
| T20 | 0.0 | | | 0.0 | | | 19.20 |

All innovative ready-mix combinations (sr.no. 1 to 4) shows synergism in efficacy against leaf folder, stem borer and brown plant hopper and also produces higher number of productive tillers in comparison to all prior art treatments (sr.no.5 to 13).

Experiment 8: Control of Fall Armyworm, Spodoptera frugiperda in Maize (Zea mays)

Crop & Variety: Maize

Location: Balasinor, Gujarat

Plot size: 20 sq. mt. (5 m×4 m)

Number of Treatments: 30

Application Time: 20 DAS (Days after sowing) as soon as fall armyworm infestation noticed.

Method of Application: Foliar spray with knap sack sprayer

Water volume: 400 liter per hectare.

Agronomic Practices: All agronomic practices followed as per the crop requirement.

Observation Methods:

% Fall armyworm (larval) control: Count the number of larvae per plant. Record the observation from 10 plants per plot on 7th day after application. Calculate % larval control.

$$\% Larval control = 100 - \frac{Number of live larva in treated plot}{Number of live larva in untreated control} \times 100$$

Plant damage: Count the number of healthy and damaged plants per meter row length on 15th days after application. Record the observations from 10 spots per plot. Calculate % plant damage. Also record the plant height (cm) of 10 plants per plot.

TABLE 17
Treatment details for field bio-efficacy
against fall army worm infesting maize.

| Treatment | |
|---|---|
| Number | Treatment composition with application rate per hectare |
| T1 | Chlorantraniliprole 5% + Brassinolide 0.05% + |
| | Methoxyfenozide 20% SC-500 ml (ready-mix) |
| T2 | Cyantraniliprole 5% + Brassinolide 0.025% + |
| | Methoxyfenozide 10% OD-1000 ml (ready-mix) |
| T3 | Tetraniliprole 5% + Brassinolide 0.025% + Methoxyfenozide |
| | 10% OD-1000 ml (ready-mix) |
| T4 | Broflanilide 1.8% + Brassinolide 0.05% + Methoxyfenozide |
| | 20% OD-500 ml (ready-mix) |
| T5 | Chlorantraniliprole 5% + Brassinolide 0.05% + Emamectin |
| | benzoate 1.5% ZC-500 ml (ready-mix) |
| T6 | Cyantraniliprole 10% + Brassinolide 0.05% + Emamectin |
| | benzoate 1.5% ZC-500 ml (ready-mix) |
| T7 | Tetraniliprole 10% + Brassinolide 0.05% + Emamectin |
| | benzoate 1.5% ZC-500 ml (ready-mix) |
| T8 | Broflanilide 1.8% + Brassinolide 0.05% + Emamectin |
| | benzoate 1.5% ZC-500 ml (ready-mix) |
| T9 | Chlorantraniliprole 18.5% SC-125 ml + Brassinolide 0.2% |
| | SC-125 ml (prior art) |
| T10 | Cyantraniliprole 10.26% OD-500 ml + Brassinolide 0.2% |
| | SC-125 ml (prior art) |
| T11 | Tetraniliprole 20% SC-250 ml + Brassinolide 0.2% SC-125 |
| | ml (prior art) |
| T12 | Broflanilide 30% SC-30 ml + Brassinolide 0.2% SC-125 ml |
| | (prior art) |
| T13 | Chlorantraniliprole 18.5% SC-125 ml + Methoxyfenozide |
| | 21.8% SC-416.7 ml (prior art) |
| T14 | Cyantraniliprole 10.26% OD-500 ml + Methoxyfenozide |
| | 21.8% SC-416.7 ml (prior art) |
| T15 | Tetraniliprole 20% SC-250 ml + Methoxyfenozide 21.8% |
| | SC-416.7 ml (prior art) |
| T16 | Broflanilide 30% SC-30 ml + Methoxyfenozide 21.8% |
| | SC-416.7 ml (prior art) |
| T17 | Chlorantraniliprole 18.5% SC-125 ml + Emamectin benzoate |
| | 5% SG-150 g (prior art) |
| T18 | Cyantraniliprole 10.26% OD-500 ml + Emamectin benzoate |
| | 5% SG-150 g (prior art) |
| T19 | Tetraniliprole 20% SC-250 ml + Emamectin benzoate 5% |
| | SG-150 g (prior art) |
| T20 | Broflanilide 30% SC-30 ml + Emamectin benzoate 5% |
| | SG-150 g (prior art) |
| T21 | Brassinolide 0.2% SC-125 ml + Methoxyfenozide 21.8% |
| | SC-416.7 ml (prior art) |
| T22 | Brassinolide 0.2% SC-125 ml + Emamectin benzoate 5% |
| | SG-150 g (prior art) |
| T23 | Chlorantraniliprole 18.5% SC-125 ml |
| T24 | Cyantraniliprole 10.26% OD-500 ml |
| T25 | Tetraniliprole 20% SC-250 ml |
| T26 | Broflanilide 30% SC-30 ml |
| T27 | Brassinolide 0.2% SC-125 ml |
| T28 | Methoxyfenozide 21.8% (24% w/v) SC-416.7 ml |
| T29 | Emamectin benzoate 5% SG-150 g |
| T30 | UTC (Untreated Check) |

TABLE 18
Synergistic control of fall armyworm in maize

| | | | | | % Plant damage | Plant |
|---|---|---|---|---|---|---|
| Treatment | % FAW larval control | | | Synergism | by FAW at 15 | height |
| Number | Obs. Value | Cal. Value | Colby's ratio | (Y/N) | DAA | (cm) |
| T1 | 98.6 | 86.62 | 1.14 | Y | 0.82 | 132.3 |
| T2 | 97.2 | 86.95 | 1.12 | Y | 0.74 | 134.1 |
| T3 | 99.2 | 86.79 | 1.14 | Y | 0.68 | 131.2 |
| T4 | 98.4 | 86.21 | 1.14 | Y | 0.88 | 134.7 |
| T5 | 96.8 | 87.03 | 1.11 | Y | 0.72 | 133.6 |
| T6 | 97.4 | 87.35 | 1.12 | Y | 0.66 | 135.7 |
| T7 | 98.2 | 87.19 | 1.13 | Y | 0.80 | 132.6 |
| T8 | 96.4 | 86.63 | 1.11 | Y | 0.76 | 130.2 |
| T9 | 69.4 | 70.79 | 0.98 | N | 6.82 | 126.2 |
| T10 | 68.8 | 71.51 | 0.96 | N | 7.24 | 123.7 |
| T11 | 69.4 | 71.15 | 0.98 | N | 8.26 | 125.1 |
| T12 | 69.2 | 69.89 | 0.99 | N | 7.20 | 124.5 |
| T13 | 84.6 | 85.07 | 0.99 | N | 4.56 | 124.3 |
| T14 | 83.6 | 85.44 | 0.98 | N | 5.82 | 125.6 |
| T15 | 84.6 | 85.25 | 0.99 | N | 3.98 | 124.2 |
| T16 | 83.4 | 84.61 | 0.99 | N | 6.12 | 122.1 |
| T17 | 83.8 | 85.53 | 0.98 | N | 4.86 | 127.9 |
| T18 | 84.2 | 85.88 | 0.98 | N | 5.62 | 126.7 |
| T19 | 84.8 | 85.70 | 0.99 | N | 6.20 | 128.3 |
| T20 | 83.6 | 85.08 | 0.98 | N | 5.28 | 127.5 |
| T21 | 57.6 | 58.96 | 0.98 | N | 11.26 | 128.2 |
| T22 | 58.8 | 60.22 | 0.98 | N | 12.42 | 127.7 |
| T23 | 67.4 | | | | 11.26 | 120.3 |
| T24 | 68.2 | | | | 12.42 | 121.0 |
| T25 | 67.8 | | | | 10.78 | 118.2 |
| T26 | 66.4 | | | | 11.24 | 119.5 |
| T27 | 10.4 | | | | 24.24 | 117.3 |
| T28 | 54.2 | | | | 11.26 | 115.2 |
| T29 | 55.6 | | | | 12.42 | 116.0 |
| T30 | 0.0 | | | | 30.26 | 112.5 |

The all-innovative ready-mix formulations (T1 to T8) shows synergistic efficacy against fall army worm and provides excellent residual control compared to prior art treatments (T9 to T22). The average plant height was observed higher in ready mix synergistic combinations compared to prior arts. The other visual observations like overall plant biomass, stem girth, leaf color, leaf blade width, number of leaves per plant were higher in synergistic ready-mix combinations.

Experiment 9: Control of Pigeon Pea/Red Gram (Cajanus Cajan) Pod Borer and Healthy Pods

Crop: Red gram

Location: Dabhoi, Gujarat

Plot size: 40 sq. mt. (10 m×4 m)

Number of Treatments: 30

Application Time: At pod development stage when high infestation of pod borer observed.

Method of Application: Foliar spray with knap sack sprayer

Water volume: 480 liter per hectare.

Agronomic Practices: All agronomic practices followed as per the crop requirement.

Observation Methods:

% Pod borer (Larval control): Count the number of larvae per plant. Record the observation from 10 plants per plot on 7th day after application. % Larval control method same as in experiment no.4. Apply Colby's formula to check synergism.

Pod count: Count the number of healthy pods per plant on 15 days after application.

TABLE 19
Treatment details for bio efficacy against pigeon pea pod borer

| Treatment | |
|---|---|
| Number | Treatment composition with application rate per hectare |
| T1 | Chlorantraniliprole 5% + Ortho silicic acid 4% + |
| | Dichloromezotiaz 4% WG-500 g (ready mix) |
| T2 | Cyantraniliprole 10% + Ortho silicic acid 4% + |
| | Dichloromezotiaz 4% WG-500 g (ready mix) |
| T3 | Tetraniliprole 10% + Ortho silicic acid 4% + |
| | Dichloromezotiaz 4% WG-500 g (ready mix) |
| T4 | Broflanilide 2% + Ortho silicic acid 4% + Dichloromezotiaz |
| | 4% WG-500 g (ready mix) |
| T5 | Chlorantraniliprole 2.5% + Ortho silicic acid 2% + |
| | Flupyrimin 10% SC-1000 ml (ready mix) |
| T6 | Cyantraniliprole 5% + Ortho silicic acid 2% + |
| | Flupyrimin 10% SC-1000 ml (ready mix) |
| T7 | Tetraniliprole 5% + Ortho silicic acid 2% + Flupyrimin 10% |
| | SC-1000 ml (ready mix) |
| T8 | Broflanilide 1% + Ortho silicic acid 2% + Flupyrimin 10% |
| | SC-1000 ml (ready mix) |
| T9 | Chlorantraniliprole 20% SC-125 ml + Ortho silicic acid 2% |
| | WP-1000 g (prior art) |
| T10 | Cyantraniliprole 10.26% OD-500 ml + Ortho silicic acid 2% |
| | WP-1000 g (prior art) |
| T11 | Tetraniliprole 20% SC-250 ml + Ortho silicic acid 2% |
| | WP-1000 g (prior art) |
| T12 | Broflanilide 30% SC-33.33 + Ortho silicic acid 2% WP-1000 |
| | g (prior art) |
| T13 | Chlorantraniliprole 20% SC-125 ml + Dichloromezotiaz 35% |
| | WG-57.14 g (prior art) |
| T14 | Cyantraniliprole 10.26% OD-500 ml + Dichloromezotiaz 35% |
| | WG-57.14 g (prior art) |
| T15 | Tetraniliprole 20% SC-250 ml + Dichloromezotiaz 35% |
| | WG-57.14 g (prior art) |
| T16 | Broflanilide 30% SC-33.33 ml + Dichloromezotiaz 35% |
| | WG-57.14 g (prior art) |
| T17 | Chlorantraniliprole 20% SC-125 ml + Flupyrimin 10% |
| | SC-200 ml (prior art) |
| T18 | Cyantraniliprole 10.26% OD-500 ml + Flupyrimin 10% |
| | SC-200 ml (prior art) |
| T19 | Tetraniliprole 20% SC-250 ml + Flupyrimin 10% SC-200 ml |
| | (prior art) |
| T20 | Broflanilide 30% SC-33.33 ml + Flupyrimin 10% SC-200 ml |
| | (prior art) |
| T21 | Ortho silicic acid 2% WP-1000 g + Dichloromezotiaz 35% |
| | WG-57.14 g (prior art) |
| T22 | Ortho silicic acid 2% WP-1000 g + Flupyrimin 10% SC-200 |
| | ml (prior art) |
| T23 | Chlorantraniliprole 20% SC-125 ml |
| T24 | Cyantraniliprole 10.26% OD-500 ml |
| T25 | Tetraniliprole 20% SC-250 ml |
| T26 | Broflanilide 30% SC-33.33 ml |
| T27 | Ortho silicic acid 2% WP-1000 g |
| T28 | Dichloromezotiaz 35% WG-57.14 g |
| T29 | Flupyrimin 10% SC-200 ml |
| T30 | UTC (Untreated Check) |

TABLE 20
Pod borer (Helicoverpa armigera)
larval control and healthy pod count.

| | % Pod borer larval control | | | | Average number |
|---|---|---|---|---|---|
| Treatment | Obs. | Cal. | Colby's | Synergism | of healthy pods |
| Number | Value | Value | ratio | (Y/N) | per plant |
| T1 | 99.2 | 89.54 | 1.11 | Y | 174.2 |
| T2 | 100.0 | 89.80 | 1.11 | Y | 188.6 |
| T3 | 98.8 | 89.67 | 1.10 | Y | 178.4 |
| T4 | 100.0 | 89.22 | 1.12 | Y | 180.2 |
| T5 | 100.0 | 89.95 | 1.11 | Y | 168.4 |
| T6 | 99.0 | 90.20 | 1.10 | Y | 164.8 |
| T7 | 98.4 | 90.08 | 1.09 | Y | 172.4 |
| T8 | 99.4 | 89.64 | 1.11 | Y | 170.6 |
| T9 | 69.4 | 70.79 | 0.98 | N | 128.4 |
| T10 | 68.8 | 71.51 | 0.96 | N | 138.6 |
| T11 | 69.4 | 71.15 | 0.98 | N | 122.4 |
| T12 | 69.2 | 69.89 | 0.99 | N | 130.6 |
| T13 | 87.8 | 88.33 | 0.99 | N | 114.6 |
| T14 | 87.6 | 88.62 | 0.99 | N | 118.2 |
| T15 | 86.6 | 88.47 | 0.98 | N | 110.6 |
| T16 | 86.4 | 87.97 | 0.98 | N | 113.6 |
| T17 | 87.6 | 88.79 | 0.99 | N | 115.2 |
| T18 | 88.0 | 89.06 | 0.99 | N | 118.4 |
| T19 | 86.6 | 88.92 | 0.97 | N | 120.6 |
| T20 | 87.2 | 88.44 | 0.99 | N | 112.4 |
| T21 | 66.8 | 67.92 | 0.98 | N | 116.8 |
| T22 | 68.2 | 69.18 | 0.99 | N | 112.6 |
| T23 | 67.4 | | | | 112.6 |
| T24 | 68.2 | | | | 120.2 |
| T25 | 67.8 | | | | 108.6 |
| T26 | 66.4 | | | | 115.4 |
| T27 | 10.4 | | | | 90.6 |
| T28 | 64.2 | | | | 108.4 |
| T29 | 65.6 | | | | 100.2 |
| T30 | 0.0 | | | | 70.6 |

The wettable granular (WG) formulation of all innovative ready-mix combinations (T1 to T8) provides synergistic larval control of pigeon pea pod borer and also produces the higher average number of healthy pods per plant compared to all prior art treatments. All innovative ready-mix combinations (T1 to T8) also show a greater number of flowers, a greater number of branches, excellent plant growth and vigor as compare to prior art treatments (T9 to T22).

Experiment 10: Control of Sucking Pests of Cotton

Crop: Cotton,

Location: Baroda, Gujarat

Treatments: 40

Plot size: 30 sq.m

Spacing: 120 cm×60 cm

Time of Application: As soon as sucking pests reached 5-10 insects per leaf

Method of Application: Foliar spray with knapsack sprayer

Water volume: 400 liter/hectare

Agronomic Practices: All agronomic practices followed as per the crop requirement.

Observation Methods:

Sucking pests (Thrips, Thrips tabaci and Whitefly Bemisia tabaci) control (%): Count the number of insects per leaf. Observed 3 leaves per plant and 5 plants per plot.

Calculate

% insect control by given formula.

$$\% Insect control = 100 - \frac{Number of live insects in treatment}{Number of live insects in untreated} \times 100$$

% Insect control data used to check the synergism by applying Colby's formula given above.

Fruiting bodies count: Count the number of fruiting bodies (square, flowers and balls) per plant. Record the observations from 5 plants per plot at 15 days after spray.

TABLE 21
Treatment details for field bio efficacy
against sucking pests in cotton

| Treatment | |
|---|---|
| Number | Treatment details with application Rate (ml or g per Hectare) |
| T1 | Cyantraniliprole 5% + Brassinolide 0.02% + Diafenthiuron |
| | 20% OD-1000 ml (ready-mix) |
| T2 | Cyantraniliprole 5% + Brassinolide 0.02% + Pyriproxyfen |
| | 5% SE-1000 ml (ready-mix) |
| T3 | Cyantraniliprole 10% + Brassinolide 0.04% + Flonicamid |
| | 10% WG-500 g (ready-mix) |
| T4 | Cyantraniliprole 5% + Brassinolide 0.02% + Tolfenpyrad |
| | 10% OD-1000 ml (ready-mix) |
| T5 | Cyantraniliprole 10% + Brassinolide 0.04% + Pymetrozine |
| | 20% WG-500 g (ready-mix) |
| T6 | Cyantraniliprole 5% + Brassinolide 0.02% + Spiromesifen |
| | 12% OD-1000 ml (ready-mix) |
| T7 | Cyantraniliprole 5% + Brassinolide 0.02% + Afidopyropen |
| | 4% SC-1000 ml (ready-mix) |
| T8 | Cyantraniliprole 10% + Brassinolide 0.04% + Pyrifluquinazon |
| | 10% OD-500 ml (ready-mix) |
| T9 | Cyantraniliprole 10% + Brassinolide 0.04% + Dimpropyridaz |
| | 5% SC-500 ml (ready-mix) |
| T10 | Brassinolide 0.04% L-500 ml + Diafenthiuron 50% WP-400 g |
| | (prior art) |
| T11 | Brassinolide 0.04% L-500 ml + Pyriproxyfen 10% EC-500 ml |
| | (prior art) |
| T12 | Brassinolide 0.04% L-500 ml + Flonicamid 50% WG-100 g |
| | (prior art) |
| T13 | Brassinolide 0.04% L-500 ml + Tolfenpyrad 15% EC-500 ml |
| | (prior art) |
| T14 | Brassinolide 0.04% L-500 ml + Pymetrozine 50% WG-200 g |
| | (prior art) |
| T15 | Brassinolide 0.04% L-500 ml + Spiromesifen 22.90% |
| | SC-500 ml (prior art) |
| T16 | Brassinolide 0.04% L-500 ml + Afidopyropen 5% DC-800 |
| | ml (prior art) |
| T17 | Brassinolide 0.04% L-500 ml + Pyrifluquinazon 10% |
| | SC-500 ml (prior art) |
| T18 | Brassinolide 0.04% L-500 ml + Dimpropyridaz 12% |
| | SC-208.33 ml (prior art) |
| T19 | Cyantraniliprole 10.26% OD-500 ml + Diafenthiuron 50% |
| | WP-400 g (prior art) |
| T20 | Cyantraniliprole 10.26% OD-500 ml + Pyriproxyfen 10% |
| | EC-500 ml (prior art) |
| T21 | Cyantraniliprole 10.26% OD-500 ml + Flonicamid 50% |
| | WG-100 g (prior art) |
| T22 | Cyantraniliprole 10.26% OD-500 ml + Tolfenpyrad 15% |
| | EC-500 ml (prior art) |
| T23 | Cyantraniliprole 10.26% OD-500 ml + Pymetrozine 50% |
| | WG-200 g (prior art) |
| T24 | Cyantraniliprole 10.26% OD-500 ml + Spiromesifen 22.90% |
| | SC-500 ml (prior art) |
| T25 | Cyantraniliprole 10.26% OD-500 ml + Afidopyropen 5% |
| | DC-800 ml (prior art) |
| T26 | Cyantraniliprole 10.26% OD-500 ml + Pyrifluquinazon 10% |
| | SC-500 ml (prior art) |
| T27 | Cyantraniliprole 10.26% OD-500 ml + Dimpropyridaz 12% |
| | SC-208.33 ml (prior art) |
| T28 | Cyantraniliprole 10.26% OD-500 ml + Brassinolide 0.04% |
| | L-500 ml (prior art) |
| T29 | Diafenthiuron 50% WP-400 g |
| T30 | Pyriproxyfen 10% EC-500 ml |
| T31 | Flonicamid 50% WG-100 g |
| T32 | Tolfenpyrad 15% EC-500 ml |
| T33 | Pymetrozine 50% WG-200 g |
| T34 | Spiromesifen 22.90% SC-500 ml |
| T35 | Afidopyropen 5% DC-800 ml |
| T36 | Pyrifluquinazon 10% SC-500 ml |
| T37 | Dimpropyridaz 12% SC-208.33 ml |
| T38 | Brassinolide 0.04% L-500 ml |
| T39 | Cyantraniliprole 10.26% OD-500 ml |
| T40 | UTC (Untreated Check) |

All prior art treatment are on farm tank mixing.

TABLE 22
Field bio efficacy of innovative ready-mix combinations against sucking pests
of cotton

| | % Whitefly control at | | | | | | | |
|---|---|---|---|---|---|---|---|---|
| | 5 DAA | | | % Thrips control at 5 DAA | | | | Average |
| | | | Colby/s | | | Colby/s | | number of |
| Treatment | Obs. | Cal. | Ratio | Obs. | Cal. | Ratio | Synergism | fruiting |
| Number | Value | Value | O/E | Value | Value | O/E | (Y/N) | bodies/plants |
| T1 | 98.6 | 87.92 | 1.12 | 98.2 | 87.62 | 1.12 | Y | 102.6 |
| T2 | 97.4 | 87.06 | 1.12 | 97.6 | 87.09 | 1.12 | Y | 108.4 |
| T3 | 99.2 | 87.56 | 1.13 | 96.4 | 87.99 | 1.10 | Y | 100.4 |
| T4 | 97.4 | 87.63 | 1.11 | 96.4 | 87.69 | 1.10 | Y | 105.6 |
| T5 | 98.6 | 86.56 | 1.14 | 97.4 | 86.94 | 1.12 | Y | 99.8 |
| T6 | 97.2 | 87.06 | 1.12 | 98.4 | 87.46 | 1.13 | Y | 102.8 |
| T7 | 96.4 | 86.49 | 1.11 | 97.6 | 87.24 | 1.12 | Y | 101.4 |
| T8 | 97.2 | 86.78 | 1.12 | 96.6 | 87.54 | 1.10 | Y | 98.6 |
| T9 | 98.2 | 86.92 | 1.13 | 97.8 | 87.69 | 1.12 | Y | 106.6 |
| T10 | 67.8 | 69.65 | 0.97 | 69.4 | 70.09 | 0.99 | N | 56.4 |
| T11 | 66.6 | 67.49 | 0.99 | 66.8 | 68.81 | 0.97 | N | 55.2 |
| T12 | 68.4 | 68.75 | 0.99 | 69.4 | 71.00 | 0.98 | N | 57.4 |
| T13 | 67.6 | 68.93 | 0.98 | 69.2 | 70.27 | 0.98 | N | 58.2 |
| T14 | 65.2 | 66.24 | 0.98 | 67.4 | 68.44 | 0.98 | N | 52.6 |
| T15 | 66.8 | 67.49 | 0.99 | 68.2 | 69.72 | 0.98 | N | 58.8 |
| T16 | 65.4 | 66.06 | 0.99 | 68.8 | 69.17 | 0.99 | N | 56.4 |
| T17 | 66.4 | 66.77 | 0.99 | 68.8 | 69.90 | 0.98 | N | 58.2 |
| T18 | 66.4 | 67.13 | 0.99 | 69.2 | 70.27 | 0.98 | N | 59.4 |
| T19 | 84.8 | 86.55 | 0.98 | 84.8 | 86.42 | 0.98 | N | 68.2 |
| T20 | 83.4 | 85.59 | 0.97 | 83.4 | 85.84 | 0.97 | N | 70.4 |
| T21 | 85.2 | 86.15 | 0.99 | 85.2 | 86.83 | 0.98 | N | 66.6 |
| T22 | 84.4 | 86.23 | 0.98 | 84.4 | 86.50 | 0.98 | N | 68.2 |
| T23 | 83.8 | 85.04 | 0.99 | 83.8 | 85.68 | 0.98 | N | 65.2 |
| T24 | 84.6 | 85.59 | 0.99 | 85.4 | 86.26 | 0.99 | N | 69.4 |
| T25 | 83.2 | 84.96 | 0.98 | 84.8 | 86.01 | 0.99 | N | 71.2 |
| T26 | 84.4 | 85.27 | 0.99 | 85.2 | 86.34 | 0.99 | N | 70.4 |
| T27 | 82.6 | 85.43 | 0.97 | 83.2 | 86.50 | 0.96 | N | 68.8 |
| T28 | 60.4 | 64.26 | 0.94 | 60.4 | 62.24 | 0.97 | N | 59.4 |
| T29 | 66.2 | | | 67.2 | | | | 46.2 |
| T30 | 63.8 | | | 65.8 | | | | 44.8 |
| T31 | 65.2 | | | 68.2 | | | | 46.2 |
| T32 | 65.4 | | | 67.4 | | | | 47.4 |
| T33 | 62.4 | | | 65.4 | | | | 43.6 |
| T34 | 63.8 | | | 66.8 | | | | 48.4 |
| T35 | 62.2 | | | 66.2 | | | | 45.6 |
| T36 | 63.0 | | | 67.0 | | | | 47.2 |
| T37 | 63.4 | | | 67.4 | | | | 48.2 |
| T38 | 10.2 | | | 8.8 | | | | 30.4 |
| T39 | 60.2 | | | 58.6 | | | | 51.4 |
| T40 | 0.0 | | | 0.0 | | | | 26.4 |

All innovative ready mix novel formulations (T1 to T9) shows synergism in terms of efficacy against sucking pests, whitefly and thrips and also produces higher number of fruiting bodies compared to all prior art treatments (T10 to T28).

Experiment 11: Control of Sucking Pests in Okra

Crop & Variety: Okra, JK-115

Location Anand, Gujarat

Treatments: 36

Plot size: 20 sq.m

Spacing: 100 cm×25 cm

Time of Application: At moderate infestation of jassid i.e., 10 to 20 insects per leaf

Method of Application: Foliar spray with knapsack sprayer

Water volume: 500 liter/hectare

Agronomic Practices: All agronomic practices followed as per the crop requirement.

Observation Methods:

Sucking Pests (Jassid, Amrasca biguttula biguttula) Control (%): Count the number of insects per leaf at 3, 7 and 14 days after application (DAA). Observed 3 leaves per plant and 5 plants per plot. Calculate % insect control by given formula.

$$\% Insect control = 100 - \frac{Number of live insects in treatment}{Number of live insects in untreated} \times 100$$

% Insect control data used to check the synergism by applying Colby's formula given above.

TABLE 23
Treatment details for bio efficacy
against sucking pests in Okra crop

| Treatment | |
|---|---|
| Number | Treatment details with application Rate (ml or g per Hectare) |
| T1 | Broflanilide 1.2% + Salicylic acid 2% + Diafenthiuron 25% |
| | SC-1000 ml (ready mix) |
| T2 | Broflanilide 1.2% + Salicylic acid 2% + Pyriproxyfen 5% |
| | SE-1000 ml (ready mix) |
| T3 | Broflanilide 6% + Salicylic acid 10% + Flonicamid 25% |
| | WG-200 WG (ready mix) |
| T4 | Broflanilide 2.4% + Salicylic acid 4% + Tolfenpyrad 15% |
| | OD-500 ml (ready mix) |
| T5 | Broflanilide 1.2% + Salicylic acid 2% + Spiromesifen 10% |
| | OD-1000 ml (ready mix) |
| T6 | Broflanilide 2.4% + Salicylic acid 4% + Spiropidion 10% |
| | WG-500 g (ready mix) |
| T7 | Broflanilide 2.4% + Salicylic acid 4% + Pyrifluquinazon 8% |
| | SC-500 ml (ready mix) |
| T8 | Broflanilide 2.4% + Salicylic acid 4% + Dimpropyridaz 5% |
| | SC-500 ml (ready mix) |
| T9 | Salicylic acid 4% WP-500 g + Diafenthiuron 50% WP-500 g |
| | (prior art) |
| T10 | Salicylic acid 4% WP-500 g + Pyriproxyfen 10% EC-500 ml |
| | (prior art) |
| T11 | Salicylic acid 4% WP-500 g + Flonicamid 50% WG-100 g |
| | (prior art) |
| T12 | Salicylic acid 4% WP-500 g + Tolfenpyrad 15% EC-500 ml |
| | (prior art) |
| T13 | Salicylic acid 4% WP-500 g + Spiromesifen 22.90% SC-416 |
| | ml (prior art) |
| T14 | Salicylic acid 4% WP-500 g + Spiropidion 50% WG-100 g |
| | (prior art) |
| T15 | Salicylic acid 4% WP-500 g + Pyrifluquinazon 10% SC-400 |
| | ml (prior art) |
| T16 | Salicylic acid 4% WP-500 g + Dimpropyridaz 12% |
| | SC-208.33 ml (prior art) |
| T17 | Broflanilide 30% SC-40 ml + Diafenthiuron 50% WP-500 g |
| | (prior art) |
| T18 | Broflanilide 30% SC-40 ml + Pyriproxyfen 10% EC-500 ml |
| | (prior art) |
| T19 | Broflanilide 30% SC-40 ml + Flonicamid 50% WG-100 g |
| | (prior art) |
| T20 | Broflanilide 30% SC-40 ml + Tolfenpyrad 15% EC-500 ml |
| | (prior art) |
| T21 | Broflanilide 30% SC-40 ml + Spiromesifen 22.90% SC-416 |
| | ml (prior art) |
| T22 | Broflanilide 30% SC-40 ml + Spiropidion 50% WG-100 g |
| | (prior art) |
| T23 | Broflanilide 30% SC-40 ml + Pyrifluquinazon 10% SC-400 |
| | ml (prior art) |
| T24 | Broflanilide 30% SC-40 ml + Dimpropyridaz 12% SC-208.33 |
| | ml (prior art) |
| T25 | Broflanilide 30% SC-40 ml + Salicylic acid 4% WP-500 g |
| | (prior art) |
| T26 | Diafenthiuron 50% WP-500 g |
| T27 | Pyriproxyfen 10% EC-500 ml |
| T28 | Flonicamid 50% WG-100 g |
| T29 | Tolfenpyrad 15% EC-500 ml |
| T30 | Spiromesifen 22.90% SC-416 ml |
| T31 | Spiropidion 50% WG-100 g |
| T32 | Pyrifluquinazon 10% SC-400 ml |
| T33 | Dimpropyridaz 12% SC-208.33 ml |
| T34 | Salicylic acid 4% WP-500 g |
| T35 | Broflanilide 30% SC-40 ml |
| T36 | UTC (Untreated Check) |

TABLE 24
Residual control of sucking pests of okra

| | % Jassid control at 3 DAA | | | | | |
|---|---|---|---|---|---|---|
| Treatment | Obs. | Cal. | Colby's | Synergism | | 14 |
| Number | Value | Value | ratio | (Y/N) | 7 DAA | DAA |
| T1 | 96.8 | 85.70 | 1.13 | Y | 78.6 | 54.2 |
| T2 | 97.2 | 85.91 | 1.13 | Y | 77.4 | 53.8 |
| T3 | 95.2 | 86.60 | 1.10 | Y | 79.2 | 51.2 |
| T4 | 94.8 | 86.46 | 1.10 | Y | 78.4 | 52.2 |
| T5 | 95.4 | 86.33 | 1.11 | Y | 76.8 | 53.4 |
| T6 | 96.2 | 85.98 | 1.12 | Y | 76.6 | 52.6 |
| T7 | 96.4 | 86.19 | 1.12 | Y | 80.4 | 54.2 |
| T8 | 95.8 | 87.09 | 1.10 | Y | 82.4 | 55.6 |
| T9 | 62.8 | 63.90 | 0.98 | N | 56.8 | 25.6 |
| T10 | 63.6 | 64.42 | 0.99 | N | 48.6 | 28.8 |
| T11 | 65.4 | 66.17 | 0.99 | N | 50.2 | 26.4 |
| T12 | 64.8 | 65.82 | 0.98 | N | 48.2 | 25.6 |
| T13 | 64.6 | 65.47 | 0.99 | N | 47.2 | 27.8 |
| T14 | 63.4 | 64.60 | 0.98 | N | 47.8 | 26.2 |
| T15 | 64.6 | 65.12 | 0.99 | N | 45.2 | 30 |
| T16 | 66.8 | 67.39 | 0.99 | N | 50.6 | 26 |
| T17 | 82.4 | 83.61 | 0.99 | N | 67.2 | 45.4 |
| T18 | 81.8 | 83.84 | 0.98 | N | 68.4 | 46.8 |
| T19 | 83.4 | 84.64 | 0.99 | N | 70.6 | 44.4 |
| T20 | 82.4 | 84.48 | 0.98 | N | 69.2 | 46.6 |
| T21 | 81.8 | 84.32 | 0.97 | N | 68.4 | 45.8 |
| T22 | 82.6 | 83.92 | 0.98 | N | 69.2 | 46.2 |
| T23 | 83.6 | 84.16 | 0.99 | N | 68.8 | 44.2 |
| T24 | 84.4 | 85.19 | 0.99 | N | 70.8 | 43.8 |
| T25 | 63.8 | 65.47 | 0.97 | N | 45.2 | 23.4 |
| T26 | 58.6 | | | | 46.8 | 29.6 |
| T27 | 59.2 | | | | 48.4 | 30.2 |
| T28 | 61.2 | | | | 50.4 | 27.6 |
| T29 | 60.8 | | | | 47.8 | 28.4 |
| T30 | 60.4 | | | | 47.6 | 29.4 |
| T31 | 59.4 | | | | 48.6 | 27.6 |
| T32 | 60.0 | | | | 46.6 | 31.6 |
| T33 | 62.6 | | | | 51.4 | 30.8 |
| T34 | 12.8 | | | | 6.4 | 0.6 |
| T35 | 60.4 | | | | 45.4 | 28.6 |
| T36 | 0.0 | | | | 0.0 | 0.0 |

All innovative ready-mix formulations (T1 to T8) shows synergism in efficacy against jassid control and provides excellent residual (duration of control) compared to all prior art treatments (T9 to T25).

Experiment 12: Control of Pigeon Pea/Red Gram (Cajanus Cajan) Pod Borer and Healthy Pods

Crop: Red gram

Location: Sinor, Gujarat

Plot size: 50 sq. mt.

Number of Treatments: 16

Application Time: At pod development stage when high infestation of pod borer observed.

Method of Application: Foliar spray with knap sack sprayer

Water volume: 420 liter per hectare.

Agronomic Practices: All agronomic practices followed as per the crop requirement.

Observation Methods: Same as given in Experiment no. 5

TABLE 25
Treatment details for bio efficacy against pigeon
pea pod borer (Helicoverpa armigera)

| Treatment | |
|---|---|
| Number | Treatment composition with application rate per hectare |
| T1 | Isocycloseram 5% + Ortho silicic acid 4% + |
| | Methoxyfenozide 20% SC-500 ml (ready mix) |
| T2 | Isocycloseram 10% + Ortho silicic acid 8% + Emamectin |
| | benzoate 3% SC-250 ml (ready mix) |
| T3 | Isocycloseram 5% + Ortho silicic acid 4% + Dichoromezotiaz |
| | 4% WG-500 g (ready mix) |
| T4 | Methoxyfenozide 21.8% SC-416.7 ml + Ortho silicic acid 2% |
| | WP-1000 g (prior art) |
| T5 | Emamectin benzoate 5% SG-150 g + Ortho silicic acid 2% |
| | WP-1000 g (prior art) |
| T6 | Dichloromezotiaz 35% WG-57.14 g + Ortho silicic acid 2% |
| | WP-1000 g (prior art) |
| T7 | Methoxyfenozide 21.8% SC-416.7 ml + Isocycloseram 10% |
| | DC-200 ml (prior art) |
| T8 | Emamectin benzoate 5% SG-150 g + Isocycloseram 10% |
| | DC-200 ml (prior art) |
| T9 | Dichloromezotiaz 35% WG-57.14 g + Isocycloseram 10% |
| | DC-200 ml (prior art) |
| T10 | Ortho silicic acid 2% WP-1000 g + Isocycloseram 10% |
| | DC-200 ml (prior art) |
| T11 | Methoxyfenozide 21.8% (24% w/v) SC-416.7 ml |
| T12 | Emamectin benzoate 5% SG-150 g |
| T13 | Dichloromezotiaz 35% WG-57.14 g |
| T14 | Ortho silicic acid 2% WP-1000 g |
| T15 | Isocycloseram 10% DC-200 ml |
| T16 | UTC (Untreated Check) |

TABLE 26
Bioefficacy against pigeon pea pod borer

| | % Pod borer larval control | | | | Average number |
|---|---|---|---|---|---|
| Treatment | Obs. | Cal. | Colby's | Synergism | of healthy Pods |
| Number | Value | Value | ratio | (Y/N) | per plant |
| T1 | 100.0 | 87.23 | 1.15 | Y | 136.2 |
| T2 | 100.0 | 85.26 | 1.17 | Y | 140.2 |
| T3 | 100.0 | 86.69 | 1.15 | Y | 138.6 |
| T4 | 64.2 | 65.86 | 0.97 | N | 115.6 |
| T5 | 58.8 | 60.59 | 0.97 | N | 113.2 |
| T6 | 62.4 | 64.41 | 0.97 | N | 117.4 |
| T7 | 83.4 | 85.94 | 0.97 | N | 124.6 |
| T8 | 80.8 | 83.77 | 0.96 | N | 123.2 |
| T9 | 82.4 | 85.34 | 0.97 | N | 122.8 |
| T10 | 63.2 | 66.04 | 0.96 | N | 118.6 |
| T11 | 62.4 | | | | 112.4 |
| T12 | 56.6 | | | | 109.6 |
| T13 | 60.8 | | | | 113.8 |
| T14 | 9.2 | | | | 98.6 |
| T15 | 62.6 | | | | 114.4 |
| T16 | 0.0 | | | | 82.8 |

The ready mix innovative formulations (T1, T2, T3) shows synergistic larval control of pod borer larval control and also yielded higher number of healthy pods per plant in comparison with all prior treatments (T4 to T10).

Experiment 13: Control of Brinjal, Solanum melongena Fruit and Shoot Borer (Leucinoides orbonalis)

Crop: Brinj al

Location: Padra, Gujarat

Plot size: 50 sq. mt.

Number of Treatments: 26

Application Time: As soon as fruit and shoot borer infestation observed (˜65 days after transplanting).

Method of Application: Foliar spray with knap sack sprayer

Water volume: 520 liter per hectare.

Agronomic Practices: All agronomic practices followed as per the crop requirement.

Observation Methods:

Fruit & Shoot borer control (%)—Count the number of healthy and damaged shoots per plant.

Record the observations from 10 plants per plot at 7 and 14 days after application (DAA).

Calculate % shoot damage. Then recalculate % Fruit and shoot borer control.

$$Shoot damage ( \% ) by Fruit \& Shoot borer = \frac{Damaged shoots}{Total number of shoots observed} \times 100$$

$$\% Fruit \& Shoot borer ( FSB ) control = 100 - \frac{\% shoot damage by FSB in treated plot}{\% shoot damage by FSB in untreated plot} \times 100$$

Apply Colby's formula to % fruit and shoot borer control data to judge the synergism.

Fruit count: Count the number of healthy fruits (without damage) per plant. Record the observations from 10 plants per plot.

Flower count: Count the number of flowers per plant. 10 plants per plot.

TABLE 27
Treatment details for bio efficacy against brinjal
fruit and shoot borer, Leucinoides orbonalis.

| Treatment | |
|---|---|
| Number | Treatment details with use rate per hectare |
| T1 | Untreated Check (UTC) |
| T2 | Chlorantraniliprole 18.5% SC-150 ml |
| T3 | Cyantraniliprole 10.26% OD-500 ml |
| T4 | Tetraniliprole 20% SC-150 ml |
| T5 | Broflanilide 30% SC-33.33 ml |
| T6 | Salicylic acid 2% WP-750 g |
| T7 | Jasmonic acid 2% WP-500 g |
| T8 | Amino acid 20% WP-75 g |
| T9 | Fulvic acid 20% WP-75 g |
| T10 | Emamectin Benzoate 5% SG-150 g |
| T11 | Chlorantraniliprole 18.5% SC-150 ml + Salicylic acid 2% |
| | WP-750 g (prior art) |
| T12 | Cyantraniliprole 10.26% OD-500 ml + Jasmonic acid 2% |
| | WP-500 g(prior art) |
| T13 | Tetraniliprole 20% SC-150 ml + Amino acid 20% WP-75 |
| | g(prior art) |
| T14 | Broflanilide 30% SC-33.33 ml + Fulvic acid 20% WP-75 |
| | g(prior art) |
| T15 | Chlorantraniliprole 18.5% SC-150 ml + Emamectin Benzoate |
| | 5% SG-150 g(prior art) |
| T16 | Cyantraniliprole 10.26% OD-500 ml + Emamectin Benzoate |
| | 5% SG-150 g(prior art) |
| T17 | Tetraniliprole 20% SC-150 ml + Emamectin Benzoate 5% |
| | SG-150 g(prior art) |
| T18 | Broflanilide 30% SC-33.33 ml + Emamectin Benzoate 5% |
| | SG-150 g (prior art) |
| T19 | Salicylic acid 2% WP-750 g + Emamectin Benzoate 5% |
| | SG-150 g (prior art) |
| T20 | Jasmonic acid 2% WP-500 g + Emamectin Benzoate 5% |
| | SG-150 g (prior art) |
| T21 | Amino acid 20% WP-75 g + Emamectin Benzoate 5% |
| | SG-150 g (prior art) |
| T22 | Fulvic acid 20% WP-75 g + Emamectin Benzoate 5% |
| | SG-150 g (prior art) |
| T23 | Chlorantraniliprole 6% + Salicylic acid 3% + Emamectin |
| | benzoate 1.5% ZC-500 ml (ready mix) |
| T24 | Cyantraniliprole 10% + Jasmonic acid 2% + Emamectin |
| | benzoate 1.5% ZC-500 ml (ready mix) |
| T25 | Tetraniliprole 10% + Amino acid 3% + Emamectin benzoate |
| | 1.5% ZC-500 ml (ready mix) |
| T26 | Broflanilide 2% + Fulvic acid 3% + Emamectin benzoate |
| | 1.5% ZC-500 ml (ready mix) |

TABLE 28
Bo efficacy against brinjal fruit and shoot borer and fruit yield.

| | | | | | | Number | |
|---|---|---|---|---|---|---|---|
| | | | | | | of | |
| | % Fruit and Shoot borer control at | | | | | Healthy | |
| | 7 DAA | | | | | fruits/5 | Number of |
| Treatment | | | Colby/s | Synergism | 14 | plant at | Flowers/plant |
| Number | Obs. Value | Cal. Value | Ratio O/E | (Y/N) | DAA | 14 DAA | at 14 DAA |
| T1 | 0.0 | | | | 0.0 | 16.8 | 58.4 |
| T2 | 54.8 | | | | 36.2 | 37.4 | 85.2 |
| T3 | 60.4 | | | | 46.4 | 38.2 | 87.4 |
| T4 | 58.6 | | | | 41.2 | 37.8 | 83.6 |
| T5 | 62.2 | | | | 48.6 | 42.6 | 80.2 |
| T6 | 6.8 | | | | 4.2 | 26.8 | 92.4 |
| T7 | 5.8 | | | | 3.4 | 24.6 | 98.6 |
| T8 | 5.0 | | | | 2.6 | 27.2 | 95.6 |
| T9 | 4.4 | | | | 1.8 | 24.6 | 97.2 |
| T10 | 56.2 | | | | 30.4 | 40.2 | 84.6 |
| T11 | 56.2 | 57.87 | 0.97 | N | 36.8 | 39.8 | 132.6 |
| T12 | 60.4 | 62.70 | 0.96 | N | 47.6 | 42.6 | 142.8 |
| T13 | 58.8 | 60.67 | 0.97 | N | 41.2 | 41.2 | 128.4 |
| T14 | 61.6 | 63.86 | 0.96 | N | 46.8 | 46.2 | 138.2 |
| T15 | 78.6 | 80.20 | 0.98 | N | 52.4 | 60.6 | 112.4 |
| T16 | 80.6 | 82.66 | 0.98 | N | 57.4 | 65.4 | 116.2 |
| T17 | 80.4 | 81.87 | 0.98 | N | 50.2 | 63.2 | 104.8 |
| T18 | 81.2 | 83.44 | 0.97 | N | 60.8 | 68.2 | 116.4 |
| T19 | 57.6 | 59.18 | 0.97 | N | 30.2 | 34.8 | 122.6 |
| T20 | 56.4 | 58.74 | 0.96 | N | 28.6 | 36.2 | 128.6 |
| T21 | 55.8 | 58.39 | 0.96 | N | 27.4 | 33.2 | 112.6 |
| T22 | 56.2 | 58.13 | 0.97 | N | 28.4 | 35.6 | 120.6 |
| T23 | 92.4 | 81.55 | 1.13 | Y | 60.2 | 72.4 | 152.4 |
| T24 | 98.4 | 83.66 | 1.18 | Y | 66.2 | 78.2 | 172.4 |
| T25 | 96.4 | 82.77 | 1.16 | Y | 62.8 | 75.6 | 158.2 |
| T26 | 97.2 | 84.17 | 1.15 | Y | 69.6 | 80.4 | 162.8 |

The treatments of novel, ready mix and innovative formulations (T23, T24, T25, T26) provides excellent control of fruit and shoot borer in brinjal crop and also produces higher number of healthy fruits and a greater number of flowers per plant in comparison with all prior art treatments (Shows synergistic larval control of pod borer larval control and also yielded higher number of healthy pods per plant in comparison with all prior treatments (T11 to T22).

Overall Summery of Field Trials:

The field trials results shows many benefits/advantages of ready mix formulations of diamide, Metadiamides, isooxazoline insecticide with plant health additive and one more insecticides.
Synergism observed
Provides higher level of insect control (increase % control)
Provides effective control of a greater number of insect-pests species at a time and over a period of time.
Provides longer duration of control (residual control)
Increases plant growth, vigor, height, produces a greater number of tillers, shoots, branches, flowers, fruits, pods, square, bolls, seeds, grains etc. and overall biomass of the crop, which directly increases the yield of the crop.
Increase in bio efficacy, residual control and plant growth also observed due to novel and innovative formulations (OD, ZC, SE, SC, WG, GR, GR-SL) of diamide, meta-diamide, isooxazoline insecticide with plant health additive and one more insecticides.

Product used in bio-efficacy trials are Chlorantraniliprole 18.5% SC (20% w/v), Cyantraniliprole 10.26% OD (10% w/v), Cyclaniliprole 4.5% SL (5% w/v), Methoxyfenozide 21.8% SC (24% w/v), Spiromesifen 22.9% SC (24% w/v), Triflumezopyrim 10.6% SC (10.6 g in 100 ml).

Terminology used in bio-efficacy trials are cm-centimetre, m-meter, g-gram, kg-kilogram, ml-millilitre, sq.mt. square meter (m²), DAS Days after sowing, DAP Days after planting, DATP Days after transplanting, DAA Days after application, T for Treatment, spp.-species, Ob. Value-observed value, Cal. Value-calculated value.

GR/Gr—Granule/soil applied granule, GR-SL Controlled/Slow release granule, SC Suspension concentrate, SE Suspo emulsion, OD Oil dispersion, SL Soluble liquid, WG/WDG-Water dispersible granule, WP Wettable powder, SG Soluble granule, L Liquid, SL Soluble liquid, EC Emulsifiable concentrate.

We claim:

1. An agrochemical mixture comprising:
a. an insecticide selected from broflanilide, chlorantraniliprole, cyantraniliprole, cyclaniliprole, cyhalodiamide, cyproflanilide, flubendiamide, tetrachlorantraniliprole, tetraniliprole, fluxametamide and isocyclaseram present in amount of 0.1%-40% by weight;
b. plant health additives compound selected from chitosan, chitin, humic acid, potassium fulvic acid, potassium humate, fulvic acid, amino acid, protein hydrolisates, seaweed extract (Ascophyllum nodosum), brassinolide, microalgae polysaccharides, jasmonic acid (methyl jasmonate), silicon compound-silicic acid (H2Si03), monosilicic acid, orthosilicic acid (H4Si04), disilicic acid (H2Si205), and pyrosilicic acid (H6Si207), silica nanoparticles, Calcium silicate, Potassium silicate, Sodium silicate or mixtures thereof, silicyclic acid Micronutrients Zinc (zinc sulphate heptahydrate ZnSO47H2O, zinc sulphate mono hydrate ZnSO4·H2O, chelated zinc as Zn-EDTA, zinc oxide, Zinc Lactate Gluconate, Zinc Polyflavonoid), Boron (borax-sodium tetraborate, boric acid (H3BO3), di-sodium octa borate tetra hydrate (Na2B8O13.4H2O), di-sodium tetra borate penta hydrate, anhydrous borax,), Manganese (manganese sulphate), Copper (copper sulphate), Iron (ferrous sulphate, chelated iron as Fe-EDTA), Molybdanum (ammonium molybdate), Magnesium (Magnesium sulphate) or Sulphur (elemental sulphur, boronated sulphur) or mixture thereof present in amount of 0.001%-20% by weight;
c. an insecticide selected from aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, and triazamate; acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion; endosulfan; ethiprole, fipronil, flufiprole, nicofluprole, pyrafluprole, or pyriprole; acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (py rethrum), resmethrin, silafluofen, tefluthrin, tetramethylfluthrin, tetramethrin, tralomethrin, transfluthrin; acetamiprid, clothianidin, dinotefuran, imidacloprid, nitenpyram, thiacloprid, thiamethoxam; sulfoxaflor; flupyradifurone; triflumezopyrim and flupyrimin; spinosad, spinetoram; abamectin, emamectin benzoate, ivermectin, lepimectin; milbemectin; hydroprene, kinoprene, methoprene, fenoxycarb, pyriproxyfen; methyl bromide and other alkyl halides, chloropicrin, sulfuryl fluoride, borax or tartar emetic, dazomet, metam; pymetrozine, pyrifluquinazon; afidopyropen; clofentezine, hexythiazox, diflovidazin or etoxazole; Bacillus thuringiensis; diafenthiuron, azocyclotin, cyhexatin, fenbutatin oxide, propargite, or tetradifon; chlorfenapyr, DNOC, or sulfluramid; Benzoylureas-bistrifluron, chlorfluazuron, diflubenzuron, flucycloxuron, flufenoxuron, hexaflumuron, lufenuron, novaluron, noviflumuron, teflubenzuron, and triflumuron; buprofezin; cyromazine; methoxyfenozide, tebufenozide, halofenozide, fufenozide or chromafenozide; amitraz; hydramethylnon, acequinocyl, flometoquin, fluacrypyrim, pyriminostrobin or bifenazate; fenazaquin, fenpyroximate, pyrimidifen, pyridaben, tebufenpyrad, tolfenpyrad, flufenerim, or rotenone; indoxacarb; semicarbazones like metaflumizone; spirodiclofen, spiromesifen, spirotetramat or spiropidion; cyenopyrafen, cyflumetofen or pyflubumide; flonicamid; granuloviruses and nucleopolyhedrosis viruses; azadirechtin, benzoximate, benzpyrimoxan, pyridalyl and oxazosulfyl; dimpropyridaz, tyclopyrazoflor, dichloromezotiaz, fluhexafon, cyetpyrafen, flupentiofenox, acynonapyr, cyclobutrifluram, fluazaindolizine, tioxazafen present in amount of 0.1%-40% by weight;
d. inactive formulation excipients.

2. (canceled)

3. (canceled)

4. The agrochemical mixture as claimed in claim 1, wherein the formulation for the said composition is selected from Capsule suspension (CS), Dispersible concentrate (DC), Powder for dry seed treatment (DS), Emulsifiable concentrate (EC), Emulsion, water in oil (EO), Emulsion for seed treatment (ES), Emulsion, oil in water (EW), Flowable suspension/concentrate for seed treatment (FS), Granule/soil applied (GR), Controlled (Slow or Fast) release granules (CR), Solution for seed treatment (LS), Micro-emulsion (ME), Oil dispersion (OD), Oil miscible flowable concentrate (oil miscible suspension (OF), Oil miscible liquid (OL), Suspension concentrate (flowable concentrate) (SC), Suspo-emulsion (SE), Water soluble granule (SG), Soluble concentrate (SL), Water soluble powder (SP), Water dispersible granule (WG or WDG), Wettable powder (WP), Water dispersible powder for slurry treatment (WS), A mixed formulation of CS and SC (ZC), A mixed formulation of CS and SE (ZE), A mixed formulation of CS and EW (ZW).

5. (canceled)

6. The agrochemical mixture as claimed in claim 4, wherein the Oil Dispersion (OD) formulation comprises:
a) an insecticide selected from class of diamide group present in an amount of 0.1%-40% by weight of the composition is selected from Cyantraniliprole, Tetraniliprole, Broflanilide or Chlorantraniliprole;
b) a compound selected from plant health additives or mixture thereof present in amount of 0.001%-20% by weight of the composition is selected from Salicylic acid, Brassinolide;
c) an insecticide selected from various class present in amount of 0.1%-40% by weight of the composition is selected from Triflumezopyrim, Benzpyrimoxan, Methoxyfenozide, Emamectin benzoate, Diafenthiuron, Spiromesifen, Pyrifluquinazon, Tolfenpyrad, Spiromesifen or Flupyrimin;
d) Wetting-spreading-penetrating agent in an amount of 2 to 6% by weight;
e) Dispersing agent in an amount of 2 to 8% by weight;
f) Emulsifying agent in an amount of 6 to 10% by weight;
g) Stabilizer in an amount of 0.5 to 4% by weight;
h) Antifoaming agent in an amount of 0.1 to 1.5% by weight;
i) Preservative in an amount of 0.1 to 0.5% by weight;
j) Anti-freezing agent in an amount of 2 to 6% by weight;
k) Carrier as solvent in an amount of 40 to 70% by weight.

7. The agrochemical mixture as claimed in claim 6, wherein Wetting-spreading-penetrating agent is selected from Organo silicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof.

8. The agrochemical mixture as claimed in claim 6, wherein emulsifying agent is selected from castor oil ethoxylates, alcohol ethoxylates, fatty acid ethoxylates, sorbitan ester ethoxylates, sulphosuccinate, calcium salts of dodecyl benzene sulphonate, alkyl ammonium salts of alkyl benzene sulphonate, alkyl sulphosuccinate salts, ethylene oxide-propylene oxide block copolymers, ethoxylated alkylamines, ethoxylated alkyl phenols, polyoxyethylene sorbitan monolaurate.

9. The agrochemical mixture as claimed in claim 6, wherein dispersing agent is selected from alkyl sulfonates, alkyl benzene sulfonates, alkyl aryl sulfonates, alkyl phenol alkoxylates, tristyryl phenol ethoxylates, natural or synthetic fatty ethoxylate alcohols, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers), fatty acid-polyalkylene glycol condensates, polyamine-fatty acid condensates, polyester condensates, salts of polyolefin condensates, sodium ligno sulfonate, sodium ploy carboxylate, EO/PO based copolymer, phenol sulfonate, sodium methyl oleoyl taurate, styrene acrylic acid copolymer, propylene oxide-ethylene oxide-copolymer, polyethylene glycol 2,4,6-tristyrylphenyl ether, tristyryl phenol-poly glycol ether-phosphate, tristyryl phenole with 16 moles EO, tristyryl phenol-poly glycol ether-phosphate, oleyl-polyglycol ether with ethylene oxide, tallow fatty amine polyethylene oxide, nonyl phenol poly glycol ether with 9-10 moles ethylene oxide.

10. (canceled)

11. The agrochemical mixture as claimed in claim 6, wherein Carrier as solvent or diluting agent is selected from vegetable or plant or seed oil or its alkylated oil or alkylated oil of vegetable oil, alkylated oil (alkylated vegetable oil) may be methylated or ethylated oil of the vegetable oil, wherein vegetable oil are olive oil, kapok oil, castor oil, papaya oil, camellia oil, sesame oil, corn oil, rice bran oil, peanut oil, cotton seed oil, soybean oil, groundnut oil, rapeseed oil, linseed oil, tung oil, sunflower oil, safflower oil, coconut oil, alkyl ester of vegetable oils, (e.g. rapeseed oil methyl ester or rapeseed oil ethyl ester, rapeseed oil propyl esters, rapeseed oil butyl esters, neem oil, tall oil fatty acids esters etc.), diesel, mineral oil, fatty acid amides (e.g. C1-C3 amines, alkylamines or alkanolamines with C6-Ci8 carboxylic acids), fatty acids, tall oil fatty acids, alkyl esters of fatty acids (e.g. Ci, Methyl and ethyl oleate, methyl and ethyl soyate, alkyl benzenes and alkylnaphthalenes, polyalkylene glycol ethers, fatty acid diesters, fatty alkylamides and diamides, dialkylene carbonates, ketones and alcohols or mixture thereof.

12. (canceled)

13. The agrochemical mixture as claimed in claim 4, wherein the Suspension Concentrate (SC) formulation comprises:
a) an insecticide selected from class of diamide group present in an amount of 0.1%-40% by weight of the composition is selected from Cyantraniliprole, Tetraniliprole, Broflanilide, Chlorantraniliprole or Isocycloseram;
b) a compound selected from plant health additives or mixture thereof present in amount of 0.001%-20% by weight of the composition is selected from Salicylic acid, Brassinolide, Ortho silicic acid;
c) an insecticide selected from various class present in amount of 0.1%-40% by weight of the composition is selected from Afidopyropen, Dimpropyridaz, Methoxyfenozide, Emamectin benzoate, Diafenthiuron, Pyrifluquinazon or Flupyrimin;
d) Wetting-spreading-penetrating agent in an amount of 2 to 6% by weight;
e) Dispersing agent 1 in an amount of 2 to 8% by weight;
f) Dispersing agent 2 in an amount of 1 to 3% by weight;
g) Suspending agent in an amount of 0.2 to 4.0% by weight;
h) Antifoaming agent in an amount of 0.1 to 1.5% by weight;
i) Preservative in an amount of 0.1 to 0.5% by weight;
j) Antifreezing agent in an amount of 2 to 6% by weight;
k) Thickner in an amount of 0.1 to 1.0% by weight;
l) Diluent Water in an amount of 40 to 70% by weight.

14. The agrochemical composition as claimed in claim 13, wherein Wetting-spreading-penetrating agent is selected from Organo silicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof.

15. The agrochemical composition as claimed in claim 13, wherein dispersing agent is selected from alkylated naphthalene sulfonate, sodium salt, sodium salt of naphthalene sulfonate condensate, sodium ligno sulfonate, sodium ploycarboxylate, EO/PO based copolymer, phenol sulfonate, sodium methyl oleoyl taurate, styrene acrylic acid copolymer, propylene oxide-ethylene oxide-copolymer, polyethylene glycol 2,4,6-tristyrylphenyl ether, tristyryl phenol-polyglycol ether-phosphate, tristyryl phenole with 16 moles EO, tristyryl phenol-polyglycol ether-phosphate, oleyl-polyglycol ether with ethylene oxide, tallow fatty amine polyethylene oxide, nonylphenol polyglycol ether with 9-10 moles ethylene oxide.

16. (canceled)

17. (canceled)

18. (canceled)

19. The agrochemical mixture as claimed in claim 4, wherein the Water Dispersible Granule (WG) formulation comprises:
a) an insecticide selected from class of diamide group present in an amount of 0.1%-40% by weight of the composition is selected from Cyantraniliprole, Tetraniliprole, Broflanilide, Chlorantraniliprole or Isocycloseram;
b) a compound selected from plant health additives or mixture thereof present in amount of 0.001%-20% by weight of the composition is selected from Salicylic acid, Brassinolide, Ortho silicic acid;
c) an insecticide selected from various class present in amount of 0.1%-40% by weight of the composition is selected from Pymetrozine, Dichloromezotiaz, Flonicamid, Spiropidion;
d) Wetting-spreading-penetrating agent in an amount of 2 to 6% by weight;
e) Dispersing agent I in an amount of 2 to 8% by weight;
f) Dispersing agent II in an amount of lto 3% by weight;
g) Disintegrating agent in an amount of 0.2 to 0.8% by weight;
h) Antifoaming agent in an amount of 0.1 to 1.5% by weight;
i) Carrier in an amount of 50 to 80% by weight.

20. The agrochemical composition as claimed in claim 19, wherein dispersing agent is selected from naphthalene sulfonic acid, sodium salt condensated with formaldehyde, poly alcoxylated alkyl phenol, naphthalene sulfonic acid formaldehyde condensate, methyl naphtaline-formaldehyde-condensate sodium salt, naphthalene condensates, lingo sulfonates, poly acrylates and phosphate esters, calcium lingo sulfonate, lignin sulfonate sodium salt.

21. The agrochemical composition as claimed in claim 19, wherein Wetting-spreading-penetrating agent is selected from Organo silicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof etc.

22. (canceled)

23. (canceled)

24. The agrochemical mixture as claimed in claim 4, wherein the Granule (GR) formulation comprises
a) an insecticide selected from class of diamide group present in an amount of 0.1%-40% by weight of the composition is selected from Cyantraniliprole, Tetraniliprole, Cyclaniliprole or Chlorantraniliprole;
b) a compound selected from plant health additives or mixture thereof present in amount of 0.001%-20% by weight of the composition is selected from Salicylic acid, zinc, suplhur;
c) an insecticide selected from various class present in amount of 0.1%-40% by weight of the composition is selected from Triflumezopyrim, Flupyrimin, Clothianidin or Fipronil;
d) Wetting agent in an amount of 2 to 6% by weight;
e) Dispersing agent in an amount of 1 to 3% by weight;
f) Colourant in an amount of 0.2 to 1.0% by weight;
g) Solvent in an amount of 2 to 8% by weight;
h) Carrier in an amount of 50 to 80% by weight.

25. (canceled)

26. The agrochemical mixture as claimed in claim 4, wherein the GR (Controlled/slow Release Granules) formulation comprises:
a) an insecticide selected from class of diamide group present in an amount of 0.1%-40% by weight of the composition is selected from Cyantraniliprole, Tetraniliprole, Cyclaniliprole or Chlorantraniliprole;
b) a compound selected from plant health additives or mixture thereof present in amount of 0.001%-20% by weight of the composition is selected from Brassinolide, Salicylic acid, zinc, suplhur, humic acid;
c) an insecticide selected from various class present in amount of 0.1%-40% by weight of the composition is selected from Triflumezopyrim, Flupyrimin, Clothianidin, Fipronil or Thiamethoxam;
d) Emulsifier in an amount of 0.25 to 4% by weight;
e) Controlled release agent-1 in an amount of 0.5 to 4% by weight;
f) Preservative in an amount of 0.01 to 1% by weight;
g) Antifoaming agent in an amount of 0.01 to 1% by weight;
h) Thickners in an amount of 0.1 to 1% by weight;
i) Controlled release agent-2 in an amount of 0.5 to 4% by weight;
j) Wetting agent in an amount of 2 to 6% by weight;
k) Dispersing agent in an amount of 0.5 to 2% by weight;
l) Water in an amount of 2 to 8% by weight;
m) Colourant in an amount of 0.25 to 2% by weight;
n) Innerts in an amount of 1 to 6% by weight;
o) Solvent in an amount of 2 to 6% by weight;
p) Carrier in an amount of 60 to 80% by weight.

27. The agrochemical mixture as claimed in and claim 26, wherein wetting agent is selected from mono C2-6 alkyl ether of a poly C2-4 alkylene oxide block copolymer, condensation product of castor oil and poly C2-4 alkylene oxide, alkoxylated castor oil, ethoxylated castor oil, a mono- or di-ester of a C12-24 fatty acid and poly C2-4 alkylene oxide, carboxylates, sulphates, sulphonates, alcohol ethoxylates, alkyl phenol ethoxylates, fatty acid ethoxylates, sorbitan esters, ethoxylated fats or oils, amine ethoxylates, phosphate esters, ethylene oxide-propylene oxide copolymers, fluorocarbons, alkyd-polyethylene glycol resin, polyalkylene glycol ether, apoly alkoxylated nonyl phenyl, alkoxylated primary alcohol, ethoxylated distyryl phenol, ethoxylated distyryl phenol sulphate, ethoxylated tristyrylphenol phosphate, tristyrylphenol phosphate ester, hydroxylated stearic acid polyalkylene glycol polymer and their corresponding salts, alkyd-polyethylene glycol resin, polyalkylene glycol ether, ethoxylated distyryl phenol, ethoxylated distyryl phenol sulphate, ethoxylated tristyrylphenol phosphate, tristyrylphenol phosphate ester, tristyrylphenol phosphate potassium salt, dodecyl sulfate sodium salt.

28. The agrochemical mixture as claimed in claim 26, wherein Dispersing agent is selected from copolymer of propylene oxide (PO) and ethylene oxide (EO) and/or an ethoxylated tristyrene phenol, copolymer of PO and EO is alpha-butyl-omega-hydroxypoly (oxypropylene) block polymer with poly(oxyethylene), ethoxylated tristyrene phenol is alpha-[2,4,6-tris[1-(phenyl)ethyl] phenyl]-omega-hydroxy poly(oxyethylene, poly(oxy-1,2-ethanediyl)-alpha-C10-15 alkyl-omega-hydroxy phosphate or sulphate and/or a C10-13 alkylbenzene sulfonic acid, tristyrylphenols, nonylphenols, dinonylphenol and octyl phenols, styryl phenol polyethoxyester phosphate, alkoxylated C14-20 fatty amines.

29. The agrochemical mixture as claimed in claim 26, wherein controlled/Slow releasing agent is selected from xanthan gum, PVK, carboxymethyl celluloses, polyvinyl alcohols, gelatine, sodium carboxymethylcellulose, hydroxyethyl cellulose, Sodium Polyacrylate, modified starch, paraffin wax, polyvinyl acetate, montane wax and vinyl acetate, polyethylene glycol 6000, cationic hydro soluble polymer, C4 alkylated polyvinyl pyrrolidone.

30. (canceled)

31. The agrochemical mixture as claimed in claim 4, wherein the Suspo-emulsion (SE) formulation comprises:
a) an insecticide selected from class of diamide group present in an amount of 0.1%-40% by weight of the composition is selected from Cyantraniliprole or Broflanilide;
b) a compound selected from plant health additives or mixture thereof present in amount of 0.001%-20% by weight of the composition is selected from Salicylic acid or Broflanilide;
c) an insecticide selected from various class present in amount of 0.1%-40% by weight of the composition is selected from Pyriproxyfen;
d) Solvent in an amount of 8 to 12% by weight;
e) Wetting-spreading-penetrating agent in an amount of 2 to 6% % by weight;
f) Dispersing agent 1 in an amount of 2 to 8% by weight;
g) Dispersing agent 2 in an amount of 1 to 3% by weight;
h) Suspending agent in an amount of 0.2 to 4.0% by weight;
i) Antifoaming agent in an amount of 0.1 to 1.5% by weight;
j) Preservative in an amount of 0.1 to 0.5% by weight;
k) Antifreezing agent in an amount of 2 to 6% by weight;
l) Thickner in an amount of 0.1 to 1.0% by weight;
m) Diluent Water in an amount of 40 to 70% by weight.

32. The agrochemical mixture as claimed in claim 31, wherein Emulsifier is selected from salts of dodecyl benzene sulphonate, Ca-salts or amine salts, and sulphonates of other C11-C16 alkyl benzenes, alkyl ether sulphates, alkyl phenol ether phosphates and ester phosphates; non-ionic surfactants such as alkoxylated alcohols and alkyl phenols, ethoxylated fatty acids, ethoxylated vegetable oils, e.g. ethoxylated castor oil, fatty acid esters, e.g. of sorbitol, and their ethoxylated derivatives, ethoxylated amines, and condensates of glycerol; and catanionic emulsifiers such as a cationic amine, optionally in combination with an alkyl sulphonate or ether sulphonate or ether phosphate, alkoxylated alcohols; alkoxylated alkyl phenols; ethoxylated fatty acids; ethoxylated vegetable oils; ethoxylated tristyrylphenol; fatty acid esters of sorbitol and ethoxylated derivatives thereof; ethoxylated amines and condensates of glycerol; sulfonated alkyl benzenes in the range C11-C16 and salts thereof; alkyl ether sulphates; alkyl ether phosphates; alkyl phenol ether phosphates; or combinations thereof; salts of phosphate esters of ethoxylated tristyrylphenol; salts of sulphated ethers of ethoxylated tristyrylphenol; or a catanionic system, wherein a cationic amine is present in combination with an alkyl sulphonate, an alkyl ether sulphonate, an ether sulphate, or an ether phosphate such as an alkyl ether phosphate, nonyl phenol poly ethoxy ethanols, castor oil polyglycol ethers, poly adducts of ethylene oxide and polypropylene, tributyl phenoxy polyethoxy ethanol, octyl phenoxy polyethoxy ethanol.

33. (canceled)

34. The agrochemical mixture as claimed in claim 31, wherein dispersing agent is selected from polyesters, polyamides, poly-carbonates, polyurea and polyurethanes, acrylic polymers and copolymers, styrene copolymers, butadiene copolymers, polysaccharides such as starch and cellulose derivatives, vinylalcohol, vinylacetate and vinylpyrrolidone polymers and copolymers, polyethers, epoxy, phenolic and melamine resins, polyolefins and define copolymers and mixtures thereof, preferred polymers are acrylate polymers such as poly(methacrylate), poly(ethyl methacrylate), poly(methylmethacrylate), acrylate copoylmers and styrene-acrylic copolymers as defined herein below, poly (styrene-co maleic anhydride), cellulosic polymers such as ethyl cellulose, cellulose acetate, cellulose acetatebutyrate, acetylated mono, di, and triglycerides, poly(vinylpyrrolidone), vinyl acetate polymers and copolymers, poly(alkylene glycol), styrene butadiene copolymers, poly(orthoesters), alkyd resins, and mixtures of two or more of these, biodegradable polymers, biodegradable polyesters, starch, polylactic acid starch blends, polylactic acid, poly(lactic acid-glycolic acid) copolymers, polydioxanone, cellulose esters, ethyl cellulose, cellulose acetate butyrate, starch esters, starch esteraliphatic polyester blends, modified corn starch, polycaprolactone, poly(namylmethacrylate), wood rosin, polyanhydrides, polyvinylalcohol, polyhydroxybutyratevalerate, biodegradable aliphatic polyesters, and polyhydroxybutyrate or mixtures thereof. The examples of dispersing agents are alkylated naphthalene sulfonate, sodium salt, sodium salt of naphthalene sulfonate condensate, sodium ligno sulfonate, sodium ploycarboxylate, EO/PO block copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide.

35. (canceled)

36. The agrochemical mixture as claimed in claim 31, wherein Wetting-spreading-penetrating agent is selected from Organo silicone surfactants includes trisiloxane ethoxylate, polydimethylsiloxane, polyoxyethylene methyl polysiloxane, polyoxyalkylene methyl polysiloxane, polyether polymethyl siloxane copolymer, modified heptamethyl trisiloxane, polyether modified polysiloxane, 10 mole ethylene oxide adduct of octylphenol, may or may not be in modified form, may be liquid or powder form or mixture thereof.

37. (canceled)

38. (canceled)

39. The agrochemical mixture as claimed in claim 4, wherein (ZC) formulation comprises:
a) an insecticide selected from class of diamide group present in an amount of 0.1%-40% by weight of the composition is selected from Cyantraniliprole, Tetraniliprole, Broflanilide or Chlorantraniliprole;
b) a compound selected from plant health additives or mixture thereof present in amount of 0.001%-20% by weight of the composition is selected from Salicylic acid, Jasmonic acid, Amino acid, Fulvic acid;
c) an insecticide selected from various class present in amount of 0.1%-40% by weight of the composition is selected from Emamectin benzoate;
d) Wetting-spreading-penetrating agent in an amount of 2 to 6% by weight;
e) Dispersing agent 1 in an amount of 2 to 8% by weight;
f) Dispersing agent 2 in an amount of 1 to 3% by weight;
g) Solvent in an amount of 6 to 10% by weight;
h) Wall forming material 1 in an amount of 0.1 to 3% by weight;
i) Wall forming material 2 in an amount of 0.1 to 2% by weight;
j) Suspending agent in an amount of 1 to 3% by weight;
k) Antifoaming agent in an amount of 0.1 to 1.0% by weight;
l) Buffering agent in an amount of 0.1 to 2.0% by weight;
m) Preservative in an amount of 0.05 to 1.0% by weight;
n) Antifreezing agent in an amount of 4 to 8% by weight;
o) Thickner in an amount of 0.05 to 2.0% by weight;
p) Diluent Water in an amount of 40 to 70% by weight.

40. (canceled)

41. (canceled)

42. The agrochemical mixture as claimed in 39, wherein wall forming agent is selected from Tetramethylene diisocyanate, pentamethylene diisocyanate, hexamethylene diisocyanate, toluene diisocyanate, diphenylmethene-4,4′-diisocyanate, polymethylene polyphenylene isocyanate, 2,4,4′-diphenyl ether tri-isocyanate, 3,3′-dimethyl-4,4′-diphenyl diisocyanate, 3,3′-dimethoxy-4,4′-diphenyl diisocyanate, 1,5-naphthylene diisocyanate and 4,4′ 4″-triphenylmethane tri-isocyanate, toluene diisocyanate or polymethylene polyphenylisocyanate; Ammonia, hexamine, ethylene diamine, propylene-1,3-diamine, tetramethylenediamine, pentamethylene diamine, 1,6-hexamethylenediamine, diethylenetriamine, triethylene-tetramine, tetra ethylene pentamine, pentaethylenehex amine, 4,9-dioxadodecane-1, 12-diamine, 1,3-phenylene diamine, 2,4- and 2,6-toluenediamine and 4,4′-diaminodiphenylmethane, 1,3-phenylenediamine, 2,4- and 2,6-toluenediamine, 4,4′-diaminodiphenylmethane, 1,5-diaminonaphthalene, 1,3,5-triaminobenzene, 2,4,6-triaminotoluene, 1,3,6-triaminonaphthalene, 2,4,4′-triaminodiphenyl ether, 3,4,5-triamino-1,2,4-triazole and 1,4,5,8-tetraminoanthraquinone.

43. The agrochemical mixture as claimed in claim 24, and wherein zinc is selected from zinc oxide, zinc sulphate, zinc lactate, zinc gluconate or zinc proteino-lacto gluconate.
